(19) United States
(12) Patent Application Publication
(10) Pub. No.: US 2022/0212263 A1
(43) Pub. Date: Jul. 7, 2022

(54) NON-COAXIAL ROTATING TURNTABLES FOR ADDITIVE MANUFACTURING

(71) Applicant: Nikon Corporation, Tokyo (JP)

(72) Inventors: Alton Hugh Phillips, Oro Valley, AZ (US); Patrick Shih Chang, San Francisco, CA (US); Michael Birk Binnard, Belmont, CA (US); Matthew Rosa, Union City, CA (US); Serhad Ketsamanian, Fremont, CA (US); Lexian Guo, Fremont, CA (US); Brett William Herr, Menlo Park, CA (US); Eric Peter Goodwin, Oro Valley, AZ (US); Johnathan Agustin Marquez, San Francisco, CA (US); Matthew Parker-McCormick Bjork, Oakland, CA (US); Paul Derek Coon, Redwood City, CA (US); Motofusa Ishikawa, Ageo-shi (JP)

(73) Assignee: Nikon Corporation, Tokyo (JP)

(21) Appl. No.: 17/623,847

(22) PCT Filed: Jul. 1, 2020
(86) PCT No.: PCT/US20/40391

§ 371 Date: Dec. 29, 2021

Related U.S. Application Data
(60) Provisional application No. 62/869,859, filed on Jul. 2, 2019.

(51) Int. Cl. B22F 12/37; B33Y 30/00; B33Y 50/02; B22F 10/85; B22F 12/90; B22F 12/00; B23K 26/342; B23K 26/08

(52) U.S. Cl. CPC B22F 12/37; B33Y 30/00; B33Y 50/02; B22F 10/85; B23K 26/083; B22F 12/226; B23K 26/342; B23K 26/0823; B22F 12/90

(57) ABSTRACT

To improve the operation of 3D printing systems, techniques are disclosed for a rotary 3D printer comprising: a main rotating support table rotating about a first axis and one or more secondary support tables rotating around a non-coaxial secondary axis; a powder supply assembly for distributing powder onto the tables; and an energy system for directing an energy beam at the powder to form a part. The main support table and secondary support tables can rotate in the same or opposite directions.

Disclosed techniques include: grooved support table surfaces for improving stability of applied powder; reciprocating bellows for controlling a differential load on actuators that move the support tables; high temperature bearings or bushings for supporting rotary motion at high temperatures; and a mechanism for counterbalancing a weight of the part being built.

### RELATED APPLICATIONS

This application claims priority to U.S. Provisional Application No. 62/869,859 filed on Jul. 2, 2019 and entitled “NON-COAXIAL ROTATING TURNTABLES FOR ADDITIVE MANUFACTURING”. As far as permitted the contents of U.S. Provisional Application No: 62/869,859 are incorporated herein by reference.

### BACKGROUND

Three-dimensional printing systems are used to print three-dimensional objects. Existing three-dimensional printing systems are relatively slow, have a low throughput, are expensive to operate, and/or generate excessive waste. There is a never ending search to increase the speed, the throughput and reduce the cost of operation for three-dimensional printing systems.

### BRIEF DESCRIPTION OF THE DRAWINGS

FIG. 1 is a view schematically showing the configuration of a shaping apparatus according to a first embodiment.

FIG. 2 is a perspective view showing a shaping apparatus main section shown in FIG. 1, with a part thereof omitted.

FIG. 3 is a view used to explain the configuration of parts disposed on the upper surface of a frame-shaped section and the arrangement of a beam irradiation unit, and also is a view (No. 1) used to explain a movement operation of a table device 12 along a circulation path, in the shaping apparatus according to the first embodiment.

FIG. 4 is a view (No. 2) used to explain the movement operation of table device 12 along the circulation path, in the shaping apparatus according to the first embodiment.

FIG. 5 is a view (No. 3) used to explain the movement operation of table device 12 along the circulation path, in the shaping apparatus according to the first embodiment.

FIG. 6 is a view (No. 4) used to explain the movement operation of table device 12 along the circulation path, in the shaping apparatus according to the first embodiment.

FIG. 7 is a view (No. 5) used to explain the movement operation of table device 12 along the circulation path, in the shaping apparatus according to the first embodiment.

FIG. 8 is a view (No. 6) used to explain the movement operation of table device 12 along the circulation path, in the shaping apparatus according to the first embodiment.

FIG. 9 is a view (No. 7) used to explain the movement operation of table device 12 along the circulation path, in the shaping apparatus according to the first embodiment.

FIG. 10 is a view (No. 8) used to explain the movement operation of table device 12 along the circulation path, in the shaping apparatus according to the first embodiment.

FIG. 11 is a view used to explain reasons for employing a multicolumn electron beam optical system.

FIG. 12 is a view (No. 1) used to explain formation of layers of shaping material performed in the shaping apparatus main section.

FIG. 13 is a view (No. 2) used to explain the formation of layers of shaping material performed in the shaping apparatus main section.

FIG. 14 is a view (No. 3) used to explain the formation of layers of shaping material performed in the shaping apparatus main section.

FIG. 15 is a perspective view used explain leveling of the face of shaping material supplied onto a table (shaping plate).

FIG. 16 is a block diagram showing the input/output relationship of a controller that centrally configures a control system of the shaping apparatus according to the first embodiment.

FIG. 17 is a perspective view showing a state of irradiating electron beams from three beam irradiation units to layers of shaping material on the table.

FIG. 18 is a view used to explain an example of a shaping work with respect to a layer of shaping material shared by the three beam irradiation units.

FIG. 19 is a view used to explain an example of beam current value in the case of applying gradation to the beam current in a boundary area AB, in the example shown FIG. 18.

FIG. 20 is a perspective view showing the configuration of a shaping apparatus main section that configures a shaping apparatus according to a second embodiment.

FIG. 21 is a plan view showing the shaping apparatus main section shown in FIG. 20, with a part thereof omitted.

FIG. 22 is a block diagram showing the input/output relationship of a controller that centrally configures a control system of the shaping apparatus according to the second embodiment.

FIGS. 23(A) to 23(C) are views used to explain a modified example of the first embodiment and the second embodiment, and showing a system configured to supply shaping material from below onto a support surface.

FIG. 24 is a view used to explain a modified example of the second embodiment, and showing a system equipped with a plurality of supply sections and a plurality of shaping sections.

FIG. 25 is a view schematically showing the configuration of a shaping apparatus according to a third embodiment.

FIG. 26A illustrates a top down view of an exemplary embodiment of a rotating turntable 3D printer.

FIG. 26B illustrates a top down view of an exemplary embodiment of a rotating turntable 3D printer showing a first hatching direction in a print process to build a part.

FIG. 26C illustrates a top down view of an exemplary embodiment of a rotating turntable 3D printer showing a second hatching direction in a print process to build a part.

FIG. 27A illustrates a side view of exemplary portions of a rotary turntable 3D printer as disclosed herein.

FIG. 27B illustrates a top down view of the 3D printer shown in FIG. 27A.

FIG. 28 illustrates a cross-sectional view of a portion of an exemplary 3D printer having grooved support table surfaces for improving the stability of applied powder used for building parts.

FIG. 29A illustrates a perspective view of an exemplary processing machine as described herein having grooved support table surfaces for improving the stability of applied powder used for building parts.

FIG. 29B illustrates a cross-sectional view of the processing machine shown in FIG. 29A.

FIG. 30 illustrates a cross-sectional view of V-shaped grooves on an upper surface of a support table for improving the stability of applied powder used for building parts, according to an embodiment.

FIG. 31 illustrates a cross-sectional view of another example of a circular build platform configured to support a 3D part built on a processing machine as disclosed herein.

FIG. 32A illustrates an example of a processing machine having two symmetrical bellows with equal effective area between an elevator plate at its highest position during a build process.

FIG. 32B illustrates the processing machine of FIG. 32A wherein the elevator plate is at its lowest position during a build process.

FIG. 33 illustrates an example of a processing machine having two bellows with different diameters above and below an elevator plate, according to an embodiment.

FIG. 34 illustrates a cross-sectional view showing further details of the processing machine of FIGS. 32A-32B, according to an embodiment.

FIG. 35A depicts a cross-sectional view of an exemplary processing machine wherein the elevator plate is at its highest position during a build process.

FIG. 35B depicts a cross-sectional view of the processing machine of FIG. 35A wherein the elevator plate is at its lowest position during a build process.

FIG. 36 illustrates an example of a rotating and translating stage for a processing machine from a top perspective, according to an embodiment.

FIG. 37 illustrates a cross-sectional view of the exemplary rotating build platform of FIG. 36 and related components.

FIG. 38 illustrates further details of bearing structures shown in FIG. 37, according to an embodiment.

FIG. 39 illustrates an example of a processing machine having a rotating support table and a counterweight for reducing an imbalance on the rotating support table.

FIGS. 40A-40D illustrate four examples of techniques for preventing or reducing the imbalance on a turntable in a 3D printer by building two or more 3D parts on the turntable in parallel that are evenly or equally distributed around the turntable circumference, according to additional embodiments.

FIGS. 41A-41B illustrate two examples of techniques for preventing or reducing the imbalance on a turntable in a 3D printer by providing an empty vessel on the turntable that is filled with counterweight material, according to additional embodiments.

FIGS. 42A-42C illustrate an example of a turntable in a 3D printer having a counterweight on the opposing side of the turntable that moves outward along a radial guide during the 3D printing process to reduce imbalance on the turntable, according to an embodiment.

FIGS. 43A-43C illustrate another example of a turntable in a 3D printer having a counterweight on the opposing side of the turntable that moves outward along a radial guide during the 3D printing process to reduce imbalance on the turntable, according to an embodiment.

### DETAILED DESCRIPTION

### First Embodiment

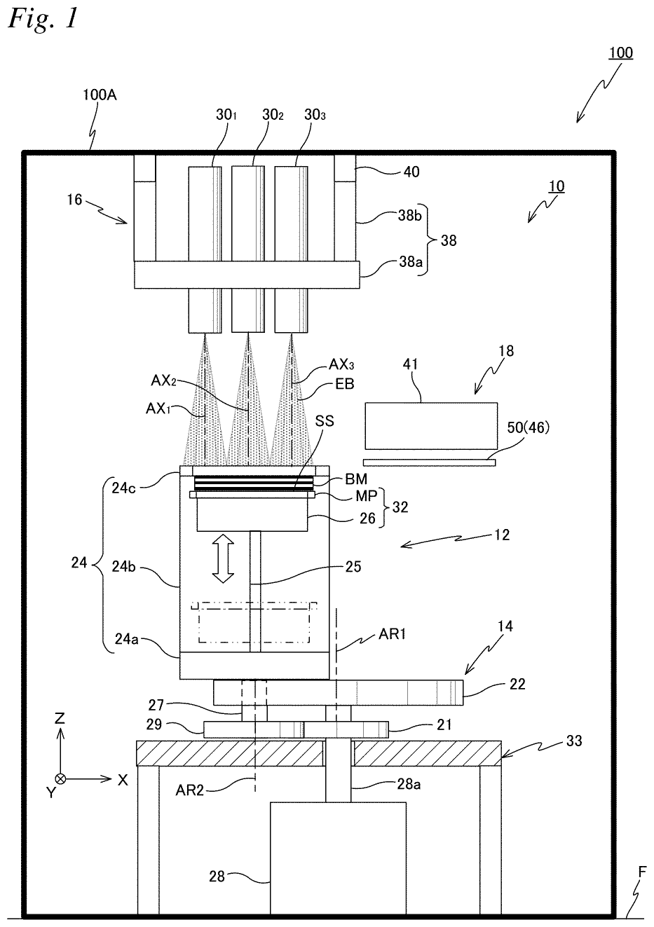

A first embodiment of the present invention will be described below, on the basis of FIGS. 1 to 19. FIG. 1 schematically shows the configuration of a shaping apparatus 100 according to the first embodiment. Shaping apparatus 100 is equipped with a plurality of electron beam irradiation units having optical systems as will be described later, and therefore the explanation will be made below assuming that a Z axis is parallel to an optical axis (AX1) and the like of the electron beam irradiation units, a lateral direction of the paper surface in FIG. 1 within a plane perpendicular to the Z-axis is the X-axis direction, a direction orthogonal to the Z-axis and the X-axis is a Y-axis direction. FIG. 1 shows the configuration of shaping apparatus 100 when viewed from the −Y direction, with a part thereof cross-sectioned.

Shaping apparatus 100 is a 3D printer for metal of a PBF (Powder Bed Fusion) type. In the PBF printer, a layer of metal powder as shaping material is spread over a table (which is also called a shaping table) or on a plate attached onto or supported by the shaping table to form powder bed, and high energy density beam(s) are selectively irradiated on only a necessary part of the powder bed, and the part where the beam hits is melted and solidified. When the beam irradiation (drawing) of one layer is completed, the shaping table is lowered by one layer thickness, spreading of metal powder is repeated thereon, and the same process is repeated. Shaping is repeated layer by layer in the manner described above so that the desired three-dimensional shape is acquired. In shaping apparatus 100 according to the present embodiment, as will be described later, electron beams, being a type of charged particle beams, are employed as high energy density beams. Note that, as the high energy beams to be selectively irradiated on the powder bed, light beams, (e.g., laser beams) or other charged particle beams(e.g., ion beams) may be employed.

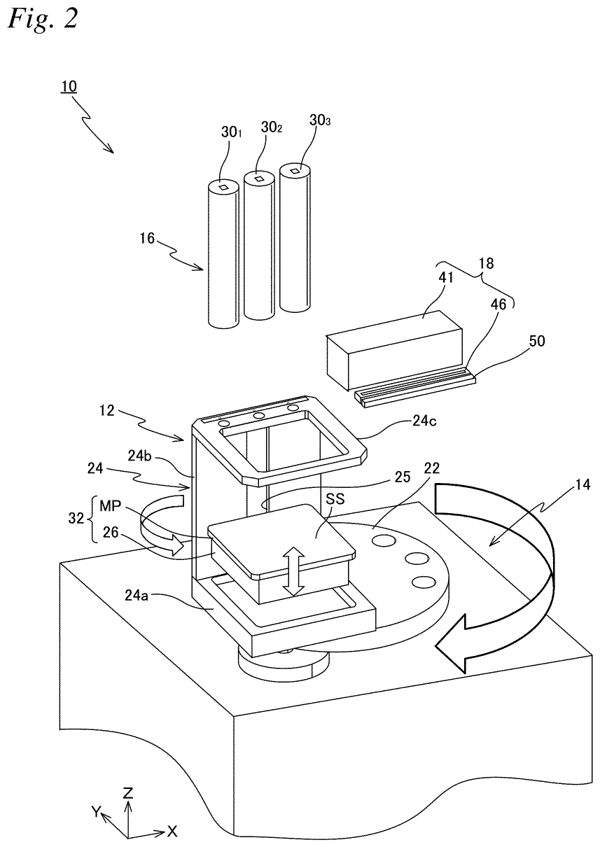

Shaping apparatus 100 is equipped with a housing 100A installed on a floor surface F of a factory, and a shaping apparatus main section 10 housed inside housing 100A. FIG. 2 shows shaping apparatus main section 10 with a part thereof omitted in a perspective view.

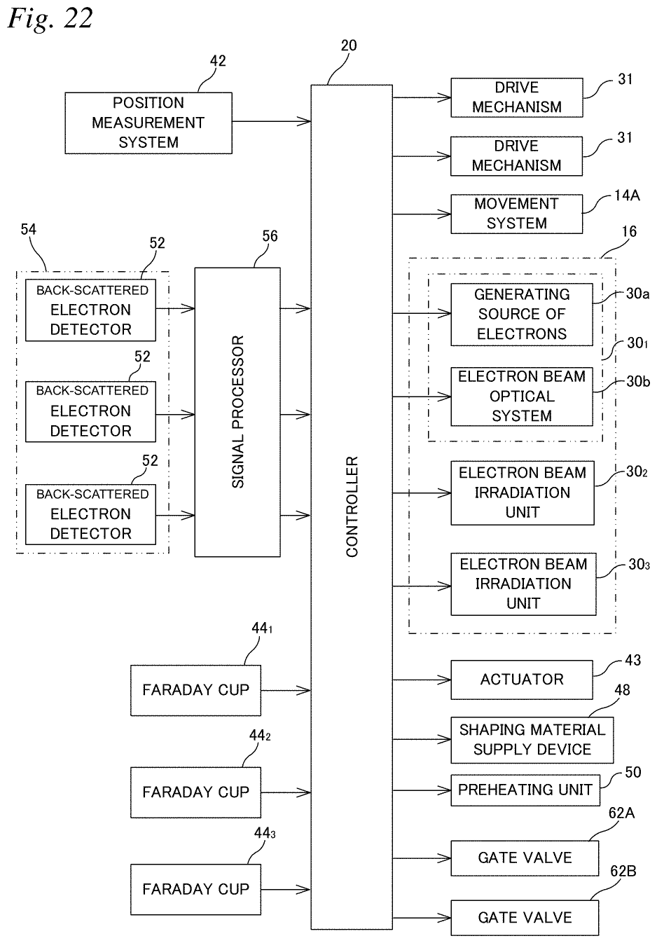

As shown in FIGS. 1 and 2, shaping apparatus main section 10 is equipped with a table device 12, a movement system 14, a beam irradiation section 16, a powder coating system 18, a preheating unit 50, a controller 20 (not illustrated in FIG. 1, see FIG. 16) to control them, and the like.

Table device 12 is equipped with: a table base 24 mounted on a rotation table 22 (also referred as a rotating support table or main rotary turn table) that configures a part of movement system 14; and a drive mechanism 31 (not illustrated in FIGS. 1 and 2, see FIG. 16) to drive a table 26 that is movable along a guide groove 25 in a vertical direction (Z-axis direction) relative to table base 24.

Table base 24 comprises: a base section 24a provided on the lowermost end and having a predetermined shape, e.g. a rectangular plate shape, with a recessed part on its upper surface; a back plate section 24b rising upwardly (perpendicularly to an XY-plane) from one end (an end on the deep side (+Y side) of the paper surface in FIG. 1) of base section 24a; and a frame-shaped section 24c provided at the upper end of back plate section 24b to face base section 24a. In the present embodiment, the orientation of table device 12 is maintained to be directed toward the same direction, i.e., so that back plate section 24b is constantly directed toward a direction parallel to an XZ plane as shown in FIGS. 1 and 2. This point will be further described later.

Guide groove 25 referred to above is formed in the center part in the X-axis direction of the −Y side surface of back plate section 24b. Note that the guide groove can also be called a guide section. The guide section is not limited to a groove but may be a protruding part or a bar-shaped member.

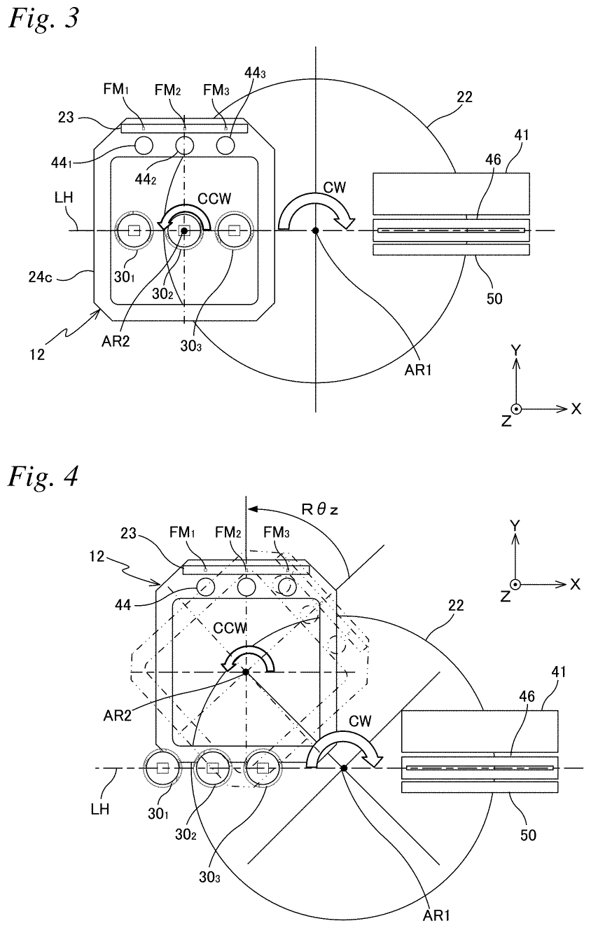

As shown in FIG. 2, frame-shaped section 24c is made up of a plate member parallel to the XY-plane with one end (+Y side end) fixed to the upper end surface of back plate section 24b and having a rectangular frame shape in planar view (a rectangular shape in the center of which an opening is formed). Frame-shaped section 24c serves to restrict expansion within the XY-plane (horizontal plane) of powdered shaping material BM (see FIG. 1) supplied onto a shaping plate (a build plate) MP attached on table 26. For example, as shown in FIG. 3, at the +Y side part of the upper surface of framed-shape section 24c, a fiducial mark plate 23 extending in the X-axis direction, and a plurality, e.g. three, of beam monitors 44₁, 44₂ and 44₃ are disposed. Note that the fiducial mark plate and the beam monitors will be further described later.

Shaping plate MP made up of a plate-shaped member is attached onto table 26, and shaping plate MP is freely detachable from and attachable to table 26. That is, shaping plate MP is not a component of shaping apparatus 100. Hereinafter, both of table 26 and shaping plate MP placed on table 26 are collectively referred to as a table section 32 for the sake of convenience in the description. Further, table 26 may be referred to as secondary support table or support table, and shaping plate MP may be referred to as rotary build platform (RBP).

In this embodiment, shaping plate MP is made up of a plate-shaped member with a square shape and the four corners thereof are chamfered. Shaping plate MP is fixed on table 26 to be freely detachable and attachable via electrostatic chucks (or mechanical chucks) that are not illustrated. In the present embodiment, as will be described later, a series of processing for constructing a shaping object is performed on shaping plate MP. That is, the upper surface of shaping plate MP serves as a support surface SS. Shaping plate MP is supported by table 26 in a state where support surface SS is parallel to the XY-plane (horizontal plane).

Drive mechanism 31 can be configured including, for example, a support member with an L-like shape to support table 26, and a linear motor or other one-axial actuator to drive the support member along guide groove 25 (guide section) in a vertical direction.

Movement system 14 moves table device 12 along a predetermined circulation path within the horizontal plane (XY-plane) (in the present embodiment, a circular path centered on a first axis (axis AR1) shown in FIG. 1 parallel to the Z-axis), and also drives table device 12 to rotate in conjunction with rotation of rotation table 22 so that the orientation of table device 12 within the horizontal plane is maintained at a predetermined orientation (such an orientation that back plate section 24b is parallel to the XZ-plane). To be more specific, as shown in FIG. 1, movement system 14 has: rotation table 22 that is rotatable within the XY-plane with axis AR1 serving as its center; a motor 28 that has a drive shaft 28a whose one end (upper end) is integrally connected to the center part of rotation table 22; a drive gear 21 that is integrally attached to drive shaft 28a to be coaxial with drive shaft 28a; and a driven gear 29 that is engaged with drive gear 21. As shown in FIG. 1, driven gear 29 is fixed to one end (lower end) of a shaft member 27 having a predetermined length in the Z-axis direction. The other end (upper end) of shaft member 27 is disposed in a through hole in the vertical direction formed at rotation table 22, and the other end surface is fixed (connected) to the lower surface of base section 24a of table base 24.

As shown in FIG. 1, motor 28 is disposed below a mount 33 installed on the bottom surface of housing 100A. Drive shaft 28a is disposed in a state of penetrating the upper plate of mount 33 in the vertical direction, and is supported by the upper plate of mount 33 to be rotatable with axis AR1 serving as the center via an annular bearing section (not illustrated). Shaft member 27 is attached to rotation table 22 to be rotatable about a second axis, i.e. a center axis AR2 of shaft member 27, via a bearing section (not illustrated). In the present embodiment, rotation center AR2 of shaft member 27 serves as a reference point of table device 12 to be described later.

A predetermined clearance (interspace, gap) is set between drive gear 21 and driven gear 29, and the upper plate of mount 33. Drive gear 21 and driven gear 29 each have a circular plate shape with the same diameter, and have tooth sections with the same shape and the same size to be engaged with each other, at respective outer peripheral parts. When drive gear 21 is driven integrally with rotation table 22 by motor 28, to rotate, for example, in a clockwise direction (a first rotation direction) in planar view (viewed from the +Z direction) about axis AR1 via drive shaft 28a, table device 12 including table 26 is moved in the first rotation direction. Put another way, center axis (second axis) AR2 of shaft member 27 rotates around the first axis. At this time, driven gear 29 (table device 12) is driven to rotate in a counterclockwise direction (a second rotation direction) about axis AR2 of shaft member 27, in conjunction with the rotation of drive gear 21.

In this case, since the diameters of drive gear 21 and driven gear 29 are the same, the rotating ratio (rotational speed ratio) between both gears is 1:1. Consequently, the rotation angular speed of table device 12 in the first rotation direction is equal to the rotation angular speed of table device 12 in the second rotation direction. Therefore, in the present embodiment, table device 12 is moved along a circular path, with axis AR1 serving as the center, as rotation table 22 is rotated, but as a result of table device 12 rotating in a reverse direction about axis AR2 of the shaft member, in conjunction with the rotation of rotation table 22, table device 12 is constantly directed toward the same direction. For such a reason, in the present embodiment, as is descried earlier, table device 12 is configured so that back plate section 24b is directed toward a direction parallel to the XZ plane. Consequently, the orientation of support surface SS is kept constant. In other words, the table device 12 translates along a circular path without rotating relative to the housing 100A.

Note that, in the present embodiment, as an example, drive gear 21 and driven gear 29 are exposed above mount 33, a gear mechanism including drive gear 21 and driven gear 29 may be disposed below the upper plate of mount 33 and rotation table 22 may be exposed above mount 33, together with a part of drive shaft 28a and a part of shaft member 27. Alternatively, rotation table 22 may also be disposed together with the gear mechanism below the upper plate of mount 33. In this case, only the upper end of shaft member 27 will be exposed above mount 33. In other embodiments, different transmission mechanisms such as belts and pulleys, chain and sprockets, or friction drive may be used in place of drive gear 21 and driven gear 29.

In the present embodiment, a position measurement system 42 (see FIG. 16) made up of a rotary encoder that detects a rotation angle around axis AR1 of rotation table 22 from its reference position is provided. Measurement information of position measurement system 42 is supplied to controller 20. Controller 20 is capable of obtaining the reference point of table device 12, i.e. the position within the horizontal plane (e.g. the coordinate position on an XY coordinate system with axis AR1 serving as the origin) of axis AR2 that is the rotation center of table device 12 (the rotation center of shaft member 27), on the basis of information on the rotation angle from position measurement system 42. Consequently, position measurement system 42 functions as a position measurement system that measures the position information within the horizontal plane of the reference point (axis AR2) of table device 12.

As shown in FIGS. 1 and 2, beam irradiation section 16 has three electron beam irradiation units (hereinafter, shortly referred to as beam irradiation units) 30₁ to 30₃. Beam irradiation units 30₁ to 30₃ individually have an emitting port, and emit an electron beam EB from the emitting port as an energy beam. As representatively shown by beam irradiation unit 30₁ in FIG. 16, each of beam irradiation units 30₁ to 30₃ has: a generating source 30a of electrons; and an electron beam optical system 30b that irradiates a target with electrons emitted from generating source 30a as electron beam EB and is capable of deflecting electron beam EB within a predetermined angle range and focusing electron beam EB at a desired location. Although not illustrated in the drawings such as FIGS. 1 and 2, generating source 30a is disposed at the upper end of a barrel (column) equipped in beam irradiation unit 30i (i=1 to 3). In the present embodiment, as an example, a generating source configured by combining a laser beam source, e.g. laser diode, a photoelectric conversion element having a Pt photoelectric conversion film, and a photomultiplier is employed as generating source 30a. Note that as the generating source of electrons, an electron gun such as, for example, a thermal electron gun using lanthanum hexaboride (LaB6), iridium cerium (IrCe), doped tungsten, or a tungsten filament may be employed. In addition, for example, a combination of laser diode and a photoelectric conversion element having an alkali photoelectric conversion film, or the like may also be employed.

Electron beam optical system 30b is configured of, as an example, an electrostatic lens, an electromagnetic lens, a correction coil, a deflection lens, and the like disposed below generating source 30a inside the barrel referred to above. The electrostatic lens, the electromagnetic lens, the correction coil, and the deflection lens are disposed in a beam path of electron beam EB from generating source 30a. The electrostatic lens and the electromagnetic lens are disposed near generating source 30a and near the lower end (the exit (emitting port) of the electron beam) in the barrel, respectively. An extraction electrode for accelerating electrons emitted from the generating source 30a is disposed above the electrostatic lens in the barrel. Note that the electromagnetic lens and the deflection lens may be disposed external to the barrel.

Here, the electrostatic lens functions as a condenser lens that converges electron beams, and the electromagnetic lens functions as a reduction-projection lens also serving as an objective lens. The correction coil for aligning the axis of the electrostatic lens and the axis of the electromagnetic lens is disposed between the electrostatic lens and the electromagnetic lens.

The deflection lens is disposed near the emitting port below the electromagnetic lens inside the barrel and performs, at high speed, position control of electron beam EB, i.e. deflection control of electron beam EB.

The reduction magnification of electron beam optical system 30b is about 1/30 in one example embodiment. The reduction magnification may be other magnifications such as 1/18 or 1/12, or may be a non-reduction system.

As shown in FIG. 1, beam irradiation units 30₁ to 30₃ are disposed at a position higher than table device 12, and are supported in a suspended manner by a ceiling part of housing 100A, via a support frame 38. Support frame 38 has: a support plate 38a that supports the three beam irradiation units 30₁ to 30₃; and a plurality, e.g. a pair, of support members 38b that support plate 38a at the ceiling part of housing 100A in a suspended manner. A vibration isolation member 40 is provided at the upper end of each of the pair of support members 38b, thereby preventing or effectively suppressing the vibration of motor 28 and the like from being transmitted to the three beam irradiation units 30₁ to 30₃ via housing 100A. The space inside housing 100A is vacuum evacuated by a vacuum pump (not illustrated), and for example, a vacuum state of about 10⁻² Pa is maintained. Housing 100A may be called a vacuum chamber 100A.

Note that the configuration for supporting the three beam irradiation units 30₁ to 30₃ is not limited to the configuration described above, and for example, support plate 38a may be supported in a suspended manner from the ceiling part of housing 100A via a plurality, e.g. three, of suspension support mechanisms made up of wires provided with vibration isolation members at one ends (upper ends). In this case, of vibration such as floor vibration transmitted from the outside to housing 100A, most of a vibration component in the Z-axis direction parallel to optical axis AXᵢ of electron beam optical system 30b of beam irradiation unit 30i is absorbed by the vibration isolation member, and therefore high vibration isolation property can be obtained in the Z-axis direction. Further, the natural frequency of the suspension support mechanism is set to be lower in directions perpendicular to the Z-axis than that in the Z-axis direction. Because the three suspension support mechanisms vibrate act as pendulums, the length of the three suspension support mechanisms (the length of the wires) is set to be sufficiently long so that the pendulum natural frequency is sufficiently low to ensure a vibration isolation property (ability to prevent the vibration such as floor vibration transmitted from the outside to housing 100A from traveling to support plate 38a (beam irradiation unit 30ᵢ)) in the directions perpendicular to the Z-axis is sufficiently high. With this structure, high vibration isolation performance can be obtained and weight reduction of mechanism sections can also be achieved. Note that in other alternative embodiments some of the components 38, 40, and portions of beam irradiation units 30₁ to 30₃ may be located outside of vacuum chamber 100A.

Note that a blocking plate (not illustrated) for protecting electron beam optical systems 30b from smoke generated from a powdered shaping material (here, metal powder) BM (i.e. gas generated by irradiating electron beams) may be disposed below beam irradiation units 30₁ to 30₃, via a predetermined clearance (interspace, gap) of, for example, several μm to several-tens μm. In this case, three openings are formed at the blocking plate to face individually the exits (emitting ports) of the barrels of the three beam irradiation units 30₁ to 30₃. By regularly exchanging the blocking plate, it becomes possible to keep electron beam optical systems 30b clean. Note that the blocking plate may have a function of cooling (or suppressing the temperature change of) an object, such as electron beam optical systems 30b, disposed nearby.

As shown in FIG. 3, the three beam irradiation units 30₁ to 30₃ are disposed at a predetermined spacing and separately from axis AR1, on a half straight line (hereinafter, referred to as a reference line for the sake of convenience) LH parallel to the X-axis with axis AR1 serving as a starting point in planar view (when viewed from the +Z direction). Respective optical axes AX₁ to AX₃ of beam irradiation units 30₁ to 303 are parallel to the Z-axis in design, and set to be orthogonal to reference line LH. The respective emitting ports (referred to as a first emitting port, a second emitting port and a third emitting port) of the three beam irradiation units 30₁ to 30₃ are disposed at different positions within a plane (XY-plane) intersecting with irradiation directions in which electron beams EB from the respective corresponding beam irradiation units are irradiated.

In shaping apparatus 100 according to the present embodiment, since beam irradiation section 16 has the three beam irradiation units 30₁ to 30₃, the optical system of shaping apparatus 100 is a multicolumn electron beam optical system.

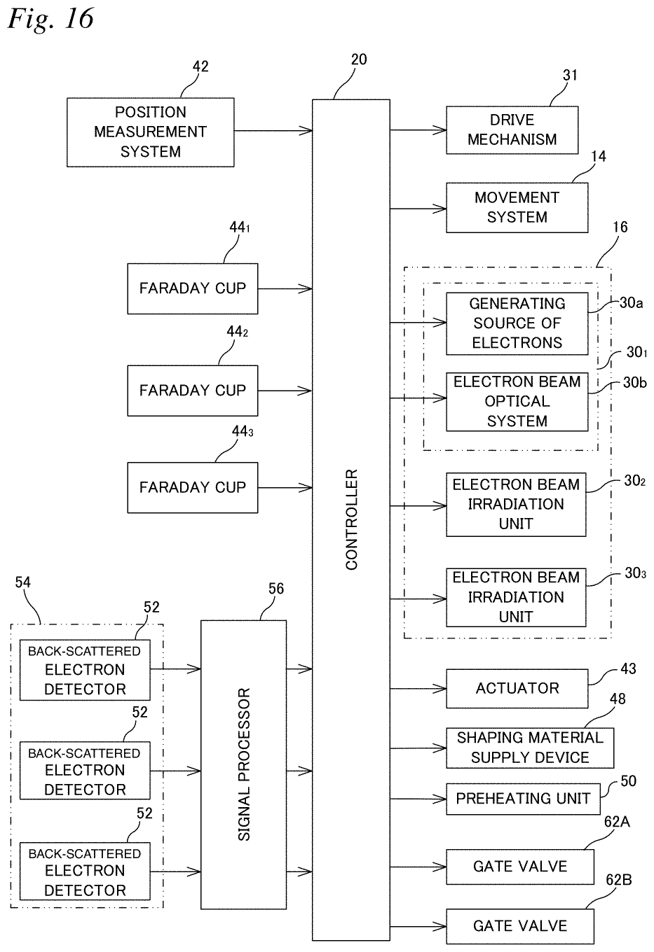

The reasons why the multicolumn electron beam optical system is employed will be described now on the basis of FIG. 11. FIG. 11 shows electron beam optical system 30b of beam irradiation unit 30₂, representing the three beam irradiation units 30, However, only deflection lens 30d is representatively illustrated in the drawing.

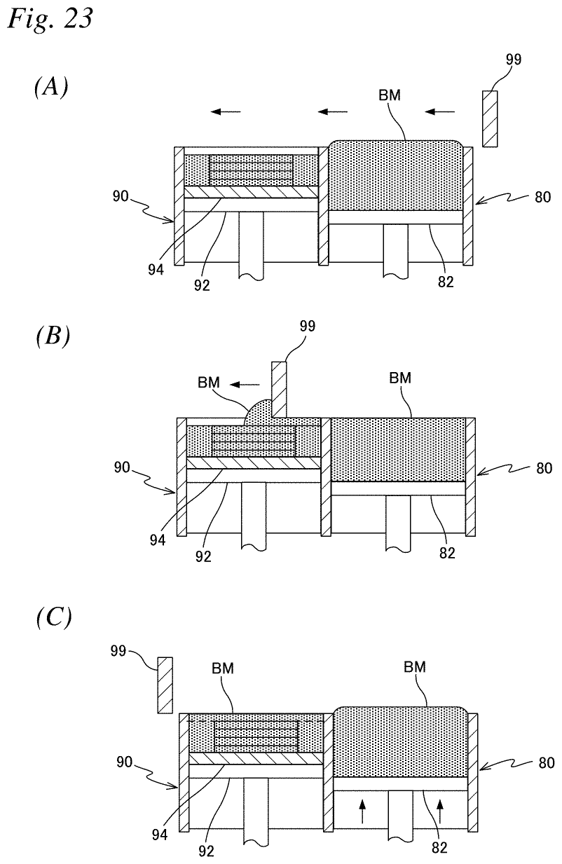

Here, as shown in FIG. 11, in shaping apparatus 100 according to the present embodiment, the case will be described where, for example, an area with a predetermined width having a length D (D is, for example, 300mm) in the X-axis direction serves as an irradiation target area of electron beam EB. In this case, the maximum swing width of electron beam EB by deflection lens 30d is assumed to be “d”. This maximum swing width d is determined according to a distance (which is also called a working distance) h between a plane (which is also called a shaping plane) FP where an irradiation area of electron beam EB is formed and the lower end of the barrel (to be more precise, a deflection center by deflection lens 30d), and a maximum deflection angle θ of electron beam EB by deflection lens 30d. For example, when assuming that the working distance h is about 400 mm to 600 mm, the maximum swing width d of electron beam EB might be, for example, about 100 mm depending on the setting of the maximum deflection angle 0. However, in shaping apparatus 100, the three beam irradiation units 30 are provided, and therefore it is possible to irradiate areas on a target that is long in the X-axis direction with electron beams concurrently using the three beam irradiation units 30₁ to 30₃ (see FIG. 17). Consequently, even if the maximum swing width d of electron beam EB by one beam irradiation unit is 100mm, it is possible to irradiate an entire area having a length D that is about 300mm of the irradiation target area with electron beams EB.

With this configuration, it becomes possible to improve the inconveniences of a shaping apparatus of PBF method employing a conventional single-column electron beam optical system such as:
a. In the single-column electron beam optical system typically employed in conventional shaping apparatus of PBF method, to irradiate an area with a predetermined width having a length D (D is, for example, 300 mm) in the X-axis direction, the swing width of electron beam EB needed to be the length D or more. Therefore, when the maximum deflection angle θ of electron beam EB by deflection lens 30d at the same 0 as in shaping apparatus 100, it was necessary to set a distance H shown in FIG. 11 as the working distance of the electron beam optical system. For example, the working distance H needed to be about 1200mm to 1800mm. The size of the apparatus increases and the focus quality of the electron beam EB degrades accordingly.
b. In a period during which electron beam EB travels from the exit of the barrel to shaping plane FP, error occurs in an irradiation coordinate (irradiation position) of the electron beam due to magnetic field disturbance with magnitude in accordance with the working distance. In this way, control error of the beam irradiation position by the deflection lens is enlarged in accordance with the working distance H.

Note that, although it is assumed that electron beam EB is deflected by a predetermined swing width in the X-axis direction in the above description, deflection lens 30d of electron beam optical system 30b according to the present embodiment is capable of deflecting the electron beam with a predetermined swing width in the Y-axis direction likewise. Consequently, at the time of a constructing work of shaping objects (hereinafter, referred to as a shaping work), the shaping work can also be performed while deflecting the electron beam in the X-axis direction and the Y-axis direction.

Note that the number of beam irradiation units 30 is not limited to three, and the number can be determined on the basis of the size of a shaping object to be constructed, the maximum deflection angle of the beam mainly in the X-axis direction by the beam irradiation unit, and the like. For example, the number of beam irradiation units 30 may be one, two, four or more.

In the present embodiment, as shown in FIG. 3 for example, on the upper surface of fiducial mark plate 23, three fiducial marks FM₁, FM₂ and FM₃ made up of two-dimensional marks are disposed in a predetermined positional relationship, corresponding to the three beam irradiation units 30₁ to 30₃. The distance between the plurality of the reference marks may be the same as the distance between the optical axis of the plurality of beam irradiation units.

Further, as shown in FIG. 3, on the upper surface of frame-shaped section 24c, three beam monitors, e.g. faraday cups 44₁, 44₂, 44 ₃ are disposed on the −Y side of fiducial mark plate 23, corresponding to the three beam irradiation units 30₁ to 30₃, respectively. Faraday cups 44₁, 44₂, 44 ₃ are disposed on the −Y side of fiducial marks FM₁, FM₂ and FM₃, respectively. Faraday cups 44₁, 44₂ and 44₃ detect the beam currents of electron beams EB from beam irradiation units 30₁ to 30₃, respectively, and supply such detection information to controller 20 (see FIG. 16). The distance between the plurality of the beam monitors may be the same as the distance between the optical axis of the plurality of beam irradiation units.

Shaping apparatus main section 10 is further provided with a back-scattered electron detection unit 54 (see FIG. 16) that has three back-scattered electron detectors 52 for individually detecting electrons back-scattered from fiducial marks FM₁, FM₂ and FM₃. Back-scattered electron detection unit 54 is disposed near beam irradiation section 16, though the illustration is omitted in the other drawings than FIG. 16. Back-scattered electron detection unit 54 has, for example, a holding member, and at least three back-scattered electron detectors 52 disposed at the holding member at a predetermined spacing in the X-axis direction. As back-scattered electron detector 52, a semiconductor detector, a scintillator, a microchannel plate, or the like is employed. Here, the semiconductor detector is assumed to be employed as the back-scattered electron detector.

At the times such as when acquiring information for calibrating the beam irradiation positions to be described later, each of back-scattered electron detectors 52 detects a back-scatter component generated from fiducial mark FMᵢ irradiated by electron beam EB from beam irradiation unit 30ᵢ (i=1 to 3) (component of the electron beam (energy beam) via the fiducial mark), in this case a back-scattered electron, and sends a detection signal corresponding to the back-scattered electron that has been detected to controller 20 (FIG. 16). Here, after the detection signal of each back-scattered electron detector 52 is amplified by an amplifier in a signal processor 56, the signal processing is performed, and the processing results are sent to controller 20.

Note that in order to prevent contamination of back-scattered electron detectors 52 due to outgassing, sputtering, or debris, back-scattered electron detection unit 54 may be normally stored in a predetermined storage position within housing 100A, and when detecting the fiducial marks, such as for example, when acquiring the information for calibrating the beam irradiation positions to be described later, back-scattered electron unit 54 may be taken out of the storage position and moved to a position near beam irradiation section 16 by a carrier system (not illustrated) under the control of controller 20.

In shaping apparatus main section 10 according to the present embodiment, as shown in FIG. 2, a shaping material supply unit 41, a powder feeder 46 (a rake member) and preheating unit 50 are disposed facing the +X side half of rotation table 22. Shaping material supply unit 41 and powder feeder 46 each configure a part of powder coating system 18 (see FIGS. 1 and 2).

Shaping material supply unit 41 is a device for supplying powdered shaping material (here, metal powder) BM (see FIG. 1) onto shaping plate MP of table section 32. Shaping material supply unit 41 is disposed on the +Y side of powder feeder 46. Note that shaping material supply unit 41 will further be described later.

Powder feeder 46 is made up of a frame-shaped member elongated in the X-axis direction having a predetermined width, the length thereof is equal to or slightly longer than the length in the X-axis direction of frame-shaped section 24c of table base 24.

Preheating unit 50 has a length that is substantially the same as the length of powder feeder 46, and is disposed adjacently (with a predetermined spacing in between) on the −Y side of powder feeder 46. In the present embodiment, for example, an ultraviolet lamp (UV lamp) is employed as preheating unit 50. As the UV lamp, such as for example, a mercury lamp that radiates ultraviolet light having a wavelength from 254 nm to 313 nm with the center wavelength of 365 nm, and a metal halide lamp that radiates ultraviolet ray having a wavelength in a wide range from 200 nm to 450 nm are known, and either one of the mercury lamp and the metal halide lamp can be employed as preheating unit 50. In alternative embodiments, broadband light sources such as infrared and visible lamps may be used in preheating unit 50.

As shown in FIG. 1, preheating unit 50 and powder feeder 46 are disposed at a height position so that the respective lower end surfaces is set above the upper end surface of frame-shaped section 24c by a predetermined clearance (interspace, gap) when table device 12 is moved under preheating unit 50 and powder feeder 46. In FIG. 1, powder feeder 46 is hidden behind preheating unit 50 on the paper surface.

The positional relationship in planar view between the constituents of shaping apparatus main section 10 will be described now. As shown in FIG. 3, the three beam irradiation units 30₁ to 30₃ are disposed at a predetermined spacing on reference line LH described earlier, to be spaced apart from axis AR1, and powder feeder 46 is disposed on an extension line of reference line LH, at a predetermined distance apart from axis AR1 toward the +X side. The center of powder feeder 46 in its width direction (Y-axis direction) substantially coincides with reference line LH. Preheating unit 50 and shaping material supply unit 41 are adjacently disposed on one side (−Y side) and the other side (+Y side) in the Y-axis direction, respectively, with powder feeder 46 in between.

Shaping material supply unit 41 is a device for temporarily storing powdered shaping material BM (see FIG. 1), comprising a supply port having a predetermined length and a predetermined width that can be opened and closed by a lid part (not illustrated) provided at the lower end surface (−Z side surface) of shaping material supply unit 41. In the present embodiment, as shaping material BM, for example, metal powder, such as for example, titanium powder or stainless steel powder is employed. Hereinafter, shaping material supply unit 41 is called a powder hopper 41 focusing on its function.

Powder hopper 41 may be equipped with a first powder hopper that has a first supply port and supplies the shaping material from the first supply port, and a second powder hopper that has a second supply port different from the first supply port and supplies the shaping material from the second supply port. In this case, the first powder hopper and the second powder hopper may store metal powder of a same kind or may store metal powder of different kinds inside thereof.

The lid part of powder hopper 41 is configured to be opened and closed by an actuator 43 (see FIG. 16) and actuator 43 is controlled by controller 20 (see FIG. 16). By the lid part coming into an opened state, shaping material BM in powder hopper 41 is discharged via the supply port. Further, powder hopper 41 is connected to a shaping material supply device (hereinafter, shortly referred to as a material supply device) 48 (see FIG. 16) disposed external to housing 100A via a material supply tube (not illustrated). Therefore, it becomes possible to supply shaping material BM from material supply device 48 to powder hopper 41 when needed, which prevents operation stop (meaningless downtime) from occurring due to shortage of shaping material BM in powder hopper 41. The supply of shaping material BM via the material supply tube from material supply device 48 is controlled by controller 20. The material supply device may be positioned outside the vacuum area.

Note that a load lock chamber (not illustrated) is provided on the −Y side of housing 100A and the −Y side wall of housing 100A also serves as a boundary wall between housing 100A and the load lock chamber, and a vacuum side door of the load lock chamber is provided at this boundary wall. As the vacuum side door, a gate valve that opens and closes an opening formed at the boundary wall is employed. Hereinafter, this vacuum side door (gate valve) is referred to as a gate valve 62A (see FIG. 16).

In the load lock chamber, a carrier robot made up of, for example, a multi-joint robot (as an example, a horizontal multi joint robot (SCARA robot)) is provided that unloads shaping plate MP with a completed shaping object (lump of shaping material BM enclosing the desired shaped part) mounted thereon. The carrier robot is configured to be capable of reaching into housing 100A, in a state where gate valve 62A is opened, receiving shaping plate MP on table 26 together with the shaping object and carrying them into the load lock chamber.

The load lock chamber is also provided with an atmospheric side door, separately from the vacuum side door. As the atmospheric side door, a gate valve that opens and closes an opening formed on the atmospheric side door is employed. Hereinafter, this atmospheric side door is referred to as a gate valve 62B (see FIG. 16). Gate valve 62B is closed during the shaping work. On the other hand, gate valve 62A may be opened during the shaping work if a vacuum state inside the load lock chamber is maintained at about the same degree as the inside of housing 100A (vacuum chamber 100A). In the present embodiment, however, gate valve 62A is also closed during the shaping work, and when gate valve 62A needs to be opened, the load lock chamber should be evacuated prior to opening gate valve 62A.

Gate valve 62A and gate valve 62B are controlled by controller 20 (see FIG. 16).

In the present embodiment, evacuation of the inside space of vacuum chamber (housing) 100A and evacuation of the inside of the load lock chamber are performed by different vacuum pumps.

Although the description goes out of sequence, the movement operation of table device 12 along a circulation path in shaping apparatus 100 according to the present embodiment will be described now on the basis of FIGS. 3 to 10. This movement is performed by controller 20 via movement system 14. As is described earlier, in the present embodiment, table device 12 is configured to maintain a constant orientation , i.e. the orientation shown in the drawings such as FIGS. 1 and 2 (with back plate section 24 being parallel to the XZ plane). This point will also be described below.

Note that only frame-shaped section 24c of table base 24 is shown, as table device 12, in the plan views of FIGS. 3 to 10, for the sake of convenience in the illustration and the description. That is, the illustration of base section 24a, back plate section 24b, table section 32 and the like of table base 24 is omitted. As is clear from the description made earlier, in the present embodiment, the rotation center (rotation axis) of rotation table 22 is axis AR1 and the rotation center (rotation axis) of table device 12 is axis AR2, but the description of these rotation centers will be omitted properly in the following explanation of the movement operation of table device 12 along the circulation path.

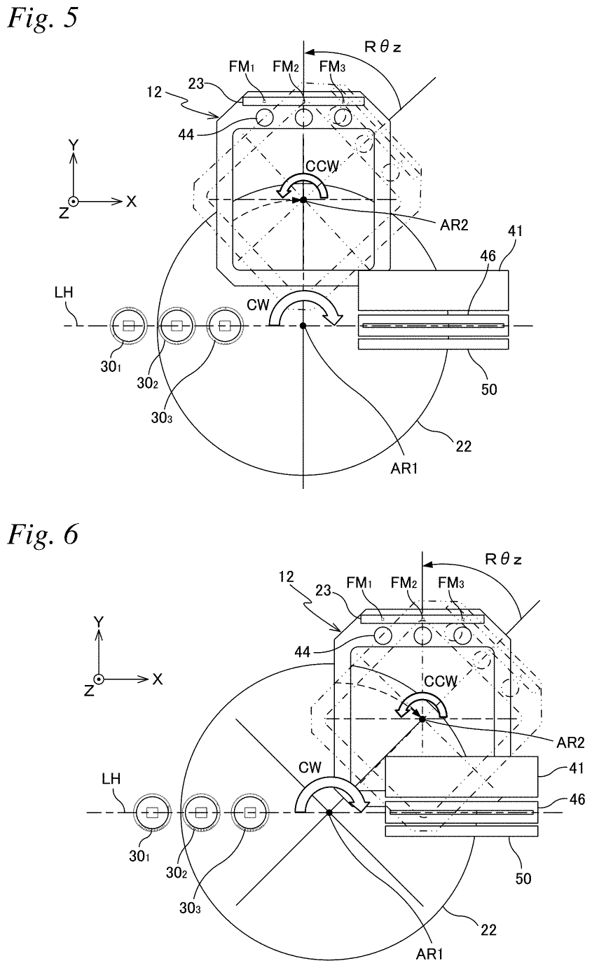

In a reference state, table device 12 is assumed to be at a position shown in FIG. 3. The case is considered where, from this reference state, rotation table 22 (and drive gear 21) is driven, by motor 28 of movement system 14, to rotate in a clockwise direction in planner view (hereinafter, shortly referred to as a clockwise direction) indicated by an arrow CW. When rotation table 22 is driven to rotate by an angle of 45 degrees in the clockwise direction shown by arrow CW from the reference state shown FIG. 3, rotation table 22 comes into a state shown in FIG. 4.

In the state shown in FIG. 4, by the rotation of rotation table 22, a line segment (hereinafter, referred to as a moving radius (AR1-AR2)) that connects the reference point (axis AR2) of table device 12 and the rotation center (axis AR1) of rotation table 22 is moved to a position angled at -45 degrees with respect to reference line LH. Here, if driven gear 29 were not provided, rotation table 22 should remain in an orientation indicated by two-dot chain lines (virtual lines) in FIG. 4, i.e. the same orientation as the reference state with respect to rotation table 22. However, in the present embodiment, driven gear 29 rotates by an angle of 45 degrees in a counterclockwise direction in planar view (hereinafter, shortly referred to as a counterclockwise direction) indicated by an arrow CCW in conjunction with the rotation of rotation table 22 (and drive gear 21) in the arrow CW direction, and by this rotation of driven gear 29, table device 12 maintains the orientation indicated by solid lines in FIG. 4.

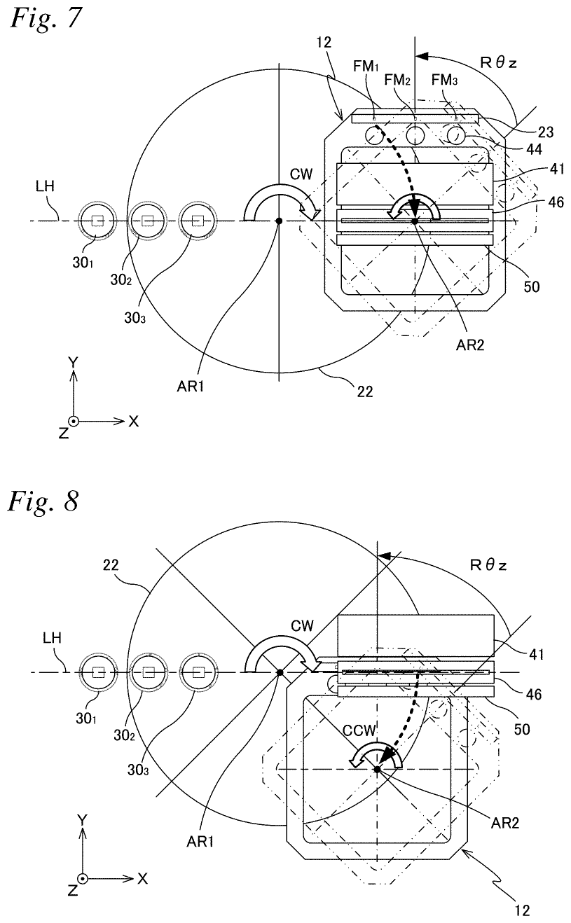

Note that the rotation of an angle of 45 degrees in the counterclockwise direction indicated by arrow Rθz in FIG. 4 is not performed after the reference point (axis AR2) of table device 12 has been moved to the position shown in FIG. 4, but is performed while the reference point of table device 12 is being moved from the position shown in FIG. 3 to the position shown in FIG. 4. However, for the sake of convenience in the illustration and for the sake of simplifying and clarifying the description, FIG. 4 shows the rotation of table device 12 as if table device 12 rotates by an angle of 45 degrees in the counterclockwise direction after the reference point of table device 12 has been moved to the position shown in FIG. 4. The same can be said for FIGS. 5 to 10 to be described below.

When rotation table 22 (and drive gear 21) is further driven by motor 28 to rotate an additional 45 degrees in the clockwise direction indicated by arrow CW from the state shown in FIG. 4, table device 12 comes into a state shown in FIG. 5.

In the state shown in FIG. 5, the moving radius (AR1-AR2) of table device 12 has been moved to a position angled at -90 degrees with respect to reference line LH, by the rotation of rotation table 22. During the motion from the state shown in FIG. 4 to the state shown in FIG. 5, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 5.

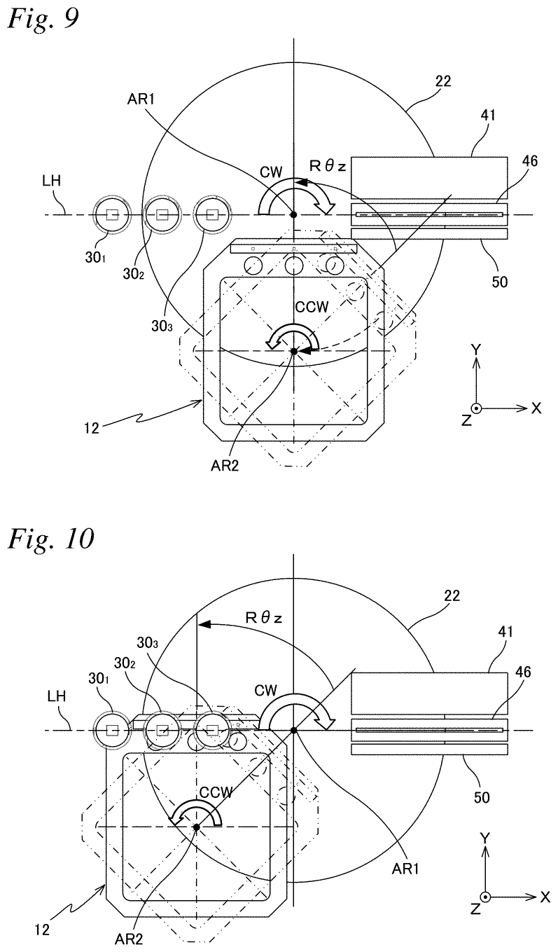

When rotation table 22 (and drive gear 21) is further driven by motor 28 to rotate by an angle of 45 degrees in the clockwise direction indicated by arrow CW from the state shown in FIG. 5, table device 12 comes into a state shown in FIG. 6.

In the state shown in FIG. 6, by the rotation of rotation table 22, the moving radius (AR1-AR2) of table device 12 has been moved to a position angled at -135 degrees with respect to reference line LH. In the present embodiment, during the motion from the state shown in FIG. 5 to the state shown in FIG. 6, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 6.

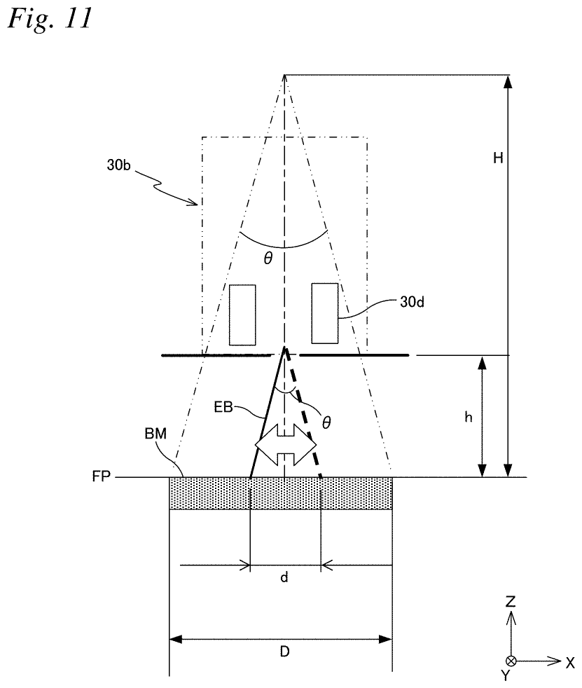

When rotation table 22 (and drive gear 21) is further driven by motor 28 to rotate by an angle of 45 degrees in the clockwise direction indicated by arrow CW from the state shown in FIG. 6, table device 12 comes into a state shown in FIG. 7.

In the state shown in FIG. 7, the moving radius (AR1-AR2) of table device 12 has been moved to a position angled at -180 degrees with respect to reference line LH. In the present embodiment, during the motion from the state shown in FIG. 6 to the state shown in FIG. 7, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 7.

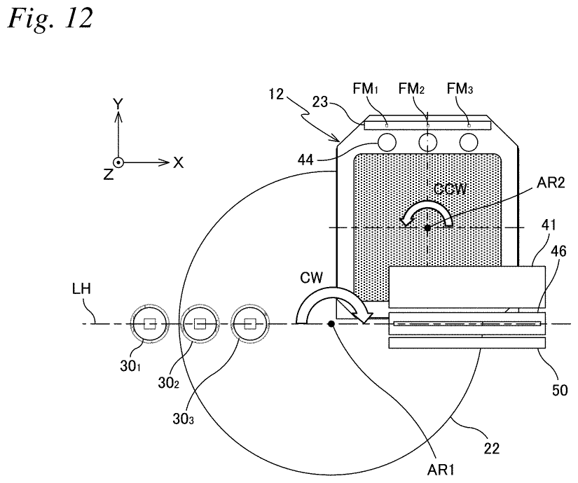

When rotation table 22 (and drive gear 21) is further driven by motor 28 to rotate by an angle of 45 degrees in the clockwise direction indicated by arrow CW from the state shown in FIG. 7, table device 12 comes into a state shown in FIG. 8.

In the state shown in FIG. 8, the moving radius (AR1-AR2) of table device 12 has been moved to a position angled at −225 degrees with respect to reference line LH. In the present embodiment, during the motion from the state shown in FIG. 7 to the state shown in FIG. 8, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 8.

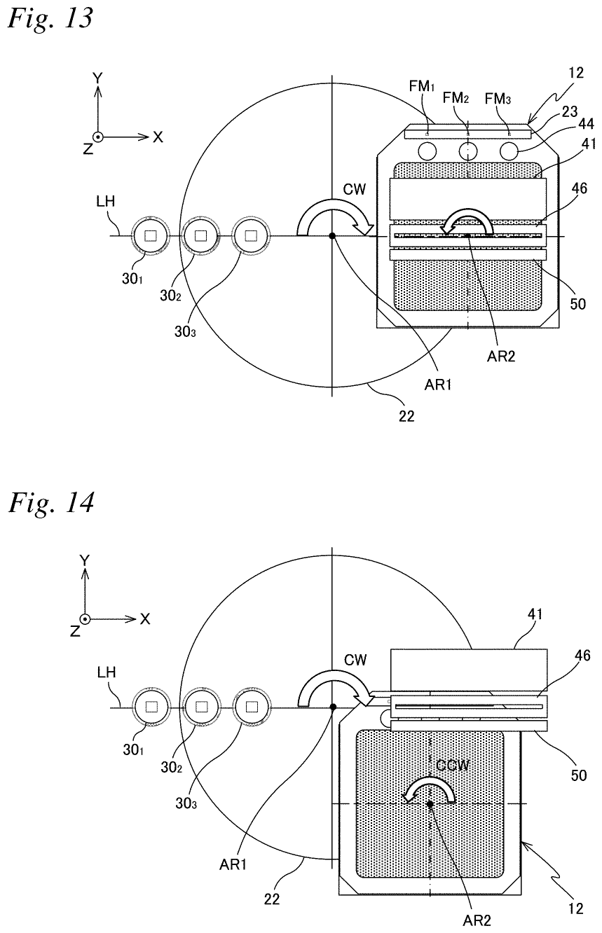

When rotation table 22 (and drive gear 21) is further driven by motor 28 to rotate by an angle of 45 degrees in the clockwise direction indicated by arrow CW from the state shown in FIG. 8, table device 12 comes into a state shown in FIG. 9.

In the state shown in FIG. 9, the moving radius (AR1-AR2) of table device 12 has been moved to a position angled at −270 (+90) degrees with respect to reference line LH. In the present embodiment, during the motion from the state shown in FIG. 8 to the state shown in FIG. 9, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 9.

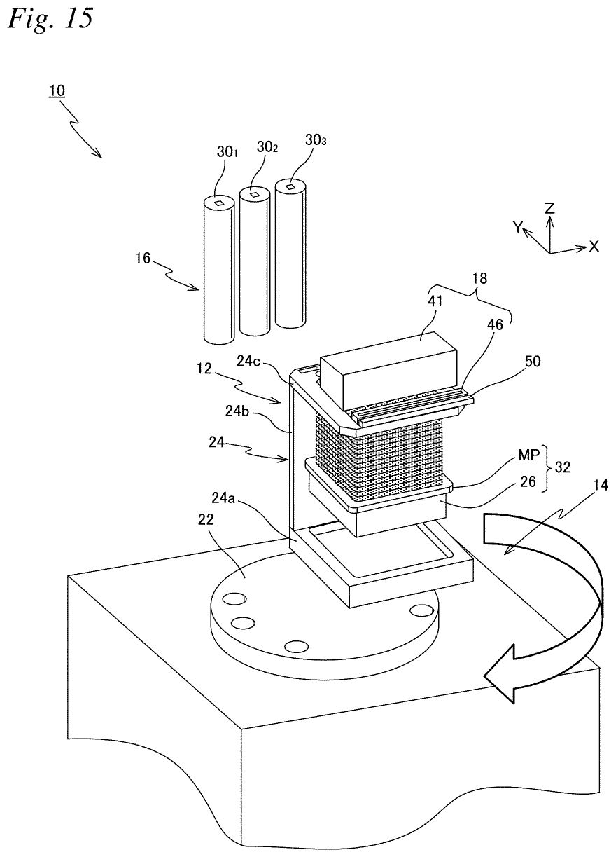

When rotation table 22 (and drive gear 21) is further driven by motor 28 to rotate by an angle of 45 degrees in the clockwise direction indicated by arrow CW from the state shown in FIG. 9, table device 12 comes into a state shown in FIG. 10.

In the state shown in FIG. 10, the moving radius (AR1-AR2) of table device 12 has been moved to a position angled at −315 (+45) degrees with respect to reference line LH. In the present embodiment, during the motion from the state shown in FIG. 9 to the state shown in FIG. 10, rotation table 22 (and drive gear 21) rotates by an angle of 45 degrees in the clockwise direction indicated by arrow CW, and in conjunction therewith, driven gear 29 rotates by an angle of 45 degrees in the counterclockwise direction indicated by arrow CCW. By this rotation of driven gear 29, table device 12 maintains the orientation shown in solid lines in FIG. 10.

When rotation table 22 (and drive gear 21) is further driven by motor 28 to rotate by an angle of 45 degrees in the clockwise direction indicated by arrow CW from the state shown in FIG. 10, table device 12 comes into the reference state shown in FIG. 3.

In the reference state shown in FIG. 3, as a matter of course, the moving radius (AR1-AR2) of table device 12 is located on reference line LH. In the present embodiment, during the motion from the state shown in FIG. 10 to the state shown in FIG. 3, rotation table 22 (and drive gear 21) rotates by an angle of 45 degrees in the clockwise direction indicated by arrow CW, and in conjunction therewith, table device 12 rotates together with driven gear 29 by an angle of 45 degrees in the counterclockwise direction indicated by arrow CCW to be in the reference state of FIG. 3.

In the above description, the movement operation of table device 12 along the circulation path is explained focusing the rotation position of rotation table 22 at an angular interval of 45 degrees, in order to facilitate the understanding of the movement operation as whole. In actuality, however, drive gear 21 and rotation table 22 continuously and repeatedly rotate in a range of 0 degree to 360 degrees in the clockwise direction indicated by arrow CW and in conjunction therewith, the driven gear and table device 12 rotate in the counterclockwise direction indicated by arrow CCW. Consequently, the movement of table device 12 is performed continuously at a substantially constant angular velocity.

As is clear from the description made so far, in the present embodiment, table 26, drive mechanism 31 and table base 24 configure a support member that supports shaping plate MP serving as a support surface member. That is, in the present embodiment, the support member includes all the constituting members of table device 12, except for shaping plate MP.

In the present embodiment, a first movement device that moves table device 12 along the circular circulation path described earlier is configured including motor 28, and rotation table 22 being a movable member which is fixed to drive shaft 28a of motor 28 and on which table device 12 is mounted. Rotation table 22 (the movable member) is moved by the first movement device, and thereby table device 12 (including the support member described above) is moved with respect to beam irradiation section 16 as a beam irradiation device.

Further, in the present embodiment, a second movement device that moves table device 12 is configured including drive gear 21, driven gear 29, shaft member 27 that is supported rotatably by rotation table 22 and connected to table device 12, and the like. Table device 12 is moved by the second movement device, in conjunction with change in position within the horizontal plane of table device 12 that is moved by the first movement device, so that the orientation within the horizontal plane of table device 12 is maintained.

As is clear from the above description, movement system 14 includes the first movement device and the second movement device.

Formation of layers of shaping material performed in shaping apparatus main section 10 according to the present embodiment will be described now.

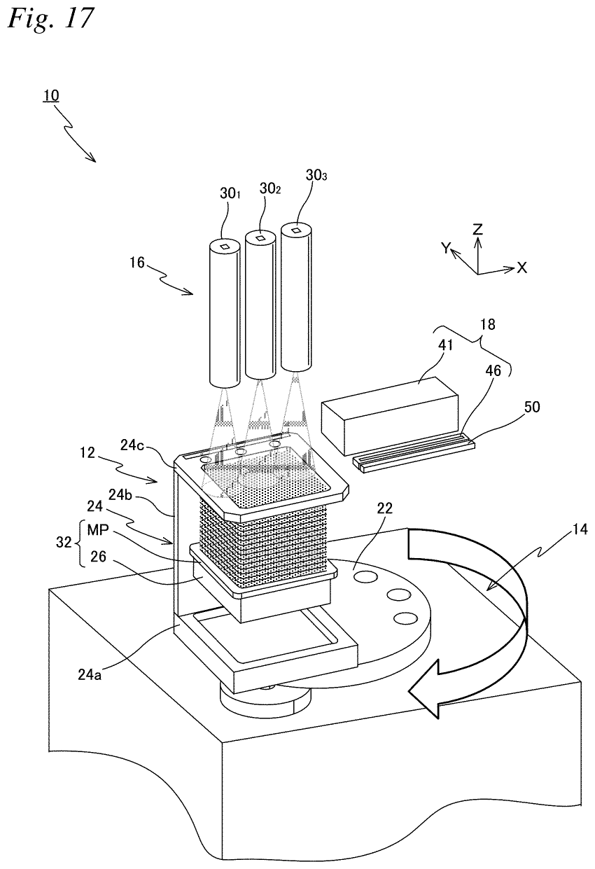

When table device 12 arrives at a position shown in FIG. 12 (and FIG. 6) by the rotation in the clockwise direction around axis AR1 of rotation table 22 of movement system 14 and the rotation in the counterclockwise direction around axis AR2 of table device 12, controller 20 detects that table device 12 has arrived at a material supply position from measurement information of position measurement system 42, and opens the lid of the supply port of powder hopper 41 via actuator 43. Thus, the supply of shaping material BM from powder hopper 41 via the opening of frame-shaped section 24c onto support surface SS of shaping plate MP is started. At this time, rotation table 22 is rotating in the clockwise direction at a constant rotational speed, and in conjunction (in synchronous) with this rotation, table device 12 is rotating counterclockwise at the same constant rotational speed, and therefore there is no angular acceleration of table device 12.

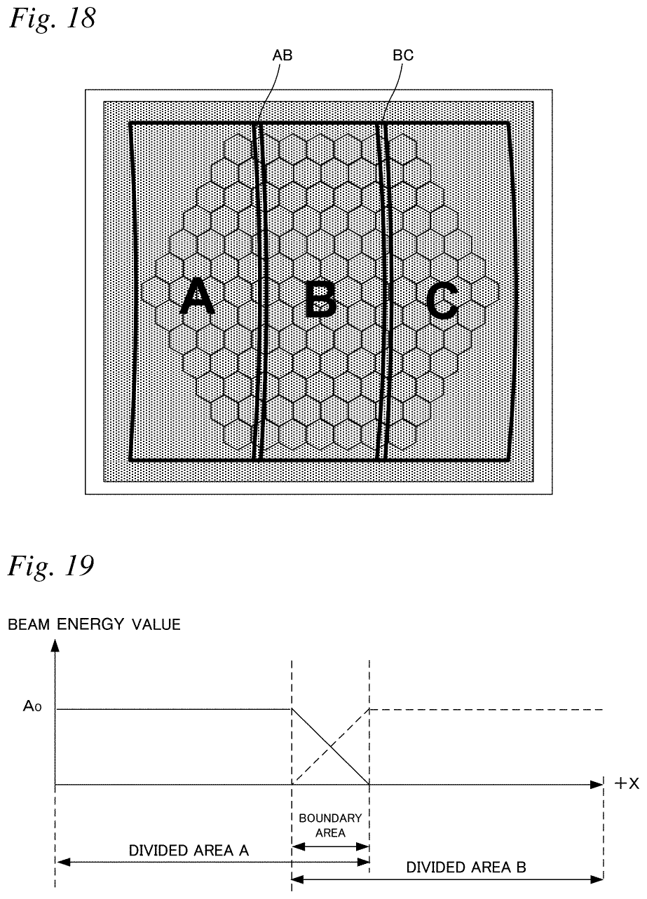

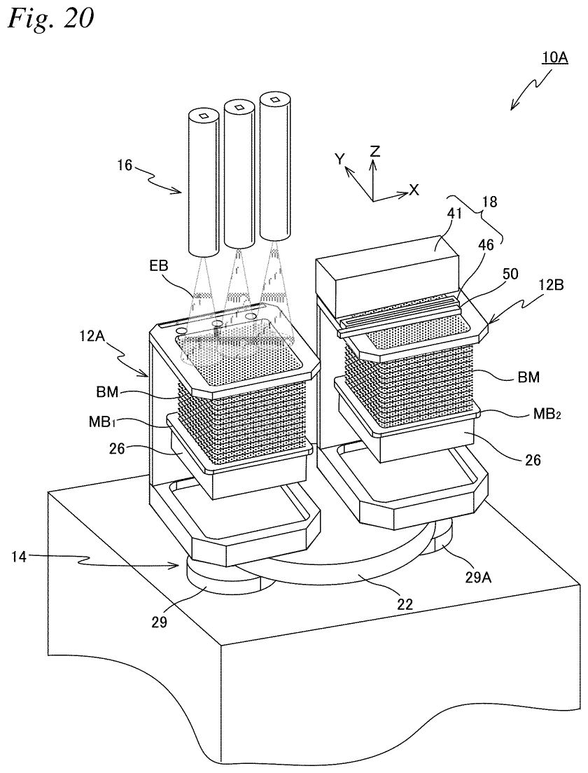

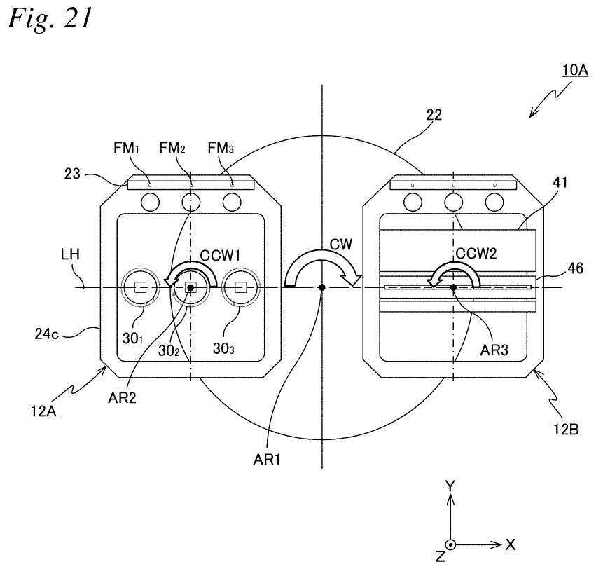

As the drive of table device 12 by movement system 14 without angular acceleration is continued, table device 12 is moved approximately along the −Y direction to a position shown in FIG. 14 (and FIG. 8) via a position shown in FIG. 13 (and FIG. 7). During this movement, the supply of shaping material BM onto support surface SS, the leveling of the face of the supplied shaping material BM, and preheating of shaping material BM whose face has been leveled using preheating unit 50 are performed. When table device 12 arrives at a position shown in FIG. 14 (and FIG. 8), controller 20 detects that table device 12 has arrived at a material supply cutoff position from measurement information of position measurement system 42, and closes the lid of the supply port of powder hopper 41 via actuator 43. In this case, the leveling of the surface of shaping material BM is realized, by table device 12, in a state where shaping material BM has been supplied onto support surface SS (shaping plate) but before such shaping material is levelled, being moved directly under powder feeder 46 substantially in the −Y direction, as shown in FIG. 15 for example. Powder feeder 46 comprises a leveling element (not shown) such as a stationary rake that levels the surface of shaping material BM. As table device 12 is moved from the position shown in FIG. 12 to the position shown in FIG. 14 (a position at which the −Y side end of powder feeder 46 coincides with the +Y side end of the opening of frame-shaped section 24c), the leveling element of powder feeder 46 forms a substantially planar upper surface of shaping material BM. That is, by the relative movement of table device 12 and powder feeder 46 described above, powder feeder 46 traverses a work area on table section 32, leveling the shaping material BM supplied onto support surface SS (shaping plate), and layers of shaping material BM (powder bed) spread over table section 32 are formed. In embodiments where the top surface of frame-shaped section 24c is coplanar with the bottom of the leveling element of powder feeder 46, frame-shaped section 24c also has a role of restricting the height of shaping material BM.

Here, a first layer of powder bed is formed on support surface SS (shaping plate 1VIP) by suppling the powder to the support surface SS (shaping plate 1VIP), but in the case of a second layer and subsequent layers, a next layer of powder bed is formed on a previous layer of powder bed formed on support surface SS by suppling the powder to the previous layer. In this application, suppling the powder for forming the next layer onto the previous layer may be referred to as “suppling the powder to the shaping plate MP.”

Note that actually table device 12 is moved along a circular path with a radius slightly smaller than the radius of rotation table 22, and therefore table device 12 is not moved linearly toward the −Y direction directly under powder feeder 46 but is moved toward the −Y direction along an arc-shaped path. However, for the sake of simplifying the description here, table device 12 is assumed to be moved substantially along the Y-axis direction toward the −Y direction directly under powder feeder 46.

In the present embodiment, as is described earlier, powder coating system 18 is configured including powder hopper 41 (including actuator 43 that opens and closes the lid part of the supply port) and powder feeder 46, and a shaping material supply system comprises powder coating system 18 and material supply device 48.

FIG. 16 shows in a block diagram the input/output relationship of controller 20 that centrally configures a control system of shaping apparatus 100. In FIG. 16, each of beam irradiation units 30₂ and 30₃ actually includes generating source 30a (not shown) of electrons and electron beam optical system 30b (not shown), like beam irradiation unit 30₁. Each electron beam optical system 30b includes its constituent elements (such as the electrostatic lens, the electromagnetic lens, the correction coil, and the deflection lens). Controller 20 includes a microcomputer and the like, and performs overall control of the constituent parts of shaping apparatus 100 including each of the parts shown in FIG. 16. Controller 20 controls movement system 14 and beam irradiation section 16 (beam irradiation units 30₁ to 30₃) on the basis of 3D data of shaping objects (here, three-dimensional CAD data) so that the electron beams are selectively irradiated on only a necessary part of the shaping material spread over the work area on table 26 (support surface SS), with the shaping material serving as a target. In the present embodiment, the three-dimensional CAD data can be inputted to controller 20 via an optical disk (DVD disk, blue ray disk) or the like inserted into an optical drive that controller 20 has, or can directly be inputted to controller 20 via an input device such as a keyboard, or can be inputted to controller 20 via a communication line such as LAN or internet line. These input means can be generically called an input device. Concerning the input of the three-dimensional CAD data to the controller, the same can be said for a second embodiment and a third embodiment to be described later. Controller 20 is equipped with the input device for inputting the 3D data (three-dimensional CAD data) of shaping objects.

The flow of processing in shaping apparatus 100 according to the present embodiment is as follows.

First of all, motor 28 of movement system 14 is driven by controller 20 and thereby rotation table 22 and drive gear 21 are driven to rotate in the clockwise direction, and after a predetermined time elapses since the drive start, the rotational speed of rotation table 22 reaches a predetermined target rotational speed (assumed to be Vt). The drive of motor 28 is controlled by controller 20 thereafter so that rotation table 22 continues to rotate in the clockwise direction at such target rotational speed Vt. In conjunction with constant speed rotation (steady rotation) of rotation table 22 in the clockwise direction at target rotational speed Vt, constant speed rotation (steady rotation) of table device 12 is performed with a rotational speed ratio of 1:1 in the counterclockwise direction with axis AR2 serving as the center, as is described earlier. With this configuration, the orientation of table device 12 within the XY-plane is maintained at a constant orientation all the time.

By the constant speed rotation of rotation table 22 at target rotational speed Vt described above, table device 12 is moved at a constant speed along the circular circulation path with the moving radius (AR1-AR2) serving as a radius, and during this movement the orientation of table device 12 within the XY-plane is always maintained at a constant orientation. This constant speed movement of table device 12 along the circulation path with the orientation of table device 12 within the XY-plane being maintained is continued until the irradiation of the electron beams to a last layer of powder bed on table section 32 is completed. On this premise, the explanation will be made below.

When table device 12 is moved along the circulation path and arrives at the position shown in FIG. 12 (and FIG. 6), controller 20 detects that table device 12 has arrived at the material supply position from the measurement information of position measurement system 42, and opens the lid of the supply port of powder hopper 41. Thus, the formation work of a first layer of powder bed (i.e. the spreading work of a layer of shaping material BM) on table 26 (shaping plate MP) following the foregoing procedures is started. At this time, the shaping material does not exist on shaping plate MP and the upper surface of shaping plate MP is at a position lower than the upper surface of frame-shaped section 24c by a predetermined distance ΔZ. The distance ΔZ corresponds to the thickness of one layer of layers of shaping material BM (powder bed).

After the formation work of the first layer of powder bed is started, table device 12 is moved substantially along the Y-axis direction toward the −Y direction directly under powder feeder 46 from the position shown in FIG. 12 (and FIG. 6) to the position shown in FIG. 14 (and FIG. 8) via the position shown in FIG. 13 (and FIG. 7), and thereby shaping material BM supplied onto the table section 32 is leveled by powder feeder 46 and the first layer of shaping material BM (the first layer of powder bed) spread over table section 32 is formed.

Note that controller 20 is capable of calculating the coordinate position on the XY coordinate system of the reference point (axis AR2) of table device 12 with respect to each rotation position of rotation table 22, on the basis of the measurement information of position measurement system 42. Therefore, a configuration capable of adjusting the position of table 26 in the X-axis direction on table base 24 on the basis of results of this calculation may be employed.

Slightly later than the start of powder bed formation, the first layer of powder bed (shaping material BM) that has been formed starts to pass directly under preheating unit 50, and preheating of the powder bed by preheating unit 50 is begun. Energy of ultraviolet radiation irradiated from preheating unit 50 is converted into heat, the temperature of shaping material BM (metal powder) is raised, which allows the shaping material to be the preheated to a desired temperature. In some embodiments, this desired temperature is sufficiently high to sinter the shaping material, forming connections between the powder particles that can withstand electrostatic repulsion (often called “smoking” of the powder). This preheating has been completed at the point in time when table device 12 arrives at the position shown in FIG. 14 (and FIG. 8). However, the first layer of powder bed does not necessarily have to be preheated.

After that, just before table device 12 arrives at the position shown in FIG. 10 via the position shown in FIG. 9, the three fiducial marks FM₁ to FM₃ on fiducial mark plate 23 are located below the three beam irradiation units 30₁, 30₂ and 30₃, respectively, and the electron beams from the three beam irradiation units 30₁, 30₂ and 30₃ are irradiated on the corresponding fiducial marks FM₁, FM₂ and FM₃, respectively. Back-scattered electrons from fiducial marks FM₁, FM₂ and FM₃ are individually detected by the three back-scattered electron detectors 52 of back-scattered electron detection unit 54, respectively, and the detection signals from the three back-scattered electron detectors 52 are supplied to signal processor 56. Signal processor 56 obtains the relative position within the XY-plane between optical axis AXᵢ (i=1 to 3) of electron beam optical system 30b of each of beam irradiation units 30₁, 30₂ and 30₃, and fiducial mark FMᵢ, on the basis of the detection signal from each of the three back-scattered electron detectors 52. On the basis of information on the relative position within the XY-plane between optical axis AX, of electron beam optical system 30b of each of beam irradiation units 30₁, 30₂ and 30₃, and fiducial mark FMᵢ, and on the basis of measurement information on the position of table device 22 by position measurement system 42 at the time of detecting each fiducial mark FMᵢ, controller 20 obtains a displacement from the reference position of optical axis AX, of electron beam optical system 30b of each of beam irradiation units 30₁, 30₂ and 303, and stores information on the displacement (calibration information).

Then, shortly after table device 12 arrives at the position shown in FIG. 10, the powder bed on table 26 (shaping plate MP) is located under the three beam irradiation units 30₁, 30₂, and 30₃. Controller 20 then starts selective irradiation of electron beams EB to (irradiation to at least a part of) the first layer of shaping material BM on table 26 from the three beam irradiation units 30₁, 30₂ and 30₃ (see FIG. 17). At this time, on the basis of the acquired calibration information, the displacement from the reference position of optical axis AXᵢ of electron beam optical system 30b of each of beam irradiation units 30₁, 30₂ and 30₃ is corrected via the deflection lens (compensation of position and alignment errors is performed). Note that FIG. 17 shows a state where several layers of powder bed have already been formed on table 26 (shaping plate MP) and therefore FIG. 17 is not a view showing a state of irradiating electron beams EB to the first layer of powder bed. However, the operation of the irradiation of the electron beams to the first layer of powder bed from the three beam irradiation units 30₁, 30₂ and 30₃ is similar to the scene shown in FIG. 17.

The selective irradiation of electron beams EB is performed by the controller according to two-dimensional shape data obtained beforehand by slicing a shaping object (a shaping object expressed by three-dimensional CAD data) at a ΔZ interval (the ΔZ interval corresponds to the thickness of each layer of shaping material BM (powder bed)). In this case, the three-dimensional CAD data is converted into, for example, STL (Stereo Lithography) data, and data of each layer (laminate) obtained from this three-dimensional STL data by further performing slicing in the Z-axis direction is used as the two-dimensional shape data.

By the selective irradiation of electron beams EB, shaping material BM (metal powder) in an area corresponding to the two-dimensional shape data is melted. At this time, controller 20 controls deflection lens 30d of each beam irradiation unit 30, to deflect electron beam EB within a range of the swing width d in the X-axis direction and the Y-axis direction, thereby starting selective melting of the first layer of shaping material BM (powder bed) on table 26 (shaping plate MP), and performs irradiation control of electron beams EB while table device 12 is moved substantially along the Y-axis direction toward the +Y direction from the position of the irradiate start of the electron beams to a position just before the position shown in FIG. 4 via the position shown in FIG. 3, thereby continuing the selective melting of the first layer of shaping material BM on table section 32. And, at the point in time when table device 12 arrives at the position just before the position shown in FIG. 4, controller 20 ends the irradiation of the electron beams (electron beams for melting) from beam irradiation units 30₁ to 30₃ to the first layer of shaping material BM on table 22. The melted shaping material BM is solidified as time elapses and its temperature cools.

During a period after the irradiation process of the electron beams for melting the first layer of the shaping material has been completed until formation of a second layer of powder bed is started, controller 20 moves table section 32 downward by the distance ΔZ via drive mechanism 31. At this time, the melted shaping material, of the first layer of the shaping material, is solidified.

Afterwards, when table device 12 arrives at the position shown in FIG. 12 (and FIG. 6), controller 20 opens the lid of the supply port of powder hopper 41. Accordingly, the second layer of powder bed is formed by new shaping material BM spread over the first layer of the shaping material a part of which has been solidified, in the procedures similar to those for the formation of the first layer of powder bed described earlier. In alternative embodiments, the second layer of powder may be spread over the first layer while portions of the shaping material are still molten. Further, slightly later than the formation start of the powder bed, the formed powder bed begins to pass directly under preheating unit 50, and the preheating of the powder bed using preheating unit 50 is started, and the preheating ends at the point in time when table device 12 arrives at the position shown in FIG. 14 (and FIG. 8).

In the second and subsequent layers of powder bed, thermal distortion of the shaping object is reduced because the preheating of the shaping material described above allows the internal stress of the solidified part of the previous layer of the shaping material to be at least partially released.

After completion of (1) the preheating, and (2) the acquisition of information for calibrating the beam irradiation positions of beam irradiation units 30₁, 30₂ and 30₃, the selective irradiation of the electron beams by beam irradiation units 30₁, 30₂ and 30₃ for the second layer of powder on table section 32. Thus, the irradiation process of the electron beams for melting the second layer of the shaping material (processing to the second layer of powder bed) is completed. Also, in the case of the second layer, the melted shaping material BM is solidified as a predetermined time in accordance with the material elapses.

Subsequent layers are formed by repeating similar procedures to the foregoing, thereby a shaping object is constructed on the support surface by forming the layers of shaping material BM (metal powder) that have been melted and solidified. More specifically, After the irradiation process of the electron beams for melting a layer of the shaping material has been completed, the following layer is formed by (1) the downward movement of table 26 by the distance ΔZ; (2) the formation of a next layer (a new uppermost layer) of shaping material BM; (3) the preheating of the uppermost layer of shaping material BM; (4) the acquisition of information for calibrating the beam irradiation positions of beam irradiation units 30₁, 30₂ and 30₃; and (5) the irradiation of the electron beams to the preheated uppermost layer of shaping material BM. Thus, a series of operations for shaping by PBF method of shaping apparatus 100 is completed.

After the series of operations for shaping has been completed, controller 20 drives drive mechanism 31 to move table 26 downward to a movement limit position in preparation for unloading of the constructed shaping object. Simultaneously, back-scattered electron detection unit 54 may be stored in a predetermined storage position within housing 10.

In shaping apparatus 100, on the construction of the shaping object described above, prior to the irradiation process of the electron beams for melting each layer of shaping material BM, the acquisition of information for calibrating the beam irradiation positions described earlier is performed after the preheating of such each layer. And, the deflection of the electron beams is controlled on the basis of the information (calibration information) obtained from the detection result of each of the three back-scattered electron detectors 52, thereby correcting the beam irradiation positions. This makes it possible to perform with high accuracy the control of the beam irradiation positions (position coordinates). However, the acquisition of the calibration information for the beam irradiation positions does not necessarily have to be performed for each layer. For example, when the calibration measurement of two or more layers is completed, the rate of alignment or calibration drift may be estimated, Beam irradiation positions (position coordinates) for subsequent layers may be estimated by extrapolating the drift.

After the foregoing series of operations for shaping by PBF method has been completed, controller 20 opens gate valve 62A on the vacuum side of the load lock chamber, and a lump of shaping material BM including the shaping object constructed on table section 32 is unloaded (carried out of housing 100A). An example of this unloading operation is described as follows.

Specifically, the foregoing carrier robot disposed in the load lock chamber causes the arm thereof to enter housing 100A and moves an end-effector section with a fork shape to below shaping plate MP on which the lump of shaping material BM including the constructed shaping object is placed. At this time, the adsorption of shaping plate MP by table 26 is released. Next, as the end-effector supports both ends (in the X-axis direction) of shaping plate MP, shaping plate MP is lifted integrally with the lump of shaping material BM, and they are separated from table 26 and carried into the load lock chamber.

Note that at the point in time when gate valve 62A on the vacuum side is opened, evacuation has been completed so that the inside of the load lock chamber is in a vacuum environment of approximately the same degree as the inside of housing (vacuum chamber) 100A.

After that, the carrier robot (or, in alternative embodiments, a second robot) carries another shaping plate onto table 26, and the arm of the robot (or second robot) returns into the load lock chamber, and then, gate valve 62A on the vacuum side of the load lock chamber is closed.

Note that the separation work of the lump of shaping material BM from shaping plate MP may be performed in the load lock chamber and shaping plate MP after the separation may be carried onto table 26 again.

After that, in housing 100A, the shaping work for constructing a next shaping object is started. Meanwhile, in parallel with the shaping work in housing 100A, in the load lock chamber unnecessary shaping material that is not solidified, of the lump of shaping material BM, is removed from the shaping object by compressed air or grit blasting. In preferred embodiments, the blasting grit is the same powder as shaping material BM. Prior to the removal work of this unnecessary shaping material, appropriate heat treatment, annealing, and natural or forced cooling of the shaping material is performed.

Then, after gate value 62B on the atmospheric side of the load lock chamber is opened, the shaping object is taken out to the outside. Afterwards, gate vale 62B is closed.

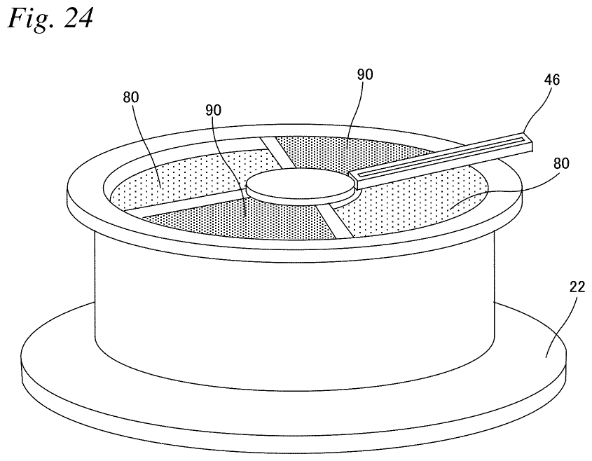

In shaping apparatus 100 according to the present embodiment, beam irradiation unit 30, is configured with a plurality of, as an example, three (i=1 to 3) of beam irradiation units 30ᵢ. Consequently, in shaping apparatus 100, during the irradiation of the electron beams to powder bed (layers of shaping material BM), the layer of the shaping material is divided into three belt-like areas with a partially annular shape (arc-shaped belt-like areas having a predetermined width) provided with reference signs A, B and C (referred to as a divided area A, a divided area B and a divided area C, respectively), as shown in FIG. 18 for example, and the irradiation of the electron beams to divided areas A, B and C are performed by the three beam irradiation units 30₁ to 303, respectively. That is, the shaping work to each layer of the shaping material can be shared among the three beam irradiation units.

In FIG. 18, a part of divided area A and a part of divided area B overlap and a part of divided area A and a part of divided area B overlap. Hereinafter, partially arc-shaped areas that overlap are called boundary areas. A boundary area AB between divided area A and divided area B can be irradiated by both of beam irradiation unit 30₁ and beam irradiation unit 30₂. In boundary area AB, the intensities of the respective electron beams irradiated from beam irradiation units 30₁ and 30₂ are set so that the sum of the beam energy value of the electron beam irradiated from beam irradiation unit 30₁ and the beam energy value of the electron beam irradiated from beam irradiation unit 30₂ is equal to the beam energy value in the other areas within divided area A. Beam energy delivered to each location can be varied by changing either (or both) of the beam power or the amount of irradiation time. Likewise, a boundary area BC between divided area B and divided area C shown in FIG. 18 is irradiated by both beam irradiation unit 30₂ and beam irradiation unit 30₃. In boundary area BC, the intensities of the respective electron beams irradiated from beam irradiation units 302 and 30₃ are set so that the sum of the beam energy value of the electron beam irradiated from beam irradiation unit 30₂ and the beam energy value of the electron beam irradiated from beam irradiation unit 30₃ is equal to the beam energy value in the other areas within divided area C.

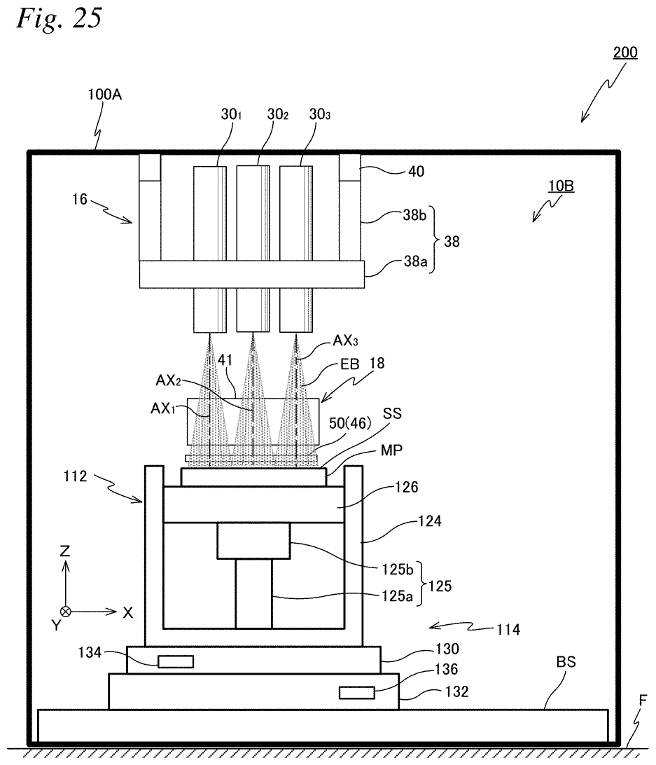

In this case, in boundary area AB for example, the beam energy value of the electron beam irradiated from beam irradiation unit 30₁ may gradually (linearly) decrease from a predetermined value Ao to zero, along the −X side end toward the +X side end, and the beam energy value of the electron beam irradiated from beam irradiation unit 30₂ may gradually (linearly) increase from zero to a predetermined value A₀, along the −X side end toward the +X side end, as shown in FIG. 19 for example. That is, in boundary area AB, gradation may be applied to the beam energy values and stitching of the patterns irradiated by beam irradiation units 30₁ and 30₂ may be performed. The same can be said for boundary area BC.

In the present embodiment, the deflection of electron beams EB and the movement of table device 12 substantially along the Y-axis direction toward the +Y direction are performed in parallel, thereby performing the drawing of the entire area of a target.

In shaping apparatus 100 according to the present embodiment, during the shaping work based on the shaping sequence described above, the irradiation (including the deflection) of the electron beams by beam irradiation units 30 is controlled by controller 20, on the basis of the position information within the XY-plane of table device 12 measured by position measurement system 42.

As is described so far, with shaping apparatus 100 according to the present first embodiment, while maintaining the orientation within the horizontal plane of table device 12 at a constant orientation, movement system 14 moves table device 12 within the horizontal plane along the circular circulation path having the moving radius (AR1-AR2) as its radius, with axis AR1 serving as the center. Then, while table device 12 makes one orbit along this circulation path, a series of processing for shaping such as the formation of powder bed (layers of shaping material BM) on table 12, the preheating of the formed powder bed, the acquisition of information for calibrating the irradiation positions of the electron beams and the selective irradiation of the electron beams is performed. Furthermore, since this series of processing can be performed in the midst of moving table device 12 at a constant speed (moving in a steady manner) without applying angular acceleration to table device 12, the shaping processing can be performed with high accuracy and high throughput.

In addition, according to shaping apparatus 100, since beam irradiation section 16 is equipped with the three beam irradiation units 30 disposed along the X-axis direction traversing the circulation path, significant improvement in productivity can be achieved, compared to the case where one beam irradiation unit 30 is employed. Further, a working distance of each beam irradiation unit 30 can be reduced, compared to the case where one beam irradiation unit 30 is employed, and accordingly, the apparatus can be downsized and also the control error of the irradiation coordinates (irradiation positions) of the electron beams can be reduced by decreasing influence of magnetic field disturbance. Especially, in the case of employing a configuration capable of irradiating a target with a plurality of beams as beam irradiation unit 30ᵢ, finer beam spots can be formed and more accurate beam deflection can be performed.

In this manner, with shaping apparatus 100 according to the present first embodiment, improvement in productivity as well as improvement in shaping accuracy can be realized at the same time.

Note that in the embodiment described above, as a result of maintaining the orientation within the XY-plane of table device 12 at a constant orientation during the rotation (during movement in the first rotation direction) of rotation table 22 on the premise that the upper surface (support surface) SS of shaping plate 1V11³ supported on table 26 is parallel to the horizontal plane, the attitude of support surface SS is kept constant. However, the attitude of support surface SS may be maintained to be constant by employing, as drive mechanism 31, a mechanism capable of adjusting not only the Z-position of table 26 but also the position in the Ox direction (a rotation direction around the X-axis) and the Oy direction (a rotation direction around the Y-axis) of table 26, and adjusting support surface SS of shaping plate MP supported on table 26 to be parallel to the XY-plane during the rotation of rotation table 22 using such a mechanism.

Further, in the case of employing the drive mechanism capable of performing position adjustment in three degrees of freedom of the Z, θx and the θy directions as described above, table 26 may be moved by the drive mechanism when table device 12 (including the support member described above) is moved by the foregoing first movement device, so that an angular relationship of an axis in the X-axis direction along support surface SS is maintained with respect to (e.g., remains parallel to) a plane containing the optical axes AXᵢ of each of beam irradiation units 30₁ to 30₃.

Note that, in the embodiment described above, the case has been exemplified where a system configured to rotate the drive gear and the driven gear engaged with each other in directions opposite to each other is employed as movement system 14, and as a result thereof, table device 12 is moved by the movement system along the circular circulation path. However, a circulation path is not limited to the circular one, and a movement system may be employed that moves table device 12 along a circulation path with a shape other than a circular shape such as an ellipse shape or an oval racetrack shape (i.e., two semicircles connected by two parallel line segments). That is, any movement system may be employed as far as such system moves a table device along a predetermined circulation path within the horizontal plane while maintaining the orientation of the table device within the horizontal plane at a constant orientation. And, the movement system does not have to be capable of moving the table device at a constant speed in all zones of the circulation path, but for example, may be capable of moving the table device at a constant speed only in a movement zone of the table device in which the electron beams are irradiated on powder bed, or in addition to such a movement zone, in a movement zone of the table device in which each layer of the powder bed is deposited and leveled on the table. The movement system may be a system that maintains the orientation of the table device within the horizontal plane at a constant orientation not in all zones of the circulation path but, for example, only in a zone in which the table device is moved at a constant speed. Further, the movement system may be a system that moves the table device along a predetermined circulation path by a mechanism other than the gear mechanism, such as for example, a belt mechanism.

In the embodiment described above, the case has been exemplified where the electron beams are deflected in the X-axis direction and the Y-axis direction, and simultaneously therewith, while table 26 supporting the shaping material is moved substantially along the Y-axis direction, shaping of a shaping object is performed by irradiating the shaping material with electron beams EB. However, table 26 may be movable in two axial directions within the horizontal plane, e.g. in the X-axis direction and the Y-axis direction orthogonal to each other. For example, in the case where the movement route of table device 12 is a route such as an arc-shaped route when the electron beams are selectively irradiated on powder bed on table 26, table 26 may be configured to be moved in the X-axis direction on table base 24, according to the position of table device 12 in the Y-axis direction.

### Second Embodiment

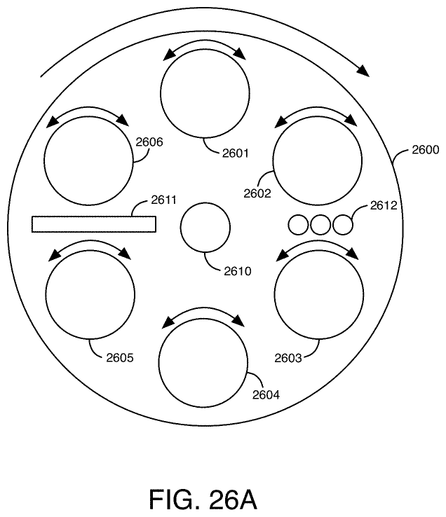

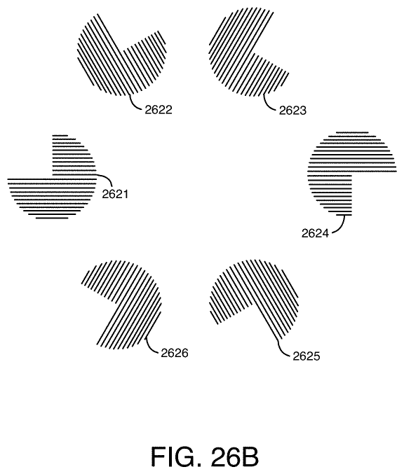

Next, a second embodiment will be described on the basis of FIGS. 20 and 21. The constituent parts that are the same as or equivalent to those of shaping apparatus 100 according to the first embodiment described earlier will be provided with the same reference signs, and the description thereof will be simplified or omitted.

FIG. 20 shows in a perspective view the configuration of a shaping apparatus main section 10A that configures a shaping apparatus according to the second embodiment. In the shaping apparatus according to the present second embodiment, instead of shaping apparatus main section 10 described earlier, shaping apparatus main section 10A is disposed in a vacuum chamber similar to housing 100A.

Shaping apparatus main section 10A is different from shaping apparatus main section 10 according to the first embodiment described earlier in that a plurality, e.g. two (a pair), of table devices are provided at rotation table 22 described earlier and that a movement system 14A to move each of the two table devices along a predetermined circulation path is provided instead of movement system 14, but the configurations of the other parts are similar to those of shaping apparatus main section 10. Shaping apparatus main section 10A will be described below focusing on the differences from shaping apparatus main section 10. Hereinafter, each of the two table devices will be denoted as a table device 12A and a table device 12B for identification, as shown in FIG. 20.

As shown in FIGS. 20 and 21, table devices 12A and 12B are each configured similarly to table device 12 described earlier, and are mounted at different positions on rotation table 22 that is an example of a first member (and a movable member) rotatable around the first axis AR1 parallel to the Z-axis perpendicular to the horizontal plane.

A shaping plate MP1 as a first support surface member is mounted on table 26 of table device 12A, and a shaping plate MP₂ as a second support surface member is mounted on table 26 of table device 12B. In the present second embodiment, the upper surface of shaping plate MP1 serves as a first support surface on which a shaping object (first shaping object) is formed, and the upper surface of shaping plate MP₂ serves as a second support surface on which a shaping object (second shaping object) is formed.

Rotation table 22 is integrally attached to the upper end of drive shaft 28a of motor 28 to be coaxial with drive shaft 28a, similarly to the first embodiment described earlier (see FIG. 1). Drive gear 21 is coaxially attached to drive shaft 28a (see FIG. 1). Rotation table 22 is driven, by motor 28 via drive shaft 28, to rotate, for example, clockwise in planar view (see arrow CW in FIG. 21) with center axis AR1 (see FIGS. 21 and 1) of drive shaft 28a serving as the center.

Table device 12A is provided with driven gear 29 at the lower end, and the upper end of shaft member 27 described earlier supported by rotation table 22 via the bearing section (not illustrated) is connected to the lower surface of table device 12A. Therefore, as shown in a plan view of FIG. 21, table device 12A is configured to rotate in a counterclockwise direction in planar view indicated by an arrow CCW1 with center axis AR2 of shaft member 27 serving as the center, with a rotational speed ratio of 1:1, in conjunction with the rotation of rotation table 22 in the clockwise direction in planar view indicated by arrow CW with rotation axis AR1 serving as the center. Note that, for the sake of convenience in the illustration and the description, only frame-shaped sections 24c of table bases 24 is shown in FIG. 21 as table devices 12A and 12B.

Table device 12B has a driven gear 29A, having the same shape as driven gear 29, at the lower end, and the upper end of another shaft member, having the same shape as shaft member 27, supported by rotation table 22 via a bearing section is connected to the bottom surface of table device 12B. Such another shaft member has a center axis AR3 shown in FIG. 21. Driven gear 29A has a circular plate shape with the same diameter as that of drive gear 21, and at its outer periphery, has a tooth section with the same shape and the same size as the tooth section of drive gear 21 to be engaged with the tooth section of drive gear 21. Therefore, as shown in FIG. 21, table device 12B is configured to rotate in a counterclockwise direction in planar view indicated by an arrow CCW2 with center axis AR3 serving as the center, with a rotational speed ratio of 1:1, in conjunction with the rotation of rotation table 22 in the clockwise direction in planar view indicated by arrow CW.

Namely, in the present second embodiment, in conjunction with the rotation of rotation table 22 in the clockwise direction indicated by arrow CW, table device 12A and table device 12B simultaneously rotate in the counterclockwise direction at the same rotational speed as that of rotation table 22. As a result, similarly to table device 12 described earlier, each of table devices 12A and 12B is moved along a circular circulation path, and regardless of the moving positions, is constantly directed toward the same direction within the XY-plane, i.e. the direction shown in FIGS. 20 and 21. Further, when rotation table 22 rotates at a constant rotational speed, each of table devices 12A and 12B is moved at a constant speed along the circular circulation path described above.

As shown in FIG. 21, table device 12B is disposed at such a position that a reference point (axis AR3 serving as a rotation center) of table device 12B is symmetric (point symmetric and laterally symmetric) to a reference point (axis AR2 serving as a rotation center) of table device 12A, with respect to the rotation center (axis AR1) of rotation table 22 serving as a datum, on a straight line in the X-axis direction which is an extension line of reference line LH.

By the constant speed rotation of rotation table 22 at target rotational speed Vt, table devices 12A and 12B are each moved at a constant speed, similarly to table device 12 as described earlier, and moved along the circular circulation path while their orientations are maintained at the orientations shown in FIGS. 20 and 21. And, during the movement, a series of processing for constructions a shaping object is performed on the tables of table devices 12A and 12B, in the similar procedures to the foregoing. The movement at a constant speed along the circulation path while maintaining the orientations of table devices 12A and 12B within the XY-plane is continued until the irradiation of the electron beams to a last layer of powder bed on table section 32 is completed after the point in time when rotation table 22 reaches target rotational speed Vt. Consequently, table devices 12A and 12B sequentially face the parts disposed on the circulation path such as beam irradiation section 16.

As is clear from the description made so far, in the present second embodiment, table device 12A (not including shaping plate MPi) configures a first support member that supports shaping plate MP1 as the first support surface member, and table device 12B (not including shaping plate MP2) configures a second support member that supports shaping plate MP2 as the second support surface member.

In the present second embodiment, a first movement device that moves each of the two table devices 12A and 12B along the circular circulation path similar to that of the first embodiment described earlier is configured including motor 28, and rotation table 22 which is fixed to drive shaft 28a of motor 28 and on which the two table devices 12A and 12B are mounted. Rotation table 22 (movable member) is moved by the first movement device, and thereby table device 12A (including the first support member described above) and table device 12B (including the second support member described above) are moved with respect to beam irradiation section 16 as a beam irradiation device.

In the present second embodiment, a second movement device that moves the two table devices 12A and 12 is configured including drive gear 21, driven gears 29 and 29A, and the two shaft members respectively connected to (table bases 24 of) table devices 12A and 12B supported rotatably by rotation table 22, and the like. The two table devices 12A and 12B are moved by the second movement device, in conjunction with change in position within the horizontal plane of the two table devices 12A and 12B that are moved by the first drive device, so that the orientation of each of the two table devices 12A and 13B is maintained.

As is clear from the above description, movement system 14A includes the first movement device and the second movement device.

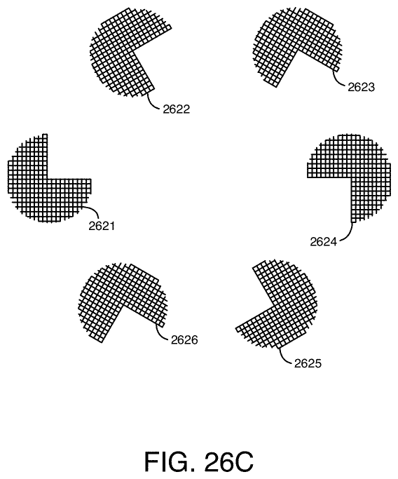

In shaping apparatus main section 10A according to the present second embodiment, position measurement system 42 (see FIG. 22) is provided that detects the rotation angle around axis AR1 of rotation table 22 from a reference position. Measurement information of position measurement system 42 is supplied to controller 20. On the basis of information on the rotation angle from position measurement system 42, controller 20 is capable of obtaining the positions within the horizontal plane (e.g. the coordinate positions on the XY coordinate system with axis AR1 serving as its origin) of the reference point of table device 12A, i.e. axis AR2 serving as the rotation center of table device 12A, and the reference point of table device 12B, i.e. axis AR3 serving as the rotation center of table devices 12B. Consequently, position measurement system 42 functions as a position measurement system that measures the position information within the horizontal plane of the respective reference points of table devices 12A and 12B.

FIG. 22 shows in a block diagram the input/output relationship of controller 20 that centrally configures a control system of the shaping apparatus according to the second embodiment. In FIG. 22, two drive mechanisms 31 denote drive mechanisms for individually moving vertically tables 26 that table devices 12A and 12B respectively have. Controller 20 includes a microcomputer and the like, and performs overall control of the constituent parts of the shaping apparatus including each of the parts shown in FIG. 22. Controller 20 controls movement system 14A and beam irradiation section 16 (beam irradiation units 30₁ to 30₃) on the basis of 3D data of shaping objects so that the electron beams are selectively irradiated on only a necessary part of the shaping material spread over the work area on table 26 of each of table devices 12A and 12B , with the shaping material spread over serving as a target.

Also in the shaping apparatus according to the present second embodiment, the load lock chamber similar to that of the first embodiment is provided adjacently on the −Y side of the vacuum chamber, and at the stage where the shaping processing for constructing shaping objects is completed on both of the two table devices 12A and 12B, the processing similar to that of the first embodiment described earlier is performed in the load lock chamber. Note that in the present second embodiment, two carrier robots may be provided in the load lock chamber or only one carrier robot may be provided.

As is described so far, since the shaping apparatus according to the present second embodiment is equipped with all the constituents of shaping apparatus 100 of the first embodiment described earlier, the similar effect can be obtained to that of the first embodiment described earlier. In addition, in the shaping apparatus according to the present second embodiment, the arrangement of beam irradiation units 30₁ to 30₃ of beam irradiation section 16, powder feeder 46, powder hopper 41 and preheating unit 50 with respect to the rotation center (axis AR1) of rotation table 22 is set into a positional relationship as shown in FIG. 21, and the arrangement in which table device 12A and table device 12B are laterally symmetric with respect to a straight line in the Y-axis direction passing through the rotation center of rotation table 22 is employed, and therefore the irradiation process of the electron beams to powder bed (layers of the shaping material) on table (referred to as one table) 26 that one table device 12A (or 12B) has is performed in parallel with the formation process of powder bed on table (referred to as the other table) 26 that the other table device 12B (or 12A) has and the preheating process to the formed powder bed on the other table.

Here, it is preferable that the formation process of powder bed on the other table is performed at least partly simultaneously with the irradiation process of the electron beams on the one table. However, the preheating process on the other table and the irradiation process of the electron beams on the one table do not have to be performed simultaneously. The preheating process on the other table should be performed during a period after the powder bed formation on the other table has been completed and before the irradiation of the electron beams to the formed powder bed. For example, in an embodiment with three table devices, powder spreading, preheating, and irradiation will not occur simultaneously.

In shaping apparatus main section 10A according to the present second embodiment, while rotation table 22 rotates once, the acquisition of calibration information for the beam irradiation positions of beam irradiation units 30ᵢ using fiducial marks FM, (i=1 to 3), the irradiation of the electron beams to an n^{th} layer (n is a natural number) of powder bed, the formation of an (n+1)^{th} layer of powder bed and the preheating are sequentially performed on the one table device (e.g. table device 12A) side, and in parallel therewith, the formation of the n^{th} layer of powder bed, the preheating, the acquisition of calibration information for the beam irradiation positions of beam irradiation units 30, using fiducial marks FMᵢ (i=1 to 3) and the irradiation of the electron beams to the n^{th} layer of powder bed are sequentially performed on the other table device (table device 12B in this case) side. That is, while table device 12A makes one round along the circular circulation path, a series of processing required for shaping is performed once on table device 12A side, and in parallel therewith, the other table device 12B makes one round along the circulation path and a series of processing required for shaping is performed once on table device 12B side. Accordingly, the substantially double processing capability can be exerted, compared to that of the first embodiment described earlier. Moreover, with a configuration similar to that of shaping apparatus main section 10 according to the first embodiment described earlier without providing two of each constituent of the shaping apparatus main section, the double throughput can be realized only by adding one table device. Depending on the requirements of a particular application, shaping on the two table devices 12A and 12B may not start and finish at the same time. For example, the first layer may be deposited and shaped on the other table when shaping of the powder bed on the one table is at the n^{th} layer. In another example, deposition and shaping of both powder beds begins during the same revolution of rotation table 22 but one shaped object is finished before the other.

Namely, in the present second embodiment, while rotation table 22 rotates once, the relative positional relationship between beam irradiation section 16 and the first support surface and the relative positional relationship between beam irradiation section 16 and the second support surface are changed by movement system 14A. Specifically, as rotation table 22 rotates, table device 12A and table device 12B are moved within a plane parallel to the XY-plane, similarly to table device 12 described earlier. Consequently, the positional relationship between beam irradiation section 16 whose position is fixed and each of shaping plates MP₁ and MP₂ is changed within the XY-plane intersecting with the irradiation direction of electron beams EB. In this case, the positional relationship between beam irradiation section 16 and each of shaping plates MP₁ and MP₂ is changed at least in the Y-axis direction, and the first emitting port, the second emitting port and the third emitting port of beam irradiation section 16 are disposed along the X-axis direction intersecting with the Y-axis direction.

In shaping apparatus main section 10A, tables 26 equipped in table devices 12A and 12B, respectively, are vertically moved independently from each other, and as a consequence, the first support surface and the second support surface are moved along the irradiation direction of electron beams EB independently from each other.

Powder coating system 18 supplies shaping material BM onto the first support surface of shaping plate MP₁ and onto the second support surface of shaping plate MP₂. Powder hopper 41 supplies the shaping material from a supply port capable of facing the first support surface or the second support surface. Powder coating system 18 is equipped with powder feeder 46, and in the present embodiment, shaping material BM supplied from the supply port of powder hopper 41 is leveled, by powder feeder 46, to the height of the upper surfaces of the frame-shaped sections of table devices 12A and 12B, and powder bed (layers of the shaping material) is formed on the first support surface and the second support surface.

In the shaping apparatus according to the present second embodiment, in a period (first period) in which the irradiation of the electron beams to the n^{th} (n is a natural number) layer of powder bed on the first support surface, the irradiation area of the energy beams is formed on the shaping material on the first support surface, and in a second period different from the first period, the irradiation of the electron beams to the n^{th} layer of powder bed on the second support surface is performed (the irradiation area of the energy beams is formed on the shaping material on the second support surface). Powder coating system 18 supplies the shaping material to the first support surface in a third period, and supplies the shaping material to the second support surface in a fourth period different from the third period. Here, the first period and the fourth period at least partly overlap and the second period and the third period at least partly overlap. Accordingly, the throughput in the shaping apparatus as a whole is improved.

Further, in the shaping apparatus according to the present second embodiment, the gravity center position within the XY-plane of an area containing table devices 12A and 12B coincides with rotation axis AR1. Therefore, the tilt of rotation axis AR1 of movement system 14 can be suppressed.

Note that, in the second embodiment described above, although the case has been exemplified where the two table devices 12A and 12B are each moved along the circular circulation path, this is not intended to be limiting, and a plurality of table devices may be moved along a circulation path with a shape other than a circular shape, such as for example, a circulation path with an ellipse shape, or a circulation path with an oval shape (koban shape) partly including a straight line path. In short, a plurality of table devices should be moved along the same circulation path, and during the movement along the circulation path of each of the table devices, the foregoing series of processing for constructing shaping objects should be performed. For example, in the case of employing the circulation path with an oval shape, a movement system that moves table devices 12A and 12B along the circulation path can be configured using, for example, a belt drive mechanism or the like.

Further, a configuration may be employed in which during the movement of a plurality of table devices along the same circulation path, the irradiation process of the electron beams to powder bed on a table of one table device and the formation process of powder bed on a table of the other table device are performed at least partly in parallel.

Additionally, in order to perform the processing of the same process using different table devices at different positions on the same circulation path, e.g. a circular circulation path, at least two sets of powder coating system 18 (the powder hopper, and the powder feeder) and the preheating unit may be disposed on the circulation path. Alternatively, a configuration may be employed in which a series of processing for constructing shaping objects can be performed on different tables concurrently. For example, a plurality of powder coating systems 18, the preheating units, the electron beam irradiation sections, and the like may be provided and they may be disposed at different positions on the same circulation path. For example, in the case of employing a drive system having a rotation table similar to the first movement system, as a part of a movement system that moves a plurality of table devices along a circular circulation path similarly to the second embodiment described above, a space where a plurality of the powder hoppers, the preheating units, the electron beam irradiation sections and the like are disposed can be secured within the circular circulation path along which the table devices are moved, if the radius of the rotation table is increased to some extent. For example, the number of sets, which is equal to the number of the table devices, of the powder hopper, the preheating unit, the electron beam irradiation section and the like may be disposed within the same circulation path.

Note that in the first embodiment and the second embodiment described above, the three fiducial marks MFᵢ and the three beam monitors 42ᵢ are provided individually corresponding to beam irradiation units 30₁, 30₂ and 30ₐ, but at least one of the fiducial marks and the beam monitors may be provided in a singular number.

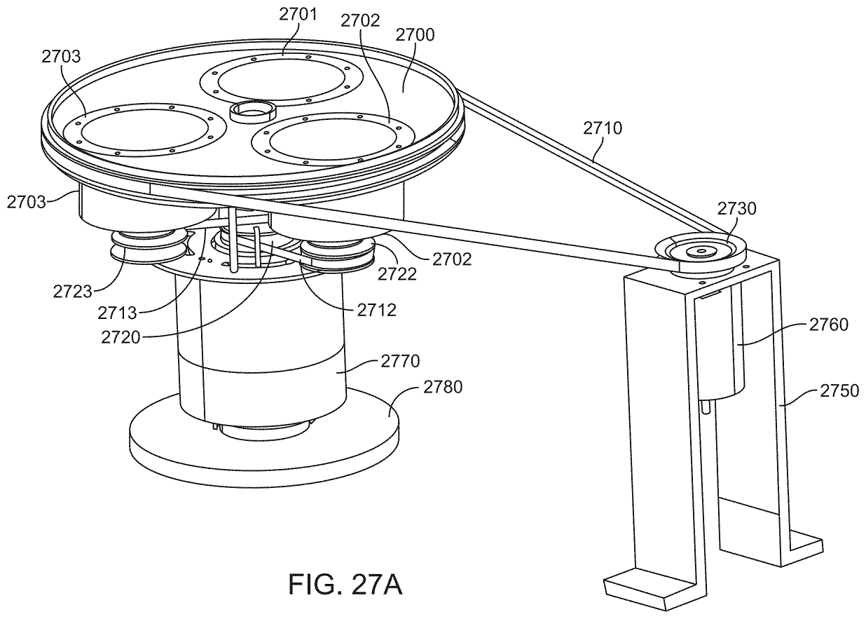

In the first embodiment and the second embodiment described above, the case has been described where the powder coating system in which powder hopper 41 is disposed above the movement route of table device 12 and which supplies the shaping material onto table section 32 from above, specifically, onto support surface SS of shaping plate MP supported by table 26 is employed as a material supply device. However, this is not intended to be limiting, and a system configured to supply the shaping material onto support surface SS from below may be employed as the material supply device. For example, a system equipped with a supply section with a tank shape in which powdered material to be used for shaping is housed, a shaping section with a similar tank shape configuring an shaping area adjacent to the supply section, and a transfer member (corresponding to the rake member), that is disclosed in U.S. Patent Application Publication No. 2013/0168902, may be employed as the material supply device. This system (referred to as a shaping material coating system for the sake of convenience) is shown in FIGS. 23(A) to 23(C). In this shaping material coating system, a bottom wall 82 of a supply section 80 and a bottom wall 92 (corresponding to table 26 in the first embodiment) of a shaping section 90 are freely elevatable, and by moving upward bottom wall 82 of supply section 82, powdered material BM is pushed up as shown in FIG. 23(A) and exposed a predetermined amount from the upper surface of supply section 80. At this time, bottom wall 82 of shaping section 82 is set at such a position that the upper surface (corresponding to support surface SS) of a plate-shaped shaping mount 94 (corresponding to shaping plate MP described earlier) disposed thereon, or the upper surface of the uppermost layer of powdered material BM formed on shaping mount 94 is a predetermined distance lower than the uppermost surface of shaping section 90. Then, as shown in FIG. 23(A), transfer blade 99 is moved from the outside of supply section 80 to sequentially pass above supply section 80 and above shaping section 90 and thereby, as shown in FIG. 23(B), the exposed powdered material BM is supplied to shaping section 90, and leveled to the height of the upper end surface of shaping section 90 by transfer blade 99 and a layer of shaping material BM (powder bed) is formed (see FIG. 23(C)). Note that, in the shaping material coating system, as shown in FIG. 23(C), in parallel with the formation of powder bed, powdered material BM inside supply section 80 can be exposed a predetermined amount from the upper surface of supply section 80 by moving bottom wall 82 upward, in preparation for formation of a next layer of powder bed.

For example, in the case of employing the shaping material coating system described above, as the material supply device, in a shaping apparatus equipped with a table device that moves along a circulation path, the shaping material is supplied from the supply port capable of facing a beam irradiation device (beam irradiation section 16). For example, in the case where table device 12 of the first embodiment described above is provided as a shaping section, a tank-shaped supply section in which the powdered material for shaping (shaping material) is housed will be disposed adjacently to table device 12, and will be moved along the circulation path together with table device 12. In this case, the upper opening of the tank-shaped supply section corresponds to the supply port of the shaping material, and this supply port could face the beam irradiation device (beam irradiation section 16) during movement of the tank-shaped supply section along a movement route.

Note that although the position of powder hopper 41 of powder coating system 18 is fixed in the first embodiment and the second embodiment described above, powder hopper 41 may be, for example, configured movable within the XY-plane that faces support surface SS, the first support surface and the second support surface, or a configuration in which a member provided with a supply port is movable may be employed. Likewise, although the position of beam irradiation section 16 is also fixed, beam irradiation section 16 may be, for example, configured movable within the XY-plane that faces support surface SS, the first support surface and the second support surface.

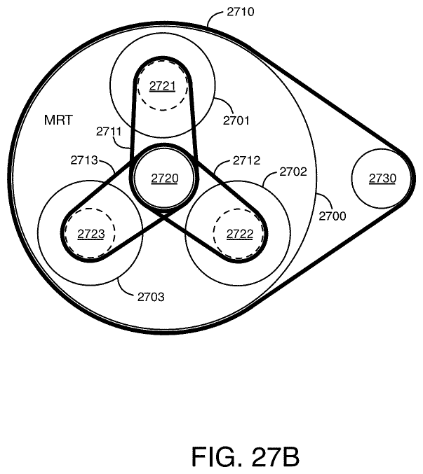

In the second embodiment described above, it can be considered that a system equipped with a plurality of supply sections 80 and a plurality of shaping sections 90 described earlier, instead of table devices 12A and 12B and powder hopper 41, is used. As the system in such a case, as shown in FIG. 24 for example, a configuration may be employed, which has a cylindrical outer appearance with the upper surface opened and the inside space of which is partitioned into four so that two each of supply sections 80 and shaping sections 90 are disposed symmetrically on the circumference. It can be considered that this system is mounted on rotation table 22 in a state where the center axis of the cylindrical section coincides with center axis AR1 described earlier and is used together with powder feeder 46. In this case, the preheating unit is disposed at a position not obstructing the formation of powder head. Further, only one beam irradiation section 16 may be provided, or two beam irradiation sections 16 may be provided and the irradiation of electron beams EB may be performed in shaping sections 90 at two places simultaneously using the two beam irradiation sections 16.

In the first embodiment and the second embodiment described above, although the case has been described where the first movement device configuring the movement system has a movable member (rotation table 22) and the second movement device moves table section 32 (including the support member) in conjunction with the movement of the movable member, this is not intended to be limiting, and the first movement device and the second movement device share the same movable member, as in a third embodiment to be described next. That is, the second movement device may be a device that indirectly moves the support member.

### Third Embodiment

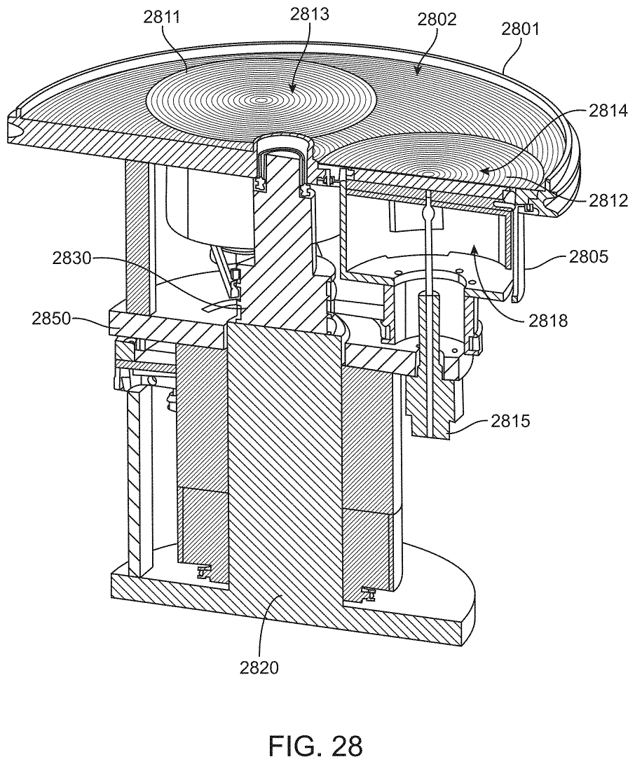

FIG. 25 schematically shows the configuration of a shaping apparatus 200 according to the third embodiment with a part thereof cross-sectioned. Shaping apparatus 200 is equipped with the vacuum chamber (housing) 100A installed on floor surface F and a shaping apparatus main section 10B disposed in vacuum chamber 100A.

Shaping apparatus main section 10B is different from shaping apparatus main section 10 according to the first embodiment described earlier in that a table device 112 is provided instead of table device 12 described earlier and a movement system 114 is provided instead of movement system 14, and powder coating system 18 and the like are disposed on the +Y side (on the depth side of the paper surface in FIG. 25) of beam irradiation section 16. Shaping apparatus 200 will be described below focusing on the differences from shaping apparatus 100 according to the first embodiment.

Table device 112 has: a frame member 124 with a bottomed cylindrical shape; a table 126 that is vertically movable along an inner wall surface of frame member 124; and a drive mechanism 125 that is capable of driving table 126 in a vertical direction. As frame member 124, a bottomed cylindrical member with a roughly square shape in planar view is used as an example, but this is not intended to be limiting, and the shape in planar view may be a circular shape, a polygonal shape or the like as far as the frame member has a bottomed cylindrical shape with the upper surface opened. Frame member 124 is provided with fiducial marks Fn and beam monitors 44ᵢ (i=1 to 3) on the upper surface of a side wall on the −Y side (on the front side of the paper surface in FIG. 25), similarly to frame-shaped section 24c described earlier.

Table 126 is made up of a plate member with a predetermined thickness. On the upper surface of table 126, shaping plate MP is loaded in a state where the upper surface of shaping plate MP is parallel to the horizontal plane. Shaping plate MP is freely detachable from and attachable to the upper surface of table 126, and in the present third embodiment, the upper surface of shaping plate MP serves as support surface SS onto which the shaping material is supplied. Drive mechanism 125 has: a Z-shaft 125a whose lower end is fixed to the center of the inner bottom surface of frame member 124 and which extends in a vertical direction (Z-axis direction); and a Z-drive section 125b that is vertically movable along Z-shaft 125a. A part of Z-drive section 125b is integrally attached to table 126. Therefore, Z-drive section 125b is vertically moved along Z-shaft 125a, thereby moving table 126 vertically along the inner peripheral surface of frame member 124. Table 126 is vertically movable between a first position shown in FIG. 23 and a second position that is lower than the first position by a predetermined distance (a distance slightly shorter than the total thickness of table 126 and Z-drive section 125b in the Z-axis direction).

Note that drive mechanism 125 may be configured capable of driving table 126 in the θx direction (a rotation direction around the X-axis) and the θy direction (a rotation direction around the Y-axis) in addition to the Z-axis direction, via Z-drive section 125b.

Movement system 114 is equipped with: frame member 124 also serving as a movable member; a fine movement stage 130 on the upper surface of which frame member 124 is mounted; a coarse movement stage 132 that supports fine movement stage 130 on base BS; a fine movement actuator 134 that finely drives fine movement stage 130 on coarse movement stage 132 in the X-axis direction, the Y-axis direction and the Oz direction; and a coarse movement actuator 136 that drives coarse movement stage 132 on base BS in XY-two-dimensional directions. Base BS is disposed on the bottom wall of vacuum chamber 100A in a state where the upper surface of base BS is parallel to the XY-plane. Fine movement actuator 134 is capable of performing the positioning of a drive target with higher accuracy, compared to coarse movement actuator 136. The output of coarse movement actuator 136 is larger, compared to that of fine movement actuator 134. For example, a voice coil motor or the like is employed as fine movement actuator 134, and for example, a linear motor or the like having relatively large output is employed as coarse movement actuator 136. In the case of employing electric motors as coarse movement actuator 136 and fine movement actuator 134, it is desirable that the magnetic shield for preventing leakage of magnetic force from the motors to the outside as much as possible is applied to the motors.

In shaping apparatus main section 10B, powder hopper (shaping material supply unit) 41, powder feeder 46 (rake member) and preheating unit 50 are disposed on the +Y side (the depth side of the paper surface in FIG. 25) of beam irradiation section 16. Powder hopper 41 and powder feeder 46 each configure a part of powder coating system 18.

Powder hopper 41 is disposed above on the +Y side of powder feeder 46. Preheating unit 50 is disposed adjacently (with a predetermined spacing) on the −Y side (the front side of the paper surface in FIG. 25) of powder feeder 46.

As shown in FIG. 25, preheating unit 50 and powder feeder 46 are disposed at such a height position that the respective lower end surfaces substantially coincide with the upper end surface of frame member 124 (a predetermined clearance (interspace, gap) is set above the upper end surface of frame member 124, in a state where table device 112 is moved to directly under preheating unit 50 and powder feeder 46). In FIG. 25, powder feeder 46 is hidden behind preheating unit 50 on the depth side of the paper surface.

The configurations of the other parts of shaping apparatus main section 10B are similar to those of shaping apparatus main section 10 described earlier.

In shaping apparatus 200 according to the present third embodiment, the shaping work is performed basically in the procedures similar to those in shaping apparatus 100 except for the movement operation of table device 112 at the time of forming and preheating powder bed, and at the time of irradiating electron beams EB to powder bed.

On the formation of powder bed, table device 112 located at a predetermined position (standby position for material supply start) on the +Y side with respect to the disposed position of powder hopper 41 is driven by coarse movement actuator 136 to be moved below powder hopper 41 linearly along the Y-axis direction from the standby position for material supply start toward the −Y side. During this movement of table device 112, the shaping material is supplied from powder hopper 41 onto shaping plate MP, and the face thereof is leveled by powder feeder 46. Accordingly, the n^{th} layer of powder bed is formed on the upper surface (support surface) SS of shaping plate MP, and as table device 112 is further moved toward the −Y direction, the preheating of the formed powder bed is performed.

After the preheating of the powder bed, when table device 112 is moved further toward the −Y direction, fiducial marks Fn on frame member 124 are irradiated with electron beams EB from beam irradiation units 30′, and the acquisition of information for calibrating the beam irradiation positions of beam irradiation units 30ᵢ is performed via back-scattered electron detection unit 54 and signal processor 56, and then the irradiation of electron beams EB to the n^{th} layer of powder bed is performed. This irradiation of electron beams EB is performed on the basis of 3D data of a shaping object as a shaping target, and on this operation, position control of fine movement stage 130 within the XY-plane is performed as needed, in addition to deflection control of the electron beams so that the beam irradiation positions are adjusted on the basis of the acquired information for calibrating the beam irradiation positions. Here, the movement direction (fine movement direction) of fine movement stage 130 may be the same direction (−Y direction) as the movement direction of coarse movement stage 132 at the time of irradiation of electron beams EB described above, or may be an opposite direction (reverse direction, +Y direction), or may be an intersecting direction (+X direction or −X direction).

In shaping apparatus 200, when a series of operations from the formation of an n^{th} layer of powder bed to the irradiation of electron beams EB to the n^{th} layer of powder bed is performed, table device 112 is linearly moved from the +Y direction toward the −Y direction and the irradiation of electron beams EB to the n^{th} layer of powder bed is completed, as is described above, and then table device 112 is driven by coarse movement actuator 136 to be moved from that position (irradiation completed position) along the Y-axis direction toward the +Y side and returns to the standby position for material supply start. During this movement toward the +Y side of table device 112, table 126 is driven a predetermined distance downward by drive mechanisms 125. Optionally during this movement, additional heat can be supplied to the powder bed by the preheating unit 50. Therefore, a series of operations from the formation of a next layer ((n+1) layer) of powder bed to the irradiation of electron beams EB to the (n+1) layer of powder bed can be performed immediately after table device 112 arrives at the standby position for material supply start.

With shaping apparatus 200 according to the present third embodiment described so far, only by driving coarse movement stage 132 linearly toward the −Y direction, the formation of powder bed and the preheating of the formed powder bed as well as the irradiation of electron beams EB to the powder bed can be sequentially performed using table device 112 mounted on coarse movement stage 132 via fine movement stage 130.

Note that, in the third embodiment described above, although the case has been exemplified where the movement direction of table 126 by coarse movement stage 132 via frame member 124 is a linear direction, this is not intended to be limiting, and the movement direction may be along a curved path, e.g., along an arc-shaped path.

In the third embodiment described above, the case has been described where table device 112 is equipped with frame member 124 made up of a bottomed cylindrical member with a square shape in planar view, but instead of frame member 124, a member with a U-like shape in planar view, like frame member 124 without the side wall on the −Y side, may be employed. Fiducial marks Fn described earlier may be disposed on the upper end surface of the side wall part on the +Y side of this member. In this case, however, fiducial marks Fn arrive at a position below beam irradiation units 30, after the irradiation of the electron beams to the n^{th} layer of powder bed, and therefore, the beam irradiation positions should be adjusted on the basis of detection results of the fiducial marks (the detection results of the beam irradiation positions), prior to irradiating a next layer of powder bed with the electron beams.

Note that two sets of powder coating system 18 and preheating unit 50 may be provided in the third embodiment described above. In this case, it is preferable that one each set is disposed on one side and the other side in the Y-axis direction with the irradiation area of electron beams EB from beam irradiation section 16 in between. In one set disposed on the +Y side of the irradiation area of electron beam EB, powder coating system 18 and preheating unit 50 are disposed in an arrangement (positional relationship) similar to that of the third embodiment described above, and in the other set disposed on the −Y side of the irradiation area of electron beams EB, powder coating system 18 and preheating unit 50 are disposed in a symmetric arrangement with respect to the one set.

By employing the two sets described above, when a series of operations from the formation of an n^{th} layer of powder bed to the irradiation of electron beams EB to the n^{th} layer of powder bed is performed, table device 112 is moved linearly from the +Y direction toward the −Y direction and the irradiation of electron beams EB to the n^{th} layer of powder bed is completed, as is described above, and then after table 126 is immediately moved a predetermined distance downward at that position (irradiation completed position), table device 112 is moved along the Y-axis direction from the −Y side toward the +Y side in a similar manner to the foregoing, which allows, during this movement, a series of operations from the formation of an (n+layer of powder bed to the irradiation of electron beams EB to the (n+1)^{th} layer of powder bed to be performed. That is, the processing of the two layers can be continuously performed by the reciprocating operations of table device 112, and in addition the reciprocating operations of table device 112 can be performed continuously, and thus remarkable improvement in throughput can be expected.

Note that in the first embodiment to the third embodiment (hereinafter, referred to as each of the embodiments) described above, the three beam irradiation units 30₁ to 30₃ of beam irradiation section 16 are disposed along a direction intersecting with the movement direction of shaping plate MP serving as the support surface member, i.e. a direction in which the positional relationship (relative position) between beam irradiation units 30₁ to 30₃ and shaping plate MP is changed. However, this is not intended to be limiting, and a plurality of beam irradiation units may be two-dimensionally disposed along a direction intersecting with a direction in which the positional relationship (relative position) between the beam irradiation units and the shaping plate is changed and a direction along the direction in which the positional relationship is changed. Especially, in the cases such as where the swing width of the beam of one beam irradiation unit 30 covers the entire area of the work area, a plurality of beam irradiation units may be disposed along the direction (e.g., the Y direction) in which the positional relationship (relative position) between the beam irradiation units and the shaping plate is changed.

In each of the embodiments described above, a vibration isolation device for decreasing vibration transmitted from floor surface F to shaping apparatus 100 may be provided between the shaping apparatus and floor surface F. Further, an inclination adjusting mechanism for causing rotation axis AR1 (and/or rotation axis AR2) of table device 12 to coincide with the gravity direction may be provided between shaping apparatus 100 and floor surface F. Such vibration isolation device and inclination adjusting mechanism may be provided at the leg section of mount 33.

Note that, although in each of the embodiments described above preheating unit 50 is adjacently disposed on the downstream side of the rake member, the preheating unit, or an additional preheating unit, may be disposed on the upstream side of the rake member. In such a case, preheating unit 50 may be disposed between the material supply position by powder feeder 46 and the rake member. In other embodiments, a plurality of preheating units 50 may be disposed along the motion path of the device table 12.

In the first embodiment and the second embodiment described above, the shaping material is supplied from powder hopper 41 disposed above the movement route of table device 12 onto table section 32 (onto support surface SS of shaping plate MP supported by table 26), but in this case, there is a risk that influence caused by the weight of the supplied shaping material is generated with the progress of shaping. Note that in the first embodiment and the second embodiment described above, table device 12 that is driven to rotate is configured to rotate at a constant speed with axis AR1 as the center, such influence can be already reduced, compared to the case of accelerating and decelerating table device 12. However, by employing another method such as a method of monitoring the rotational speed of the rotation table and using the monitoring result to the control of motor 28, or a method of performing torque control of motor 28 in accordance with the number of layers of the shaping material, or a method of performing torque control of motor 28 in accordance with the supply amount of the shaping material, the influence may be further reduced. Further, a possibility that the Z-direction positions of table device 12 and movement system 14 are displaced because of the weight of the shaping material supplied onto table section 32 can be considered, and therefore the Z-direction positions of fiducial marks FM₁, FM₂ and FM₃ may be monitored and irradiation units 30₁ to 30₃ may be controlled on the basis of this monitoring result.

Furthermore, in each of the embodiments described above, there is a risk that the burden placed on drive mechanism 31 for vertically moving table section 32 (table 26) is changed with the progress of shaping. Therefore, a compressed spring or a piston for cancelling the empty-weight may be incorporated below table section 32 (table 26).

In each of the embodiments decried above, the case has been described where the support member includes table base 24, frame member 124 and the like besides the table that directly supports shaping plate MP, but the support member that supports shaping plate MP as the support surface member may include at least a member that directly supports shaping plate MP.

Note that, in each of the embodiments described above, although the case has been described where the electron beams are used as energy beams irradiated to the shaping material, the energy beams are not limited to the electron beams, and other charged particle beams (e.g., ion beams) may be used. Alternatively, the energy beams other than the charged particle beams such as laser beams may be used. In the case of using the laser beams, the preheating does not necessarily have to be performed depending on the shaping material.

In each of the embodiments described above, although the case has been described where metal powder is used as the shaping material, this is not intended to be limiting, and not only the other powder than metal powder but also shaping material other than powdered material may be used as far as the shaping work can be performed by the irradiation of energy beams.

In the first embodiment and the second embodiment described above, although the case has been described where the first axis AR1 and the second axis AR2 are both parallel to the Z-axis, at least one of the first axis AR1 and the second axis AR2 may be inclined with respect to the Z-axis. In this case, a drive mechanism capable of adjusting the inclination angle of support surface SS with respect to the horizontal plane may be employed as drive mechanism 31.

In each of the embodiments described above, a circular shape, a rectangular shape and the like are used at times to explain the shapes of the members, the openings, the hole and like. However, it goes without saying that their shapes are not limited to these shapes.

Note that a plurality of constituent elements of each of the embodiments described above can be combined where necessary. Accordingly, a part of the foregoing plurality of constituent elements need not be used.

Note that in the embodiments described above, table device 12 is moved, by movement system 14, within a horizontal plane along the circular circulation path having the moving radius (AR1-AR2) as its radius, with axis AR1 serving as the center, while the position (attitude) within the horizontal plane of table device 12 is maintained in a constant orientation.

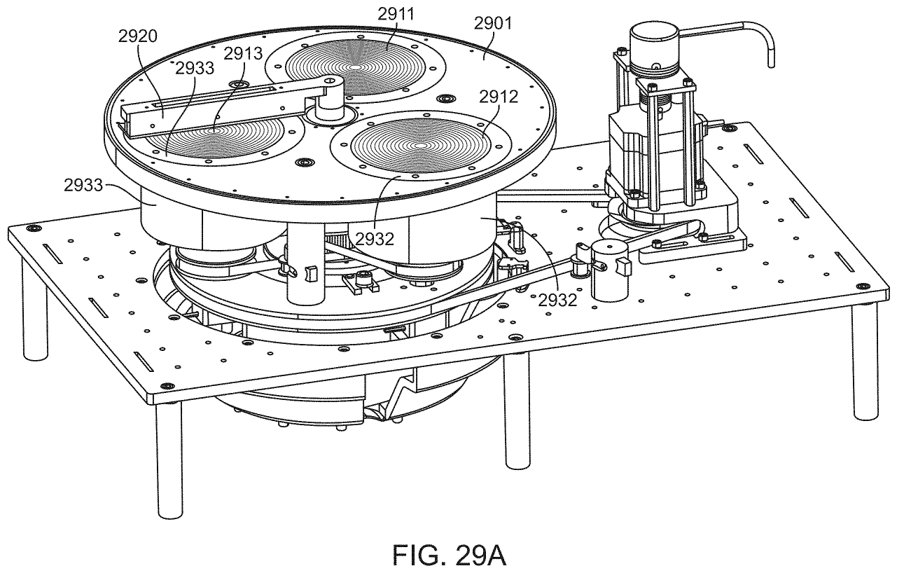

However, as shown in FIG. 26, the position within the horizontal plane of table device 12 needs not be maintained in a constant orientation.

For example, the position (attitude) within the horizontal plane of the table device at the time of shaping an Nt^{h} layer (N is a natural number) and the position (attitude) within the horizontal plane of the table device at the time of shaping an N+M^{th} layer (M is a natural number) may be changed from each other. This allows the directions of shaping lines in a shaping object to be changed for each of the layers.

Note that in the embodiments described above, drive shaft 28a of motor 28 and the rotation axis of rotation table 22 are disposed to be coaxial with each other.

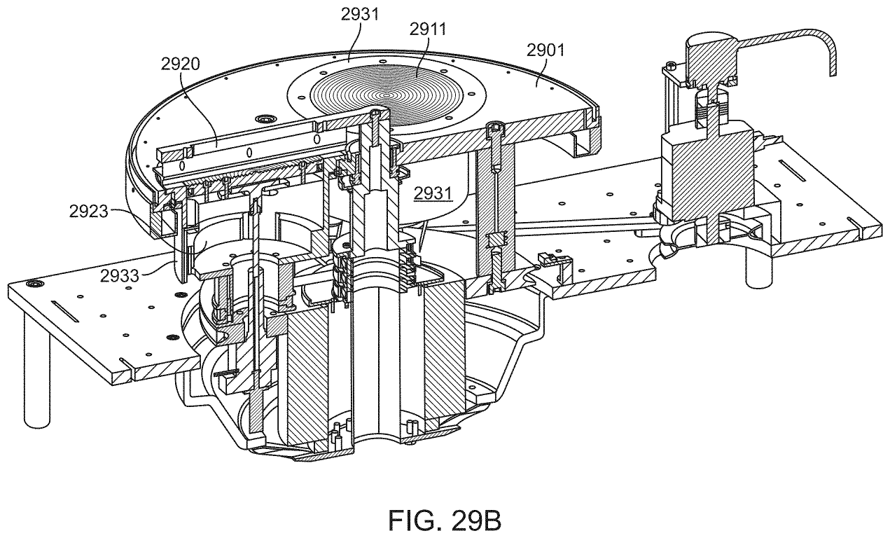

However, as shown in FIGS. 27A and 27B, the drive shaft of the motor may be arranged to have a different axis from the rotation axis of the rotation table. In other words, the motor may be disposed at a position separate from the rotation table. With this arrangement, the influence on the trajectory of the electron beams due to the magnetic field of the motor can be reduced. Note that, in this case, an electromagnetic shield may be provided around the motor (in particular, between the motor and the beam irradiation section).

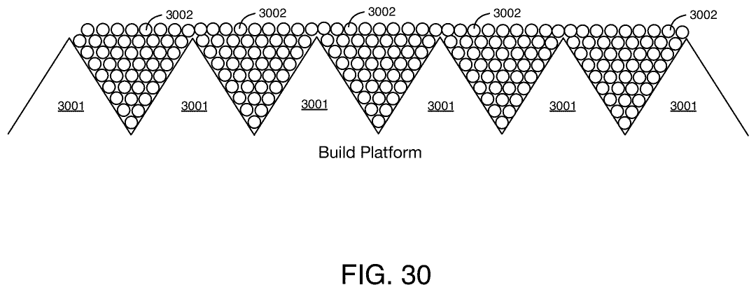

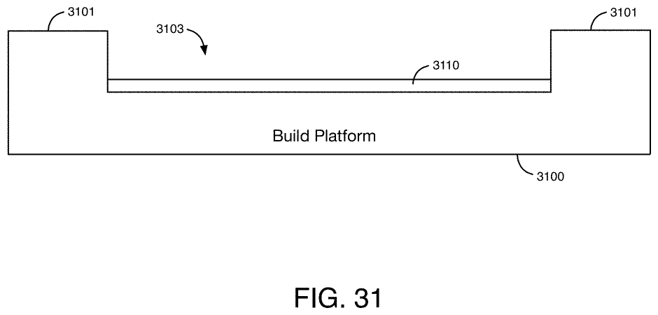

In the embodiments described above, a groove may be formed on the upper surface of shaping plate 26b. In this case, as shown in FIGS. 28 and 29A-29B, the groove may be formed along a direction intersecting with a direction (radial direction) directed outwardly from the rotation center of the table device. Accordingly, powder can be suppressed from being moved by centrifugal force caused by the rotation of the table device by the rotation table. Further, in the case where a cover plate to cover an interspace between a plurality of table devices is provided in a shaping plane (in other words, a plane that coincides with the upper surface of a shaping plate when the shaping plate is located at the uppermost plane), the groove may be formed at the cover plate.

The direction of the groove at the cover plate may be a direction intersecting with a direction (radial direction) directed outwardly from the rotation center of the table devices. Or, the direction of the groove may be a direction intersecting with a direction in which the table devices are moved.

Further, the upper surface (support surface) of the shaping plate or the upper surface of the cover plate may be non-flat, which is not limited to the case where the groove extending in a predetermined direction is formed thereon. Note that the upper surface (support surface) of the shaping plate or the upper surface of the cover plate should be non-flat in the direction in which the table devices are moved.

The following numbered supplementary notes relevant to the embodiments described so far are further disclosed.

### Supplementary Note 1

A shaping apparatus to shape a shaping object on a support surface, the apparatus comprising:

a material supply device that supplies a shaping material onto the support surface;

a beam irradiation device that irradiates the shaping material on the support surface with an energy beam;

a support member that supports a support surface member having the support surface on its one surface;

a first movement device having a movable member, the first movement device moving the support member with respect to the beam irradiation device by moving the movable member; and

a second movement device that moves the support member, wherein movement of the support member by the second movement device includes a component parallel to the support surface.

### Supplementary Note 2

The shaping apparatus according to supplementary note 1, wherein

a direction of movement of the support member by the first movement device includes a component parallel to the support surface.

### Supplementary Note 3

The shaping apparatus according to supplementary note 1 or 2, wherein the first movement device moves the support member in a first rotation direction with a first axis serving as a center.

### Supplementary Note 4

The shaping apparatus according to supplementary note 3, wherein the second movement device moves the support member in a second rotation direction with a second axis serving as a center.

### Supplementary Note 5

The shaping apparatus according to supplementary note 4, wherein the second axis is spaced apart from the first axis.

### Supplementary Note 6

The shaping apparatus according to supplementary note 4 or 5, wherein the support member is moved in the first rotation direction along a path spaced apart from the first axis.

### Supplementary Note 7

The shaping apparatus according to supplementary note 5 or 6, wherein when the support member is moved in the first rotation direction, the second axis rotates around the first axis.

### Supplementary Note 8

The shaping apparatus according to any one of supplementary notes 4 to 7, wherein the second rotation direction and the first rotation direction are directed toward different directions.

### Supplementary Note 9

The shaping apparatus according to supplementary note 8, wherein a rotation angular speed of the support member along the first rotation direction equals to a rotation angular speed of the support member along the second rotation direction.

### Supplementary Note 10

The shaping apparatus according to any one of supplementary notes 3 to 9, wherein when the support member is moved in the first rotation direction, an attitude of the support surface is constant.

### Supplementary Note 11

The shaping apparatus according to any one of supplementary notes 3 to 10, wherein the beam irradiation device irradiates the energy beam on a position spaced apart from the first axis.

### Supplementary Note 12

The shaping apparatus according to any one of supplementary notes 3 to 11, wherein the material supply device supplies the shaping material to a position spaced apart from the first axis.

### Supplementary Note 13

The shaping apparatus according to any one of supplementary notes 1 to 9, wherein the support member is moved by the first movement device, an angular relationship of an axis along the support surface with respect to an axis intersecting with an optical axis of the beam irradiation device is maintained.

### Supplementary Note 14

The shaping apparatus according to supplementary note 13, wherein the beam irradiation device comprises a plurality of beam irradiation optical systems, and

the axis intersecting and an optical axis of each of the plurality of beam irradiation optical systems intersect with each other.

### Supplementary Note 15

The shaping apparatus according to supplementary note 1 or 2, wherein the first movement device moves the support member along a first direction parallel to the support surface.

### Supplementary Note 16

The shaping apparatus according to supplementary note 15, wherein the first direction is a linear direction.

### Supplementary Note 17

The shaping apparatus according to supplementary note 15 or 16, wherein the second movement device moves the support member along a second direction parallel to the support surface.

### Supplementary Note 18

The shaping apparatus according to supplementary note 17, wherein the second direction is a linear direction.

### Supplementary Note 19

The shaping apparatus according to supplementary note 17 or 18, wherein the first direction and the second direction are directed toward a same direction.

### Supplementary Note 20

The shaping apparatus according to supplementary note 17 or 18, wherein the first direction and the second direction are directions opposite to each other.

### Supplementary Note 21

The shaping apparatus according to any one of supplementary notes 1 to 20, wherein the support member comprises a fiducial mark to be irradiated with the energy beam.

### Supplementary Note 22

The shaping apparatus according to supplementary note 21 comprising:

a detector that detects a component of the energy beam via the fiducial mark.

### Supplementary Note 23

The shaping apparatus according to supplementary note 22, comprising: a controller that acquires information on an irradiation position of the energy beam, using a result of detection of the component by the detector.

### Supplementary Note 24

The shaping apparatus according to any one of supplementary notes 1 to 23, comprising:

a controller that controls the beam irradiation device and at least one of the first and the second movement devices, based on information on 3D data of the shaping object.

### Supplementary Note 25

The shaping apparatus according to supplementary note 24, wherein the controller controls the beam irradiation device so that the energy beam is irradiated on at least a part of the shaping material above the support surface, based on the information on 3D data of the shaping object.

### Supplementary Note 26

The shaping apparatus according to any one of supplementary notes 1 to 25, wherein the material supply device supplies a powdered material.

### Supplementary Note 27

The shaping apparatus according to any one of supplementary notes 1 to 26, wherein the beam irradiation device performs irradiation of a charged particle beam.

### Supplementary Note 28

The shaping apparatus according to any one of supplementary notes 1 to 27, wherein the support member comprises a table device that has:

a table which is movable in a vertical direction and on which the shaping material is spread over;

a table support member on which the table is mounted, and which is provided with a frame member to restrict expansion of a shaping material supplied onto the table and height of an uppermost surface of the shaping material; and

a drive section that moves the table on the table support member in a vertical direction.

### Supplementary Note 29

The shaping apparatus according to supplementary note 28, wherein the material supply device comprises a powder coating system to spread the shaping material over a work area on the table defined by the frame member and form a layer of the shaping material in the work area.

### Supplementary Note 30

The shaping apparatus according to supplementary note 28 or 29, further comprising: a controller that, on shaping of the shaping object, controls at least one of the first and the second movement devices, and the beam irradiation device based on 3D data of the shaping object, so that the energy beam is selectively irradiated on only a necessary part of a layer of the shaping material formed on the support surface, with the layer of the shaping material serving as a target.

### Supplementary Note 31

The shaping apparatus according to supplementary note 30, wherein the beam irradiation device has at least one electron beam irradiation unit that has a generating source of electrons and an optical system, the at least one electron beam irradiation unit irradiating a target with electrons emitted from the generating source as an electron beam and being capable of deflecting the electron beam within a predetermined angle range.

### Supplementary Note 32

The shaping apparatus according to supplementary note 31, wherein the first and the second movement devices move the support surface member along a predetermined circulation path within a horizontal plane while maintaining an orientation of the support surface member within the horizontal plane at a constant orientation.

### Supplementary Note 33

The shaping apparatus according to supplementary note 32, wherein the circulation path is a circular circulation path with a first axis perpendicular to the horizontal plane serving as a center.

### Supplementary Note 34

The shaping apparatus according to supplementary note 33, wherein the first and the second movement devices include:

a first drive system that has a first member on which the table device is mounted and which is rotatable around the first axis, the first drive system driving the first member to rotate around the first axis; and

a second drive system that drives the table device to rotate on the first member around a second axis in a reverse direction to the first member with a rotational speed ratio of 1:1, in conjunction with rotation of the first member, the second axis being parallel to the first axis.

### Supplementary Note 35

The shaping apparatus according to supplementary note 34, wherein the first member is a turntable that rotates around the first axis.

### Supplementary Note 36

The shaping apparatus according to any one of supplementary notes 32 to 35 wherein the controller controls the beam irradiation device so that the electron beam is selectively irradiated on the target based on the 3D data, when the first member is rotated at a constant rotational speed by the first drive system.

### Supplementary Note 37

The shaping apparatus according to any one of supplementary notes 32 to 36, wherein the powder coating system has a material supply unit and a rake member, the material supply unit supplying a shaping material onto the table when the table device is located at a predetermined position on the circulation path, the rake member being relatively movable with respect to the frame member along an upper surface of the frame member, and

the beam irradiation section and the rake member are disposed at different positions on the circulation path.

### Supplementary Note 38

The shaping apparatus according to supplementary note 37, further comprising: a preheating unit that preheats the shaping material, wherein

the preheating unit is disposed at a position between the rake member and the beam irradiation section on the circulation path.

### Supplementary Note 39

The shaping apparatus according to supplementary note 38, wherein the preheating unit is adjacently disposed on a downstream side of the rake member on the circulation path.

### Supplementary Note 40

The shaping apparatus according to any one of supplementary notes 32 to 39, wherein the beam irradiation section has a plurality of the electron beam irradiation units disposed along a first direction traversing the circulation path.

### Supplementary Note 41

The shaping apparatus according to supplementary note 40, wherein the target is irradiated with the electron beam while being moved substantially along a second direction perpendicular to the first direction within a horizontal plane that is orthogonal to an optical axis of the optical system, and

each of the plurality of electron beam irradiation units deflects the electron beam so that an irradiation area of the electron beam is reciprocally moved at least in the first direction.

### Supplementary Note 42

The shaping apparatus according to supplementary note 41, wherein each of the plurality of electron beam irradiation units is capable of deflecting the electron beam to be irradiated on the target so that the electron beam overlaps a part of the electron beam emitted from the adjacent electron beam irradiation unit.

### Supplementary Note 43

The shaping apparatus according to any one of supplementary notes 32 to 39, wherein the frame member is provided with a fiducial mark, and

the shaping apparatus further comprises:

a position measurement system capable of measuring position information of the table device at least within a horizontal plane; and

a detector capable of detecting a reflection component generated from the fiducial mark by irradiation of the electron beam to the fiducial mark, wherein

when the table device is moved by the movement system to a position where the electron beam from the beam irradiation section can be irradiated on the fiducial mark, the controller acquires calibration information for an irradiation position of the electron beam based on a detection result of the detector and a measurement result of the position measurement system at the time of the detection, while irradiating the electron beam on the fiducial mark via the beam irradiation section.

### Supplementary Note 44

The shaping apparatus according to supplementary note 43, wherein acquisition of the calibration information is performed prior to irradiation of the electron beam to a layer of the shaping material formed on the table.

### Supplementary Note 45

The shaping apparatus according to supplementary note 44 wherein the acquisition of the calibration information is performed each time when the irradiation of the electron beam is performed to a predetermined number of layers.

### Supplementary Note 46

The shaping apparatus according to any one of supplementary notes 42 to 45, wherein the frame member is provided with a beam monitor that detects a beam current of the electron beam.

### Supplementary Note 47

The shaping apparatus according to supplementary note 46, wherein the beam irradiation section has a plurality of the electron beam irradiation units disposed along a first direction traversing the circulation path.

### Supplementary Note 48

The shaping apparatus according to supplementary note 47, wherein at least one of the fiducial mark and the beam monitor is provided at the frame member to correspond to the plurality of electron beam irradiation units individually.

### Supplementary Note 49

The shaping apparatus according to supplementary note 47 or 48, wherein the target is irradiated with the electron beam while being moved substantially along a second direction orthogonal to the first direction within a horizontal plane that is perpendicular to an optical axis of the optical system, and

each of the plurality of electron beam irradiation units deflects the electron beam so that an irradiation area of the electron beam is reciprocally moved at least in the first direction.

### Supplementary Note 50

The shaping apparatus according to any one of supplementary notes 32 to 49, further comprising:

a vacuum chamber that partitions off a vacuum room, a circulation path of the table device being formed inside the vacuum room.

### Supplementary Note 51

The shaping apparatus according to any one of supplementary notes 1 to 50, wherein a first support member as the support member and a second support member different from the first support member are provided, and

the first support member supports a first support surface member as the support surface member, and the second support section supports a second support surface member different from the first support surface member,

the material supply device supplies a shaping material onto a first support surface that the first support surface member has and onto a second support surface that the second support surface member has,

the first and the second movement devices change a relative positional relationship between the beam irradiation device and the first support surface, and a relative positional relationship between the beam irradiation device and the second support surface,

an irradiation area of the energy beam is formed on a shaping material on the first support surface in a first period, and an irradiation area of the energy beam is formed on a shaping material on the second support surface in a second period different from the first period, and

a first shaping object is shaped on the first support surface, and a second shaping object is shaped on the second support surface.

### Supplementary Note 52

The shaping apparatus according to supplementary note 51, wherein the shaping material is supplied to the first support surface in a third period, and the shaping material is supplied to the second support surface in a fourth period different from the third period.

### Supplementary Note 53

The shaping apparatus according to any one of supplementary notes 1 to 50, wherein a first support member as the support member and a second support member different from the first support member are provided, and

the first support member supports a first support surface member as the support surface member, and the second support section supports a second support surface member different from the first support surface member,

the material supply device supplies a shaping material onto a first support surface that the first support surface member has and onto a second support surface that the second support surface member has,

the first and the second movement devices change a relative positional relationship between the beam irradiation device and the first support surface, and a relative positional relationship between the beam irradiation device and the second support surface,

the shaping material is supplied onto the first support surface in a first period, and the shaping material is supplied onto the second support surface in a second period different from the first period, and

a first shaping object is shaped on the first support surface, and a second shaping object is shaped on the second support surface.

### Supplementary Note 54

The shaping apparatus according to any one of supplementary notes 51 to 53, wherein the positional relationship between the beam irradiation device and the first support surface is changed in an in-plane direction intersecting with an irradiation direction of the energy beam, and the positional relationship between the beam irradiation device and the second support surface is changed in the in-plane direction intersecting with the irradiation direction.

### Supplementary Note 55

The shaping apparatus according to any one of supplementary notes 51 to 54, wherein the positional relationship between the beam irradiation device and the first support surface is changed in an irradiation direction of the energy beam, and

the positional relationship between the beam irradiation device and the second support surface is changed in the irradiation direction.

### Supplementary Note 56

The shaping apparatus according to supplementary note 55, wherein the first support surface and the second support surface are moved along the irradiation direction.

### Supplementary Note 57

The shaping apparatus according to supplementary note 56, wherein the first support surface is moved along the irradiation direction, independently from the second support surface.

### Supplementary Note 58

The shaping apparatus according to any one of supplementary notes 51 to 57, wherein the material supply device forms a first layer of the shaping material on the first support surface and also forms a second layer of the shaping material on the second support surface, the second layer being separate from the first layer.

### Supplementary Note 59

The shaping apparatus according to any one of supplementary notes 51 to 58, wherein the first support surface and the second support surface are separate from each other.

### Supplementary Note 60

The shaping apparatus according to any one of supplementary notes 51 to 59, wherein the material supply device supplies the shaping material from a supply port capable of facing the first support surface or the second support surface.

### Supplementary Note 61

The shaping apparatus according to any one of supplementary notes 51 to 60, wherein the material supply device supplies the shaping material from a supply port capable of facing the beam irradiation device.

### Supplementary Note 62

The shaping apparatus according to supplementary note 60 or 61, wherein the material supply device comprises a rake member that spreads the shaping material from the supply port over the first support surface or the second support surface and forms a layer of the shaping material on the first support surface or the second support surface.

### Supplementary Note 63

The shaping apparatus according to any one of supplementary notes 51 to 62, wherein the material supply device comprises a first material supply device that supplies the shaping material from a first supply port, and a second material supply device that supplies the shaping material from a second supply port that is different in position from the first supply port.

### Supplementary Note 64

The shaping apparatus according to any one of supplementary notes 51 to 63, wherein the beam irradiation device comprises a first beam irradiation device that emits the energy beam from a first emitting port, and a second beam irradiation device that emits the energy beam from a second emitting port different from the first emitting port.

### Supplementary Note 65

The shaping apparatus according to supplementary note 64, wherein the first and the second emitting ports are disposed at different positions within a plane intersecting with an irradiation direction in which the energy beams from the first and the second beam irradiation devices are irradiated.

### Supplementary Note 66

The shaping apparatus according to supplementary note 65, wherein the first and the second emitting ports are disposed along a direction intersecting with a direction in which a relative positional relationship between the beam irradiation device and the first or the second support surface is changed.

### Supplementary Note 67

The shaping apparatus according to supplementary note 65 or 66, wherein the first and the second emitting ports are disposed along a direction in which a relative positional relationship between the beam irradiation device and the first or the second support surface is changed.

### Supplementary Note 68

The shaping apparatus according to any one of supplementary notes 51 to 67, wherein the material supply device is moved with respect to the first or the second support surface.

### Supplementary Note 69

The shaping apparatus according to any one of supplementary notes 51 to 68, wherein the beam irradiation device is moved with respect to the first or the second support surface.

### Supplementary Note 70

The shaping apparatus according to any one of supplementary notes 51 to 69, wherein the first and the second support members are movable with respect to the beam irradiation device.

### Supplementary Note 71

The shaping apparatus according to supplementary note 70, wherein the first movement device comprises a moving member that is connected to the first support member and is movable along a movement direction, and the second movement device comprises a moving member that is connected to the second support member and is movable along a movement direction.

### Supplementary Note 72

The shaping apparatus according to supplementary note 71, wherein the first and the second movement devices comprise a drive section that drives the moving member.

### Supplementary Note 73

The shaping apparatus according to supplementary note 71 or 72, wherein the first and the second support members are movable with respect to the moving member.

### Supplementary Note 74

The shaping apparatus according to any one of supplementary notes 51 to 73, wherein the first support member and the second support member rotate with a first axis as a center.

### Supplementary Note 75

The shaping apparatus according to supplementary note 74, wherein the first support member rotates with a second axis serving as a center, the second axis being parallel to the first axis, and

the second support member rotates with a third axis serving as a center, the third axis being parallel to the first axis.

### Supplementary Note 76

The shaping apparatus according to supplementary note 75, wherein when the first support member and the second support member rotate with the first axis serving as a center, attitude of the first support member and attitude of the second support member are maintained.

### Supplementary Note 77

The shaping apparatus according to any one of supplementary notes 51 to 76, wherein the first and the second movement devices move the first support body and the second support body along a circulation path.

### Supplementary Note 78

The shaping apparatus according to any one of supplementary notes 51 to 77, wherein at least one of the first support member and the second support member comprises a fiducial mark to be irradiated with the energy beam.

### Supplementary Note 79

The shaping apparatus according to supplementary note 78, comprising: a detector that detects a component of the energy beam via the fiducial mark.

### Supplementary Note 80

The shaping apparatus according to supplementary note 79, comprising: a controller that acquires information on an irradiation position of the energy beam using a result of detection of the component by the detector.

### Supplementary Note 81

The shaping apparatus according to any one of supplementary notes 51 to 80, wherein at least one of the first support member and the second support member comprises a beam detector that detects a property of the energy beam.

### Supplementary Note 82

The shaping apparatus according to any one of supplementary notes 51 to 81, comprising:

a controller that controls the beam irradiation device and at least one of the first and the second movement devices based on information on 3D data of the shaping object.

### Supplementary Note 83

The shaping apparatus according to supplementary note 82, wherein based on the information on 3D data of the shaping object, the controller controls the beam irradiation device so that the energy beam is irradiated on at least a part of the shaping material above the first support surface, and controls the beam irradiation device so that the energy beam is irradiated on at least a part of the shaping material above the second support surface.

### Supplementary Note 84

The shaping apparatus according to any one of supplementary notes 51 to 83, wherein the material supply device supplies a powdered material.

### Supplementary Note 85

The shaping apparatus according to any one of supplementary notes 51 to 84, wherein the beam irradiation device performs irradiation of a charged particle beam.

### Supplementary Note 86

The shaping apparatus according to any one of supplementary notes 1 to 85, wherein the support member comprises a plurality table devices each of which has:

a table which is movable in a vertical direction and on which the shaping material is spread over;

a table support member on which the table is mounted, and which is provided with a frame member to restrict expansion of a shaping material supplied onto the table and height of an uppermost surface of the shaping material; and

a drive section that moves the table on the table support member in a vertical direction, and

the shaping apparatus further comprises:

a controller that controls the drive section, the first and the second movement devices, the material supply device and the beam irradiation device, wherein

the first and the second movement devices move the plurality of table devices within a horizontal plane along a predetermined circulation path, respectively,

the beam irradiation device has at least one electron beam irradiation unit that has a generating source of electrons and an optical system, the at least one electron beam irradiation unit irradiating a target with electrons emitted from the generating source as the electron beam and being capable of deflecting the electron beam within a predetermined angle range,

the material supply device is disposed at a position different from the beam irradiation section on the circulation path, spreads the shaping material over a work area on the table defined by the frame member and forms a layer of the shaping material in the work area at each of the plurality of table devices, and

in parallel with controlling the first and the second movement devices and the beam irradiation device based on 3D data of the shaping object so that the electron beam is selectively irradiated on only a necessary part of the shaping material spread over a table of a first table device of the plurality of table devices, with the shaping material spread over serving as a target, the controller controls the material supply device during movement within a horizontal plane of a second table device of the plurality of table devices so that the shaping material is spread over a table of the second table device, the second table device being different from the first table device.

### Supplementary Note 87

The shaping apparatus according to supplementary note 86, further comprising: a preheating unit that is adjacently disposed on a downstream side of the material supply device on the circulation path, and preheats the shaping material.

### Supplementary Note 88

The shaping apparatus according to supplementary note 87, wherein the controller preheats a shaping material spread over the table of the second table device, using the preheating unit.

### Supplementary Note 89

The shaping apparatus according to supplementary note 88, wherein preheating of the shaping material is performed in parallel with selective irradiation of the electron beam to the target that is performed on the table of the first table device.

### Supplementary Note 90

The shaping apparatus according to any one of supplementary notes 87 to 89, wherein the first movement device moves each of the plurality of table devices along the circulation path, and

the second movement device drives the plurality of table devices in conjunction with change in position within a horizontal plane of the plurality of table devices moved by the first movement device, so that an orientation of the table of each of the plurality of table devices is maintained.

### Supplementary Note 91

The shaping apparatus according to supplementary note 90, wherein the first movement device includes a first member that is rotatable around a first axis perpendicular to the horizontal plane, and the plurality of table devices are mounted on the first member, and

the second movement device drives each of the plurality of tables to rotate around a second axis perpendicular to the horizontal plane in a reverse direction to the first member with a rotational speed ratio of 1:1, in conjunction with rotation of the first member.

### Supplementary Note 92

The shaping apparatus according to supplementary note 91, wherein the first member is a turntable that rotates around the first axis.

### Supplementary Note 93

The shaping apparatus according to any one of supplementary notes 87 to 92, wherein the material supply device is made up of a powder coating system, and

the powder coating system has a material supply unit and a rake member, the material supply unit supplying a shaping material onto the table when any one of the plurality of table devices is located at a predetermined position on the circulation path, the rake member being relatively movable with respect to the frame member along an upper surface of the frame member.

### Supplementary Note 94

The shaping apparatus according to any one of supplementary notes 87 to 93, wherein the beam irradiation device has a plurality of beam irradiation units disposed along a first direction traversing the circulation path.

### Supplementary Note 95

The shaping apparatus according to supplementary note 94, wherein

the target is irradiated with the electron beam while being moved substantially along a second direction perpendicular to the first direction within a horizontal plane that is orthogonal to an optical axis of the optical system, and

each of the plurality of electron beam irradiation units deflects the electron beam so that an irradiation area of the electron beam is reciprocally moved at least in the first direction.

### Supplementary Note 96

The shaping apparatus according to supplementary note 95, wherein each of the plurality of electron beam irradiation units is capable of deflecting the electron beam to be irradiated on the target so that the electron beam overlaps a part of the electron beam emitted from the adjacent electron beam irradiation unit.

### Supplementary Note 97

The shaping apparatus according to any one of supplementary notes 87 to 92, wherein a frame member of each of the plurality of table devices is provided with a fiducial mark, and

the shaping apparatus further comprises:

a position measurement system capable of measuring position information of each of the plurality of table devices at least within a horizontal plane; and

a detector capable of detecting a reflection component generated from the fiducial mark by irradiation of the electron beam to the fiducial mark, wherein

when one table device of the plurality of table devices is moved by the movement system to a position where the electron beam from the beam irradiation device can be irradiated on the fiducial mark, the controller acquires calibration information for an irradiation position of the electron beam based on a detection result of the detector and a measurement result of position information of the one table device by the position measurement system at the time of the detection while irradiating the electron beam on the fiducial mark via the beam irradiation device.

### Supplementary Note 98

The shaping apparatus according to supplementary note 97, wherein acquisition of the calibration information is performed each time when the irradiation of the electron beam is performed to a predetermined number of layers on each of the plurality of table devices.

### Supplementary Note 99

The shaping apparatus according to supplementary note 97 or 98, wherein the frame member of each of the plurality of table devices is provided with a beam monitor that detects a beam current of the electron beam.

### Supplementary Note 100

The shaping apparatus according to supplementary note 99, wherein the beam irradiation device has a plurality of the electron beam irradiation units disposed along a first direction traversing the circulation path.

### Supplementary Note 101

The shaping apparatus according to supplementary note 99, wherein at least one of the fiducial mark and the beam monitor is provided at the frame member of each of the plurality of table devices to correspond to the plurality of electron beam irradiation units individually.

### Supplementary Note 102

The shaping apparatus according to supplementary note 100 or 101, wherein the target is irradiated with the electron beam while being moved substantially along a second direction orthogonal to the first direction within a horizontal plane that is perpendicular to an optical axis of the optical system, and

each of the plurality of electron beam irradiation units deflects the electron beam so that an irradiation area of the electron beam is reciprocally moved at least in the first direction.

### Supplementary Note 103

The shaping apparatus according to any one of supplementary notes 87 to 102, wherein the plurality of table devices sequentially face the beam irradiation device.

### Supplementary Note 104

The shaping apparatus according to supplementary note 87, wherein multiple sets of the beam irradiation device and the material supply devices are provided,

each set of the multiple sets of the beam irradiation device and the material supply device is sequentially disposed on the circulation path, and

with the each set, spreading of the shaping material over the table and irradiation of the electron beam to the spread shaping material are sequentially performed by the controller, during movement of one cycle of the plurality of table devices along the circulation path.

### Supplementary Note 105

The shaping apparatus according to supplementary note 104, wherein one each of a preheating unit that preheats the shaping material is disposed, on the circulation path, between the beam irradiation device and the material supply device in the each set.

### Supplementary Note 106

The shaping apparatus according to supplementary note 105, wherein a set of the beam irradiation device, the material supply device and the preheating unit is provided in a same number as the number of the table devices.

### Supplementary Note 107

The shaping apparatus according to any one of supplementary notes 87 to 106, further comprising:

a vacuum chamber that partitions off a vacuum room, a circulation path of the plurality of table devices being formed inside the vacuum room.

### REFERENCE SIGNS LIST FOR FIGS. 1 TO 25

12, 12A and 12B . . . table devices,

14 and 14A . . . movement systems,

16 . . . beam irradiation section,

18 . . . powder coating system,

20 . . . controller,

21 . . . drive gear,

22 . . . rotation table,

23 . . . fiducial mark plate,

24 . . . table base,

24c . . . frame-shaped section,

26 . . . table,

27 . . . shaft member,

28 . . . motor,

28a . . . drive shaft,

29 and 29A . . . driven gears,

30ᵢ . . . electron beam irradiation unit,

30a . . . generating source of electrons,

30b . . . electron beam optical system,

31 . . . drive mechanism,

42 . . . position measurement system,

41 . . . shaping material supply unit,

46 . . . powder feeder,

48 . . . material supply device,

50 . . . preheating unit,

52 . . . back-scattered electron detector,

100 . . . shaping apparatus,

100A . . . housing,

BM . . . shaping material,

EB . . . electron beam,

FM₁ to FM₃. . . fiducial marks.

### Fourth Embodiment

To increase speed, throughput and reduce operation costs of 3D printing systems, techniques are disclosed herein for a rotary turntable 3D printer comprising: a main rotating support table that rotates about a first axis and one or more secondary support tables that rotate around a non-coaxial secondary axis; a powder supply assembly that distributes powder onto the support tables; and an energy system that directs an energy beam at the powder to form a portion of a part being built. The main support table and secondary support tables can rotate in the same or in opposite directions. Additionally, each of the secondary support tables is configured to rotate independently around its own non-coaxial secondary axis, and can therefore rotate in any direction (e.g., in the same or different directions as the main rotating support table, or in the same or different directions as any of the other secondary support tables).

Disclosed techniques include: grooved support table surfaces for improving the stability of applied powder used for building parts; reciprocating bellows to control a differential load on actuators that move the support tables, the load being caused by operating at least some of the machine components in vacuum; one or more high temperature bearings or bushings to support rotary motion at high temperatures; and a counterbalance mechanism to counterbalance at least a portion of the weight of the part being built and to reduce an imbalance during the operation of the rotating support tables.

In some embodiments, a system for 3D printing includes a rotating support table configured to rotate about a first axis and one or more secondary support tables. In some instances, the one or more secondary support tables rotate with the rotating support table and the one or more secondary support tables rotate around non-coaxial secondary axes. In some cases, the non-coaxial secondary axes move along with the rotating support table.

In some embodiments, the rotating support table and the one or more secondary support tables are configured to rotate in a same rotational direction. In other embodiments, the rotating support table is configured to rotate about the first axis in a first rotational direction and the one or more secondary support tables are configured to rotate around non-coaxial secondary axes in a second rotational direction opposite or counter to the first rotational direction.

Additionally, each of the secondary support tables is configured to rotate independently around its own non-coaxial secondary axis, and can therefore rotate in any direction (e.g., in the same or different directions as the main rotating support table, or in the same or different directions as any of the other secondary support tables).

In some embodiments, a first motor rotates the rotating support table, and in some cases, the first motor uses a belt to rotate the rotating support table. A second motor rotates the one or more secondary support tables. The second motor uses one or more belts to rotate the one or more secondary support tables.

In some embodiments, a processing machine for building a part as disclosed herein includes a rotating support table configured to rotate about a first axis. The rotating support table comprises a secondary support table. The secondary support table is configured to rotate with the rotating support table and the secondary support table is configured to rotate around a non-coaxial secondary axis. Additionally, in some cases, the processing machine comprises a powder supply assembly that distributes powder onto the secondary support table to form a powder layer. In some examples, as discussed in more detail herein, the powder supply assembly comprises a material supply device or powder supply device. In some cases, the processing machine also comprises an energy system that directs an energy beam at a portion of the powder on the secondary support table to form a portion of the part being built. In some embodiments, the energy system comprises an irradiation device.

In some instances, the part being built comprises a three-dimensional (3D) object built from powder, the rotating support table comprises a rotary turntable (e.g., a main rotary turntable), and the secondary support table supports a build platform (e.g., a rotary build platform) configured to support the part being built. In these cases, the build platform is configured to rotate around the non-coaxial secondary axis.

In some cases, as described in more detail in FIGS. 26A-26C below, the processing machine comprises a rotating turntable 3D printer configured to address the problem of beam hatching in a single direction.

FIGS. 26A-26C disclose exemplary embodiments that address the problem of beam hatching in a single direction in a rotating turntable 3D printer comprising a rotating support table (e.g., a main rotary turntable) with one or more secondary support tables having build platforms disposed on the rotating support table. In the example shown, embodiments of FIGS. 26A-26C can be used to generate multiple beam hatching directions across the surface of a build part on a build platform in a rotating turntable 3D printer. An advantage of providing multi-direction beam hatching as described, for example, with respect to FIGS. 26A-26C, is improved build part densification to minimize the number and size of voids in the build part, without degrading the throughput of a rotating turntable 3D printer.

FIG. 26A illustrates a top down view of an exemplary embodiment of a rotating turntable 3D printer. In particular, FIG. 26A shows an example of a rotating support table, in this case, circular main rotary turntable 2600, for a three-dimensional (3D) printer having build platforms, in this case, rotary build platforms (RBPs) 2601-2606, that are detachably supported by a secondary support table (not shown in the FIG. 26A) and rotatable relative to the main rotary turntable (MRT) 2600. Rotary build platforms (RBPs) are not components of the processing machine. However, hereinafter, both of secondary support table and rotary build platform (RBP) placed on the secondary support table are collectively referred to as a rotary build platform for the sake of convenience in the description. In some cases, the rotating support table (e.g., main rotary turntable) and the secondary support table (e.g., rotary build platform) are configured to rotate in a same rotational direction. In other cases, such as the first embodiment, the rotating support table (e.g., main rotary turntable) is configured to rotate about the first axis in a first rotational direction and the secondary support table (e.g., rotary build platform) is configured to rotate around the non-coaxial secondary axis in a rotational direction counter to the first rotational direction. The MRT 2600 may have a non-circular shape (e.g. polygonal shape).

As an example, in the embodiment shown in FIG. 26A, MRT 2600 rotates clockwise around a main rotary turntable axis 2610 as shown by the arrow about MRT 2600 during the 3D printing process. In other embodiments, MRT 2600 is configured to rotate counterclockwise around rotating table axis 2610.

In the embodiment of FIG. 26A, the 3D printer includes a plurality of secondary support tables, in this case, six circular rotary build platforms (RBPs) 2601-2606, disposed on MRT 2600. The RBPs 2601-2606 are rotating turntables disposed on the main rotary turntable 2600. The RBPs 2601-2606 are configured to rotate around main rotary turntable axis 2610 along with MRT 2600. In addition, each of the six RBPs 2601-2606 is rotatable around its own axis at the center of each of the respective RBPs in the perspective view of FIG. 26A. In the example shown, each of the RBPs 2601-2606 is configured to be rotated around an axis of rotation that is non-coaxial with respect to the axis of rotation of MRT 2600 and that is non-coaxial with respect to the axes of rotation of each of the other five RBPs.

The exemplary embodiment of a 3D printer as shown in FIG. 26A is designed to build a three-dimensional (3D) part (also referred to herein as a build part) on each of the RBPs 2601-2606 using a powder supply assembly or powder supply device, in this case, material supply device 2611 and an energy system, in this case, irradiation device 2612. The material supply device 2610 may, for example, supply a layer of powder on each of the RBPs 2601-2606 during each rotation of MRT 2600. The irradiation device 2612 emits one or more irradiation energy beams that irradiate and fuse together the powder supplied by material supply device 2611 to form the build part on each RBP of the 3D printer, as described for example in PCT applications WO2019/133552A1 and WO2019/133553 A1, which are incorporated by reference herein in its entirety. In the example shown, each of the six (RBPs) 2601-2606 is configured to support one or more parts as the parts are being built by the 3D printer.

In some embodiments, the processing machine as disclosed herein is configured to build multiple parts in parallel on multiple build platforms. In cases where the processing machine is configured to build a plurality of parts, the rotating support table comprises a rotary turntable, and the secondary support table comprises a plurality of build platforms. Each build platform in the plurality of build platforms is configured to rotate around its own non-coaxial secondary axis. Moreover, each build platform in the plurality of build platforms is configured to support one of the plurality of parts being built in parallel as layers of powder are distributed on each build platform.

Additionally, each build platform in the plurality of build platforms is configured to rotate independently around its own non-coaxial secondary axis, and can therefore rotate in any direction (e.g., in the same or different directions as the main rotary table (MRT), or in the same or different directions as any of the other build platforms).

As described herein, in some cases the RBPs are disposed on the rotary turntable to enable building two or more parts in parallel. Although six RBPs are shown in the embodiment of FIG. 26A, MRT 2600 may, in other embodiments, have any number of rotary build platforms (e.g., 1, 2, 3, 4, 5, 7, 8, 9, 10, etc.) that are arranged in any fashion around the surface of the MRT 2600. Each of the RBPs in these other embodiments also supports one or more parts built by the 3D printer. In the embodiment of FIG. 26A, each of the RBPs 2601-2606 is the same radial distance from the center of the MRT 2600. In other embodiments, two or more RBPs on MRT 2600 may be positioned at different radial distances from the center of MRT 2600.

Each of the RBPs 2601-2606 is rotatable relative to the MRT 2600. Each of the RBPs 2601-2606 can be rotated independently of the MRT 2600. In an embodiment, each of the RBPs 2601-2606 can be rotated independently of each of the other five RBPs. In other embodiments, the rotation of two or more of the RBPs 2601-2606 can be coupled together using a common control mechanism.

In some cases, the rotary turntable and each of the build platforms are configured to rotate in a same rotational direction. In other cases, the rotary turntable is configured to rotate about the first axis in a first rotational direction and wherein the build platforms are each configured to rotate around their own non-coaxial secondary axes in a second rotational direction opposite or counter to the first rotational direction.

Additionally, each build platform in the plurality of build platforms is configured to rotate independently around its own non-coaxial secondary axis, and can therefore rotate in any direction (e.g., in the same or different directions as the main rotary table (MRT), or in the same or different directions as any of the other build platforms).

As an example, the rotation of all six of the RBPs 2601-2606 may be in the same radial direction, at the same velocity, and at the same time or in synchronized time intervals. Each of the RBPs 2601-2606 may rotated at the same velocity or at a different velocity relative to each of the other RBP and relative to MRT 2600.

RBPs 2601-2606 can be rotated in the same radial direction as MRT 2600 or in a different direction than MRT 2600. RBPs 2601-2606 can be rotated clockwise or counterclockwise. For example, if MRT 2600 is rotating clockwise, RBPs 2601-2606 may be rotating clockwise or counterclockwise. As another example, if MRT 2600 is rotating counterclockwise, RBPs 2601-2606 may be rotating clockwise or counterclockwise.

RBPs 2601-2606 may be rotated continuously, periodically, intermittently, or discretely. As an example, each of the RBPs 2601-2606 may be continuously rotated counterclockwise and at the same velocity as MRT 2600, while MRT 2600 is rotated clockwise. In this example, each of the RBPs 2601-2606 maintains the same north-south-east-west orientation, while MRT 2600 rotated clockwise around axis 2610, such that the north-south-east-west orientation of RBPs 2601-2606 appears to remain the same to a stationary observer.

In some embodiments, each of the RBPs 2601-2606 may be rotated in a one or more discrete turns. For example, each of the RBPs 2601-2606 may be rotated by a single turn of 90° during the process of building each of the build parts in order to change the direction of the irradiation energy beams across each of the build parts.

FIGS. 26B-26C illustrate examples of six 3D parts 2621-2626 that are built by the 3D printer having MRT 2600, according to an embodiment. In the embodiment of FIGS. 26B-26C, the layers of powder used to form each of the six 3D parts are irradiated by irradiation energy beams emitted by irradiation device 2612 along two sets of perpendicular lines that are created by rotating the each of the RBPs 2601-2606 by a single turn of 90°.

FIG. 26B illustrates a top down view of an exemplary embodiment of a rotating turntable 3D printer showing a first hatching direction in a print process to build a part. In the example shown, the irradiation device 2612 emits an irradiation beam that irradiates the powder layers to form the corresponding layers each of the build parts 2621-2626. The irradiation device 2612 steers the irradiation beam in a linear direction across the radius of MRT 2600 (perpendicular to the rotation of MRT 2600). Irradiation device 2612 causes the irradiation beam to make several parallel linear passes during a 360° rotation of MRT 2600 to melt a layer of the powder and form a layer of each of the build parts 2621-2626. The path of the irradiation beam emitted by irradiation device 2612 across each of the build parts 2621-2626 during a 360° rotation of MRT 2600 is illustrated by parallel lines in a first hatching direction in the specific example FIG. 26B. According to various embodiments, irradiation device 2612 may perform any number of parallel linear passes of the irradiation beam to form each layer of each build part.

FIG. 26C illustrates a top down view of an exemplary embodiment of a rotating turntable 3D printer showing a second hatching direction in a print process to build a part. In particular, each of the RBPs 2601-2606 as shown in FIG. 26B is rotated by a single turn of 90° relative to MRT 2600 in order to cause the irradiation energy beams to irradiate each powder layer in a second hatching direction as shown in FIG. 26C that is perpendicular to the first hatching direction in FIG. 26B. Thus, FIG. 26C illustrates the effect of rotating the build parts 2621-2626 by 90° to cause the irradiation device 2612 to irradiate each powder layer in a second hatching direction that is perpendicular to the first hatching direction of FIG. 26B. To create the cross-hatched pattern shown in FIG. 26C, irradiation device 2612 steers the irradiation beam in the same linear direction perpendicular to the radius of MRT 2600 after the build parts 2621-2626 have been rotated by 90° to make a second set of parallel linear passes during a second 360° rotation of MRT 2600. The second set of parallel linear passes of the irradiation beam melt a layer of the powder and form a layer of each of the build parts 2621-2626. In FIG. 26C, the path of the irradiation beam emitted by irradiation device 2612 across each of the build parts 2621-2626 during a second 360° rotation of MRT 2600 is illustrated by the parallel lines in a second hatching direction that are perpendicular to the parallel lines in the first hatching direction shown in FIGS. 26B and 26C. Thus, each layer of each of the build parts 2621-2626 is formed by the irradiation beam making a first set of parallel linear passes across the surface of the build part in the first hatching direction during a first 360° rotation of MRT 2600 to melt a corresponding layer of the powder. Then, the irradiation beam makes a second set of parallel linear passes across the surface of the build part in the second hatching direction during a second 360° rotation of MRT 2600 to melt the same layer of the powder.

In other embodiments, multi-direction beam hatching can be performed at angles other than, or in addition to, 90°. For example, each of the RBPs 2601-2606 may be rotated by 4 separate turns of 45° relative to MRT 2600 in order to cause the irradiation energy beams to irradiate each powder layer in four hatching directions that are offset by 45° from each other (i.e., 45°, 90°, 135°, and 180°).

### Fifth Embodiment

In some cases, various techniques are described to address the increased cost associated with 3D printing using one or more non-coaxial rotating turntables as disclosed herein.

For example, in some embodiments, a processing machine for 3D printing of a part as disclosed herein comprises a rotating support table configured to rotate about a first axis, the rotating support table comprising a secondary support table, the secondary support table being configured to rotate with the rotating support table and also being configured to rotate around a non-coaxial secondary axis. The processing machine further comprises a powder supply assembly that distributes powder onto the secondary support table to form a powder layer and an energy system that directs an energy beam at a portion of the powder on the secondary support table to form a portion of the part being built.

In some cases, the rotating support table is actuated by a first motor using a first timing belt and the secondary support table is actuated by a second motor using a second timing belt. In some embodiments, rotary encoders are applied to motor shafts of the first motor and the second motor, while in other embodiments, rotary encoders are applied directly to the rotating support table and to the secondary support table.

In some embodiments, the rotary turntable is actuated by a first motor using a first timing belt and the build platforms are actuated by a second motor using a plurality of build platform timing belts, wherein each build platform is actuated using its own build platform timing belt in the plurality of build platform timing belts.

In some embodiments, the processing machine (e.g., 3D printer) comprises two rotary servo actuators and multiple timing belts. For example, in the embodiment disclosed herein with respect to FIGS. 27A-27B, a 3D printer includes a rotating support table, in this case, a main rotary turntable (MRT), that is actuated by a first rotating motor via a first timing belt and multiple secondary support tables, in this case, non-coaxial rotary build platforms (RBPs), on the MRT that are actuated by a second rotating motor via multiple additional timing belts. Rotary encoders may be applied to the motor shafts or directly to the main rotary turntable and rotary build platforms. Applying the rotary encoders to the motor shaft may be less costly, but applying the encoders directly to the MRT and RBPs may provide increased precision. In another embodiment, the main rotary turntable together with the rotary build platforms are removed from the printing chamber for offline part cooling. In yet another embodiment, only the rotary build platforms are removed for offline cooling.

FIG. 27A illustrates a side view of exemplary portions of a rotary turntable 3D printer as disclosed herein. As shown in FIG. 27A, the exemplary 3D printer includes a main rotary turntable (MRT) 2700, three non-coaxial rotating turntables 2701-2703 on the main rotary turntable (MRT), and two movers (e.g., motors 2720 and 2730), according to an embodiment.

FIG. 27B illustrates a top down view of the 3D printer shown in FIG. 27A. In the example shown, the first circular motor 2730 shown in FIGS. 27A-27B is used to rotate MRT 2700. Motor 2730 is connected to a timing belt 2710 that is wrapped around a portion of the outer circumference of motor 2730. The timing belt 2710 is also wrapped around a portion of the outer circumference of MRT 2700, as shown in FIGS. 27A-27B. An actuator 2760 rotates the circular motor 2730 and is supported by a fixed support pedestal 2750, as shown in FIG. 27A. The rotation of the motor 2730 moves the timing belt 2710, which causes MRT 2700 to rotate. Motor 2730 and MRT 2700 can be rotated either clockwise or counterclockwise.

MRT 2700 includes three non-coaxial rotating turntables 2701-2703 that are also referred to herein as rotary build platforms (RBPs). The 3D printer of FIGS. 27A-27B is designed to build a 3D part on each of the RBPs 2701-2703 using a powder supply assembly (e.g., a powder supply device), an energy system (e.g., an irradiation device), and other devices that are disclosed herein but not shown in FIGS. 27A-27B.

In the embodiment of FIGS. 27A-27B, RBPs 2701-2703 rotate independently of MRT 2700 using a second circular motor 2720 that is located in the center of MRT 2700 and is coaxial with MRT 2700. Motor 2720 rotates the RBPs 2701-2703 using three separate timing belts 2711-2713. Motor 2720 is connected to the three timing belts 2711-2713, such that each of the timing belts 2711-2713 is wrapped around a portion of the outer circumference of motor 2720, as shown in FIG. 27B. As shown in FIG. 27A, the timing belts 2711-2713 are wrapped around non-overlapping portions of the outer circumference of a cylindrical part of motor 2720 that is underneath and extends below MRT 2700. Timing belts 2711-2713 do not overlap each other on the cylindrical part of motor 2720.

Each of the timing belts 2711-2713 is used to rotate a respective one of the RBPs 2701-2703. Each of the RBPs 2701-2703 is coupled to a cylindrical pulley that extends below MRT 2700. The bottom surfaces of the RBPs 2701-2703 are attached to cylindrical pulleys 2721-2723, respectively, as shown in FIG. 27A. FIG. 27B shows that the timing belts 2711-2713 are also wrapped around the cylindrical pulleys 2721-2723 of the RBPs 2701-2703, respectively. The cylindrical pulleys 2721-2723 are fixed to the RBPs 2701-2703, respectively, such that the cylindrical pulleys 2721-2723 and their respective RBPs 2701-2703 rotate at the same angular velocity. The cylindrical pulleys 2721-2723 have smaller diameters than the RBPs 2701-2703. The cylindrical pulleys 2721-2723 and motor 2720 may, for example, have the same diameter. The cylindrical pulleys 2721-2723 of RBPs 2701-2703, respectively, are below MRT 2700 and are horizontally adjacent to motor 2720, as shown in FIG. 27A.

Motor 2720 is rotated by an actuator in cylindrical shaft 2770 that is supported by a base support 2780, as shown in FIG. 27A. The rotation of the motor 2720 moves the timing belts 2711-2713, which causes the respective RBPs 2701-2703 to rotate. Motor 2720 and RBPs 2701-2703 can be rotated either clockwise or counterclockwise. Motor 2720 and/or the actuator may be coupled to an encoder that is used to identify the position of each of the RBPs during the 3D printing process. The encoder is a device that measures the angular position and/or velocity of rotating motor 2720 using light signals. The encoder may be in shaft 2770 with the actuator or in a different housing. The encoder controls and coordinates the rotation of motors 2720 and 2730, for example, using feedback from the MRT 2700 and RBPs 2701-2703.

Motor 2720 does not rotate MRT 2700. The central platform of each of the RBPs 2701-2703 can be lowered though the cylindrical shaft after each rotation of MRT 2700, for example, to maintain a constant distance between the RBPs and the mechanisms above the MRT 2700, including the powder supply device, an irradiation device, and additional devices that are used to form the build parts.

An advantage of the embodiment of FIGS. 27A-27B is that two, three, or more RBPs can be rotated with a single motor 2720 and a single actuator. According to other alternative embodiments not shown in FIGS. 27A-27B, each of the rotary build platforms (RBPs) may be rotated by a separate motor and a separate actuator. As an example, three RBPs may be rotated by three separate motors and three separate actuators. In these embodiments, each motor and/or actuator is coupled to a separate encoder device that positively identifies the position of each RBP without having to infer the position of each RBP from a motor, such as motor 2720, that rotates multiple RBPs using timing belts. Using a separate motor and actuator to rotate each RBP reduces errors in the position identification of the RBP, because errors in the timing belts 2711-2713 (e.g., caused by heating or stretching) can introduce errors into the encoder.

In an alternative embodiment of FIGS. 27A-27B, motor 2720 is replaced with a fixed cylinder or mast that does not rotate. The timing belts 2711-2713 connect this fixed cylinder to cylindrical pulleys 2721-2723, respectively, as shown in FIG. 27B. In this embodiment, the rotating motion of MRT 2700 causes the three RBPs 2701-2703 to rotate around the central axis of MRT 2700. Because the timing belts 2711-2713 are attached to the fixed cylinder and to the cylindrical pulleys 2721-2723, the rotation of the RBPs about the central axis of MRT 2700 causes the timing belts 2711-2713 to rotate the RBPs 2701-2703, respectively, around their individual central axes of rotation relative to MRT 2700. If the fixed cylinder that replaces motor 2720 has the same diameter as each of the cylindrical pulleys 2721-2723, then the RBPs remain in fixed north-south-each-west positions as the MRT 2700 rotates.

### Sixth Embodiment

In some cases, the rotation of the main rotary turntable and the rotary build platforms makes it difficult to apply powder in a stable manner. For example, where the surface of the turntable and platforms are smooth, the rotational motion causes applied powder to shift to undesirable positions. As described herein, techniques to address this problem of unstable powder position after introduction to a smooth rotating support table and/or secondary support tables include providing a rough top surface on the rotating support table and/or secondary support tables. As an example, a grooved rotating support table (e.g., a grooved main rotary turntable) and/or a grooved secondary support table (e.g., a grooved rotary build platform) are provided, wherein the grooved top surfaces provide sufficient roughness to enable the stable application of powder to the rotating support table and/or secondary support tables.

Accordingly, in some embodiments a processing machine for 3D printing of a part as disclosed herein comprises a rotating support table configured to rotate about a first axis, the rotating support table comprising a secondary support table, the secondary support table being configured to rotate with the rotating support table and also being configured to rotate around a non-coaxial secondary axis. The processing machine further comprises a powder supply assembly that distributes powder onto the secondary support table to form a powder layer and an energy system that directs an energy beam at a portion of the powder on the secondary support table to form a portion of the part being built.

Moreover, as discussed in more detail with respect to the FIGS. 28, FIGS. 29A-29B, and FIG. 30 below, in some embodiments, the rotating support table is configured with a rough top surface to hold a powder from spinning off the surface of the rotating support table. In some cases, the rotating support table is grooved to hold a powder from spinning off the surface of the rotating support table. Additionally or in the alternative, a secondary support table of the one or more secondary support tables are configured with a rough top surface to hold powder from spinning off the surface of the rotating support table. In some cases, a secondary support table of the one or more secondary support tables are grooved to hold powder from spinning off the surface of the rotating support table.

In some embodiments, concentric V-shaped grooves are machined (or formed) into the rotating support table (e.g., main rotary turntable) and/or the secondary support tables (e.g. rotary build platforms). The V-shaped grooves create a sufficiently rough surface that traps powder on the rotating support table and/or the secondary support tables and allows more powder to be applied on top of the trapped powder in the grooves. As a result, the machined V-shaped grooves as disclosed herein provide an economic way to increase surface roughness on the support tables sufficient to address the problem of unstable powder application.

FIG. 28 illustrates a cross-sectional view of a portion of an exemplary 3D printer having grooved support table surfaces for improving the stability of applied powder used for building parts. As shown in the cross-sectional view of FIG. 28, concentric V-shaped grooves on the upper surface of a rotating support table, in this case, main rotary turntable (MRT) 2801, and on the upper surfaces of secondary support tables, in this case, rotary build platforms (RBPs) 2811-2812, are configured to create a surface that improves the stability of applied powder. The 3D printer of FIG. 28 also includes a fixed support pedestal 2820, a motor 2830 that rotates MRT 2801, and linear actuators that move the RBPs vertically. Linear actuator 2815, for example, moves RBP 2812 vertically down and/or up during the process of building a 3D part. The linear actuators do not rotate during the build process. The linear actuators are attached to plate 2850, which is attached to pedestal 2820. Each RBP is connected to a cylinder that extends below MRT 2801. The cylinder includes a hollow cavity that may be used as a supply bin for supplying powder to build a 3D part or as a collection bin for collecting excess power. For example, RBP 2812 is connected to cylinder 2805 having a cavity 2818 inside.

As shown in FIG. 28, the MRT 2801 has concentric V-shaped grooves that have been machined into its upper surface 2802. The V-shaped grooves in the surface 2802 of MRT 2801 are concentric with the center axis of MRT 2801. In addition, the RBPs 2811-2812 have concentric V-shaped grooves that have been machined into their upper surfaces 2813-2814, respectively. The V-shaped grooves in the upper surfaces 2813-2814 are concentric with the center axes of RBPs 2811-2812, respectively. The V-shaped grooves in surfaces 2802, 2813, and 2814 reduce the undesirable movement of powder applied to surfaces 2802, 2813, and 2814 during the process of building 3D parts on MRT 2801, RBP 2811, and/or RBP 2812 that is caused by the rotation of MRT 2801, RBP 2811, and RBP 2812, respectively. The V-shaped grooves may be machined into surfaces 2802, 2813, and 2814 using, for example, a lathe or milling machine. The cross-sectional shape of the groove is not limited to the V-shape.

FIG. 29A illustrates a perspective view of an exemplary processing machine as described herein having grooved support table surfaces for improving the stability of applied powder used for building parts. FIG. 29B illustrates a cross-sectional view of the processing machine of FIG. 29A.

As shown in FIGS. 29A-29B, an exemplary processing machine as disclosed herein, in this case a 3D printer, has concentric V-shaped grooves on the upper surfaces of three rotary build platforms (RBPs). In the example shown, the 3D printer of FIGS. 29A-29B includes a rotating support table, in this case, main rotary turntable (MRT) 2901, three secondary support tables, in this case, rotary build platforms (RBPs) 2911-2913, and a rake 2920. Each of the RBPs is connected to a cylinder that extends below MRT 2901. In some embodiments, each of the cylinders contains a hollow cavity that may be used as a powder supply bin or as a collection bin for collecting excess power. For example, RBPs 2911-2913 are connected to cylinders 2931-2933, respectively.

In the example shown, RBPs 2911-2913 have concentric V-shaped grooves that have been machined into the upper surfaces of RBPs 2911-2913 using, for example, a lathe or end milling machine. In this case, the V-shaped grooves are concentric with the center axes of RBPs 2911-2913. As discussed above, the rotation of MRT 2901 and of RBPs 2911-2913 during the process of building 3D parts on RBPs 2911-2913 may cause undesirable movement of the powder on the upper surfaces of RBPs 2911-2913. The V-shaped grooves reduce the movement of powder on the upper surfaces of RBPs 2911-2913 to the edges of the RBPs during the process of building 3D parts on the RBPs.

In some embodiments, a first cylinder in a MRT may be used as a powder supply bin for supplying powder to a RBP connected to a second cylinder in the MRT. The first cylinder may be raised periodically by a linear actuator to supply additional powder to the RBP. Rake 2920 scrapes powder from the supply bin and moves the powder across the MRT to the upper surface of the RBP. The powder is irradiated and then cooled to form a layer of a 3D part on the RBP. Rake 2920 then scrapes any excess powder from the upper surface of the RBP on which the build part is being formed across the MRT to a third cylinder in the MRT that is being used as a powder collection bin. The excess powder then falls into the collection bin inside the third cylinder. The third cylinder may be lowered periodically by a linear actuator to deposit additional excess powder into the collection bin. In these embodiments, the RBPs on the first and third cylinders are removed so that the excess powder can be supplied from the supply bin and deposited into the collection bin.

As an example, a first cylinder 2931 may be used as a powder supply bin, the 3D printer may build a 3D part on RBP 2912, the hollow cavity 2923 in the third cylinder 2933 may be used as a powder collection bin, and RBPs 2911 and 2913 may be removed from the 3D printer. In this example, the grooved plates are not present on the cylinders and rake 2920 scrapes powder from the powder supply bin in first cylinder 2931 across the upper surface of MRT 2901 to the upper surface of RBP 2912. Then, rake 2920 scrapes any excess powder from RBP 2912, moves the excess powder across the upper surface of MRT 2901, and deposits the excess powder into collection bin 2923 inside cylinder 2933.

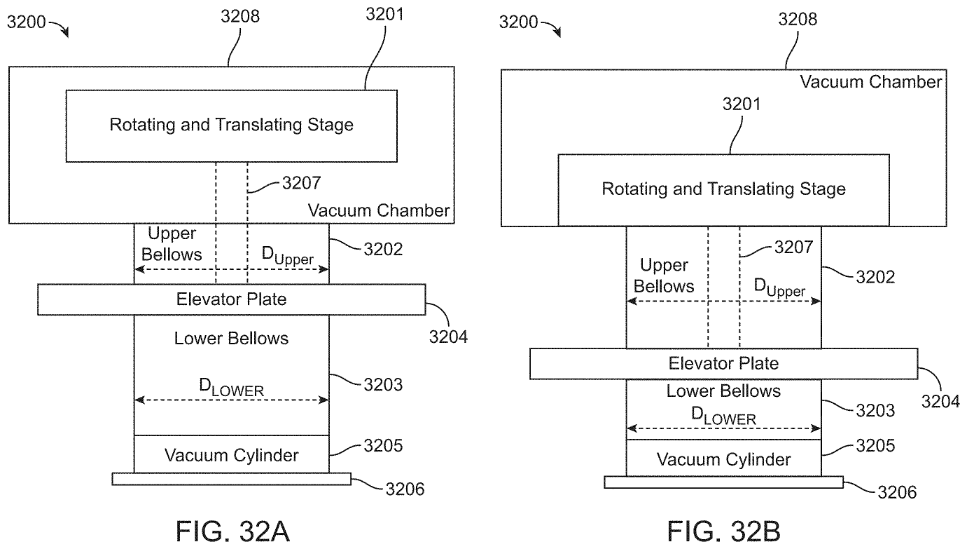

FIG. 30 illustrates a cross-sectional view of V-shaped grooves on an upper surface of a support table for improving the stability of applied powder used for building parts, according to an embodiment. As depicted in FIG. 30, V-shaped grooves 3001 are shown on an upper surface of a support table, in this case, a circular build platform used to build a 3D part in a 3D printer. The V-shaped grooves 3001 may, for example, be formed on an upper surface of a rotary build platform or on an upper surface of a main rotary turntable, as disclosed herein with respect to FIGS. 28 and 29A-29B. Powder grains 3002 are deposited on the surface of the circular build platform during the process of building the 3D part. The powder grains 3002 become trapped between the ridges of the V-shaped grooves 3001, as shown in FIG. 30, to reduce movement of the powder grains 3002 during the 3D printing process that may be caused by the rotation of the build platform.

In an embodiment, the powder grains 3002 that are deposited between the ridges of the V-shaped grooves 3001 are not melted or fused together during the 3D printing process. In this embodiment, the V-shaped grooves may provide enough friction to prevent the 3D part from sliding on the build platform during the 3D printing process, without melting and fusing together the powder grains 3002 that are between the ridges of the V-shaped grooves 3001. After the 3D printing process is complete, the 3D part can be removed from the build platform without having to cut the 3D part off of the build platform, because the 3D part is not fused to the build platform in this embodiment.

The following numbered supplementary notes relevant to the embodiments described so far are further disclosed.

### Supplementary Note 108

A support surface member comprising a support surface on which a shaping object is shaped by a shaping apparatus, wherein

a shaping material from a material supply device of the shaping apparatus is supplied to the support surface, and

the support surface is non-flat.

### Supplementary Note 109

The support surface member of Supplementary note 108, wherein

the support surface is moved, by the shaping apparatus, within a plane substantially parallel to the support surface.

### Supplementary Note 110

The support surface member of Supplementary note 109, wherein a groove is formed on the face of the support surface.

### Supplementary Note 111

The support surface member of Supplementary note 110, wherein

a plurality of the grooves are formed on the face of the support surface.

### Supplementary Note 112

The support surface member of Supplementary note 111, wherein

the support surface is moved in a movement direction within a plane substantially parallel to the support surface, and

the plurality of grooves lie side by side in a direction intersecting with the movement direction.

### Supplementary Note 113

The support surface member of Supplementary note 111, wherein the support surface is moved in a movement direction within a plane substantially parallel to the support surface,

the movement direction is a rotation direction with an axis serving as a center, and

the plurality of grooves lie side by side in a direction directed outwardly from the axis.

### Supplementary Note 114

The support surface member of Supplementary note 110, wherein

the groove formed on the support surface extends in a circumferential direction with one point on the support surface serving as a center.

### Supplementary Note 115

A shaping apparatus to shape a shaping object on a support surface, the apparatus comprising:

a material supply device that supplies a shaping material onto the support surface;

a beam irradiation device that irradiates the shaping material on the support surface with an energy beam;

a support member that supports a support surface member having the support surface; a movement device that moves the support member in a direction substantially parallel to the support surface; and

a plate member provided around the support member and has a surface parallel to the support surface.

### Supplementary Note 116

The shaping apparatus of Supplementary note 115, wherein the surface of the plate member is moved in the direction.

### Supplementary Note 117

The shaping apparatus of Supplementary note 116, wherein the surface of the plate member is non-flat.

### Supplementary Note 118

The shaping apparatus of Supplementary note 117, wherein

a groove is formed on the surface of the plate member.

### Supplementary Note 119

The shaping apparatus of Supplementary note 118, wherein

a plurality of the grooves are formed on the surface, parallel to the support surface, of the plate member.

### Supplementary Note 120

The shaping apparatus of Supplementary note 119, wherein the plurality of the grooves lie side by side in a direction intersecting with the direction.

### Supplementary Note 121

The shaping apparatus of Supplementary note 119, wherein

the direction is a rotation direction with an axis serving as a center, and

the plurality of grooves lie side by side in a direction directed outwardly from the axis.

### Supplementary Note 122

The shaping apparatus of Supplementary note 118, wherein

the movement direction is a rotation direction with an axis serving as a center, and

the groove extends in a circumferential direction with the axis serving as a center.

### Supplementary Note 123

The shaping apparatus of Supplementary note 115, wherein

the support surface has a circular shape.

### Supplementary Note 124

The shaping apparatus of Supplementary note 123, wherein

the direction is a rotation direction with a first axis serving as a center.

### Supplementary Note 125

The shaping apparatus of Supplementary note 124, wherein

the support member rotates with a second axis serving as a center, the second axis being different from the first axis.

### Supplementary Note 126

The shaping apparatus of Supplementary note 125 wherein

the support surface has a circular outer shape, and

a center of the outer shape coincides with the second axis.

### Seventh Embodiment

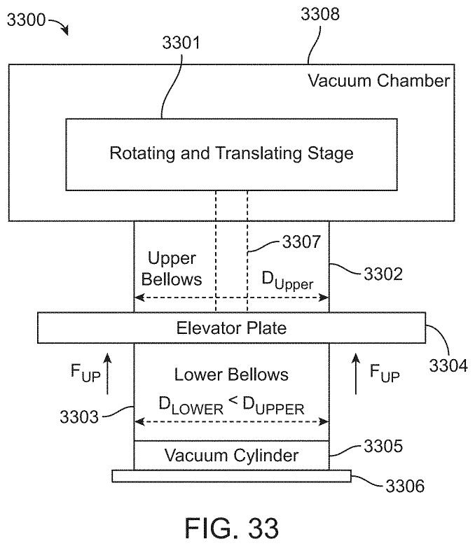

FIG. 31 illustrates a cross-sectional view of another example of a circular build platform configured to support a 3D part built on a processing machine as disclosed herein. The build platform 3100 of FIG. 31 may be, for example, a main rotary turntable or a rotary build platform, as disclosed herein for example, with respect to FIGS. 26A and 27A-27B. In the embodiment of FIG. 31, build platform 3100 has a sidewall 3101 around the circumference of the circular build platform and a recess 3103 between the sidewall 3101. One or more layers 3110 of powder are deposited within the recess 3103 of the build platform 3100 during the formation of a 3D part during the 3D printing process performed by the 3D printer.

### Eighth Embodiment

In some embodiments, 3D parts are built in a vacuum chamber on a rotating support table that is rotated by a moving mechanical assembly. In these embodiments, in order to manage potentially large vacuum forces acting on the moving mechanical assembly, techniques are disclosed that employ the use of flexible bellows configured to connect or couple the moving mechanical assembly to the vacuum chamber. According to further embodiments, techniques are provided that mitigate or eliminate the effects of differential vacuum pressure on an elevator plate configured to support the mechanical assembly and vertical actuators configured to provide movement to the mechanical assembly in a processing machine such as a 3D printer by providing a configuration of bellows that reduce or cancel the pressure-differential forces. These embodiments have an advantage of reducing the variance in the loads on the vertical actuators, which in turn can reduce the load requirements, the cost, and the size of the vertical actuators.

In some embodiments, a processing machine for building a part includes a mechanical assembly comprising a rotating support table configured to rotate about a first axis. The rotating support table is configured to operate in a vacuum chamber. The processing machine further comprises a powder supply assembly that distributes powder onto the rotating support table to form a powder layer and an energy system that directs an energy beam at a portion of the powder on the rotating support table to form a portion of the part being built. The processing machine also includes a mechanism for moving the rotating support table as the part is being built.

In some embodiments, the mechanism for moving the rotating support table comprises a shaft configured to couple both rotational and translational motion from one or more actuators to the rotating support table. In some cases, the translational motion comprises lowering a position of the rotating support table to accommodate a new build layer of powder as the part is being built. In some instances, the one or more actuators are mounted or coupled to an elevator plate, the elevator plate supporting the mechanical assembly and configured to translate vertically to accommodate build layers of the part being built.

In some embodiments, a region above the elevator plate is maintained in vacuum as the part is being built and one or more bellows maintain a vacuum pressure while allowing for vertical motion of the elevator plate and the rotating build platform. In some cases, the one or more bellows are configured to control a differential load seen by the one or more actuators. The differential load can be caused by a vacuum differential due to a difference in pressure in a region above the elevator plate and a region below the elevator plate.

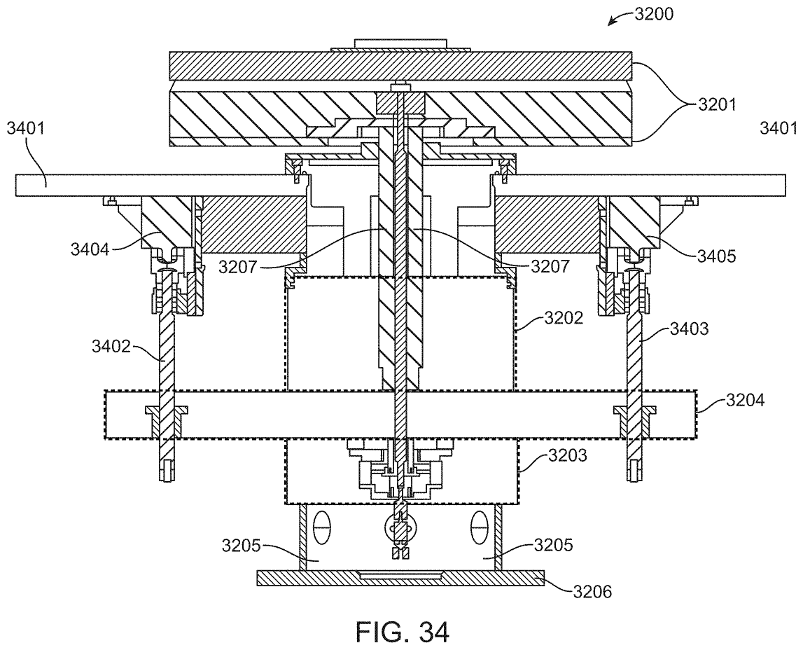

FIGS. 32A-32B illustrate an example of a processing machine, in this case, a 3D printer 3200, having two symmetrical bellows with equal effective area between an elevator plate, according to an embodiment. In particular, as described in more detail below, FIG. 32A depicts the 3D printer wherein the elevator plate is at its highest position during a build process, while FIG. 32B depicts the 3D printer wherein the elevator plate is at its lowest position during a build process.

As shown in FIGS. 32A-32B, 3D printer 3200 includes a rotating and translating stage 3201, an upper bellows 3202, a lower bellows 3203, an elevator plate 3204, a vacuum cylinder 3205, a base 3206, and a rotating shaft 3207. In the embodiment of FIGS. 32A-32B, the rotating and translating stage 3201 is disposed in a vacuum chamber 3208 and includes a rotating support table, in this case, a main rotary turntable (MRT). Stage 3201 may also include one or more secondary support tables or rotary build platforms. For example, one or more build parts may sit on the surface of the MRT or the top of one or more RBPs, as disclosed in further detail herein. The MRT may rotate at a desired rate. As an example, in a preferable embodiment, the MRT rotates at approximately 3.5 revolutions per minute. As described herein, the MRT may rotate clockwise or counter-clockwise continuously or intermittently. In some embodiments, at every full rotation, the MRT drops by a small distance (e.g., approximately 100 micrometers) to accommodate a new build layer for a 3D build part.

The rotating and translating stage 3201 typically operates at very high temperatures (e.g., in excess of 500° C.) and in vacuum (e.g., in a vacuum chamber 3208). A stiff, rotating shaft 3207 provides both rotation and translation to the MRT in the rotating and translating stage 3201. In the example shown, the elevator plate 3204 supports the mass of the rotating and translating stage 3201. Additionally, the elevator plate 3204 translates vertically to accommodate the build layers of the growing build part. For example, the elevator plate 3204 enables the shaft 3207 and the rotating and translating stage 3201 to move down by a small amount with each additional build layer added to the 3D build part. In this case, a region above the elevator plate 3204 including the rotating and translating stage 3201 are in vacuum (e.g., in a vacuum chamber 3208). According to techniques as disclosed herein, one or more bellows are used to maintain vacuum pressure, while still allowing for vertical motion of the elevator plate 3204 and the rotating and translating stage 3201.

If there were only a single bellows disposed above the elevator plate 3204, a vacuum differential would be generated across the elevator plate 3204. In particular, a vacuum differential would be created due to a vacuum that exists above the elevator plate 3204 and atmospheric pressure that exists below the elevator plate 3204. This differential load across the elevator plate 3204 creates a large upward force when the 3D printer is pumped down, and no force when the 3D printer is brought back up to atmospheric pressure. Accordingly, a configuration that consists of a single bellows disposed above the elevator plate can result in a large variance in the force experienced by the actuators that move the elevator plate 3204, wherein the variance is caused by a large upward force in the vacuum from air pressure and a large downward force in atmospheric pressure from the weight of the 3D printing system. This large variance in force is undesirable, because it requires much larger actuators and undesirable operating conditions for operating the 3D printer as disclosed herein.

To address this variance problem and to control this differential load, in some embodiments, as shown in FIGS. 32A-32B, a configuration of the one or more bellows comprises an upper bellows disposed above the elevator plate and a lower bellows disposed below the elevator plate, the upper bellows and the lower bellows being configured to reciprocate in order to accommodate a vertical motion of the elevator plate. In some embodiments, an effective area of the inner chambers of the upper bellows and an effective area of the inner chambers of the lower bellows when are about equal.

In some cases, the processing machine includes a rigid plate above the upper bellows. The rigid plate is a structural plate forming a bottom wall of the build vacuum chamber and provides a structure on which other mechanical components can be mounted (e.g., the rigid plate can hold air rotational bearings for the shaft 3207). One function of the rigid plate is to allow the entire stage or mechanical assembly to be removed from the vacuum chamber to be serviced. The rigid plate also serves as a main structural base of the entire stage and provides a reference for locating the stage relative to the rest of the 3D printer system. In addition to providing mechanical support for the shaft, the rigid plate acts as a seal for the air bearings to prevent the air evacuated from the bearings from reaching the main build chamber.

In some embodiments, a reciprocating motion of the upper bellows and lower bellows reduces the differential load on the elevator plate. In particular, the reciprocating motion of the upper bellows and lower bellows can allow for the elevator plate to translate vertically while maintaining vacuum pressure above and below the elevator plate, including by: compressing the upper bellows and extending the lower bellows at a first vertical position of the elevator plate at the top of a stroke; and extending the upper bellows and contracting the lower bellows as the elevator plate translates downward. In some instances, the upper bellows is fully compressed and the lower bellows is fully extended at the first vertical position of the elevator plate at the top of the stroke and the upper bellows is fully extended and the lower bellows is not fully compressed at a second vertical position of the elevator plate at the bottom of the stroke. Here, a stroke refers to actuator movement over its range of motion. In this case, a stroke is the range in which the actuator is utilized to sufficiently raise and lower the build platform/elevator plate.

The exemplary embodiment described with respect to FIGS. 32A-32B shows a second bellows 3203 disposed below the elevator plate 3204. In the embodiment of FIGS. 32A-32B, an upper bellows 3202 is provided above the elevator plate 3204, and a lower bellows 3203 is provided below the elevator plate 3204, such that the elevator plate 3204 is between the two bellows 3202-3203. Importantly, there are holes (not shown) in elevator plate 3204 that ensure equal air (or vacuum) pressure inside both bellows 3202-3203. As mentioned above, the top portion of upper bellows 3202 is attached to the bottom of a fixed vacuum chamber 3208. The bottom of lower bellows 3203 is attached to optional vacuum cylinder 3205 and base 3206, which are rigidly connected (by elements not shown in the FIGS. 32A, 32B) to the vacuum chamber. In this way, motion of the elevator plate does not change the volume of the vacuum environment and therefore there is substantially no air pressure vertical force on the elevator plate.

The elevator plate 3204 is connected to each of the bellows 3202 and 3203. In this case, bellows 3202 and 3203 are flexible hollow cylindrically shaped tubes. In some examples, bellows 3202-3203 have thin walls. In the example of FIGS. 32A-32B, bellows 3202-3203 are two symmetrical bellows having an equal effective area. In particular, in this case, the diameter Dᵤₚₚₑᵣ of the upper bellows 3202 is equal to the diameter M_{lower} of the lower bellows 3203, as shown in FIGS. 32A-32B.

In some embodiments, the upper bellows and lower bellows are further configured in fluid communication to the chamber (e.g., a vacuum chamber) containing the rotating support table such that the same atmosphere or vacuum pressure of the chamber exists inside both bellows 3202 and 3023. In some instances, inner chambers of the upper bellows and inner chambers of the lower bellows are configured to support a vacuum. In some cases, a vacuum cylinder is mounted below the lower bellows and the processing machine further comprises a base, the vacuum cylinder being disposed on the base. In these cases, the inner chamber of the upper bellows is open to a vacuum chamber containing the rotating support table, and the inner chamber of the lower bellows is evacuated by a separate vacuum source from the vacuum chamber. In other embodiments, the elevator plate does not allow fluid communication between the two bellows 3202 and 3203. In these embodiments, a separate pump removes air from inside lower bellows 3203. A base vacuum pressure is maintained in lower bellows 3203 from that within upper bellows 3202 which shares the same atmosphere as the vacuum chamber 3208 enclosing the rotating and translating stage 3201. This base vacuum pressure may be slightly different from the chamber vacuum pressure, but the difference is small enough to avoid unwanted air pressure forces acting on the elevator plate 3204. The base vacuum exists in the lower bellows and is separate and distinct from the vacuum chamber 3208 containing the rotating support table, which has its own pumping mechanism.

For instance, returning to the example shown in FIGS. 32A-32B, the inner chambers of each of the bellows 3202-3203 are in vacuum, while a build part is being built in the 3D printer 3200. In this case, the pressure inside the inner chambers of the bellows 3202-3203 and the pressure inside the rotating and translating stage 3201 are reduced to a vacuum using one or more vacuum pumps. When the inner chambers of the bellows 3202-3203 are in vacuum, the bellows 3202-3203 effectively cancel the atmospheric pressure loads on the elevator plate 3204. Due to the configuration of the bellows in the example shown, the elevator plate 3204 only needs to support the weight of the rotating and translating stage 3201 and the rotating shaft 3207, regardless of whether the 3D printer 3200 is in a vacuum or in atmospheric pressure.

In order to accommodate the vertical motion of the elevator plate 3204, the two bellows 3202 and 3203 are configured to reciprocate, as shown in FIGS. 32A-32B. In particular, bellows 3202 and 3203 can be extended in length and compressed in length as the elevator plate 3204 moves vertically. In FIG. 32A, the elevator plate 3204 is at its highest position when the 3D printing build process begins, the upper bellows 3202 is fully compressed, and the lower bellows 3203 is fully extended. As the elevator plate 3204 translates downward to accommodate additional layers added to the build part, the upper bellows 3202 extends in length, while the lower bellows 3203 contracts in length. In FIG. 32B, the elevator plate 3204 is at its lowest position at the end of the 3D printing build process, the lower bellows 3203 is fully compressed, and the upper bellows 3202 is fully extended. This reciprocation of the bellows 3202-3203 allows for the elevator plate 3204 to translate vertically, while still maintaining a vacuum pressure above and below the elevator plate 3204 within the bellows 3202-3203.

In some embodiments, the upper bellows and the lower bellows comprise flexible, hollow, cylindrically shaped tubes. In some cases, a diameter of the upper bellows is about the same as a diameter of the lower bellows (e.g., as shown in FIGS. 32A-32B). In other cases, a diameter of the upper bellows is different than a diameter of the lower bellows. In an exemplary embodiment as discussed in further detail below, a diameter of the upper bellows is larger than a diameter of the lower bellows.

For example, in some cases, air pressure loads may be used to cancel the weight of the 3D printer to reduce the load on actuators in the 3D printer that are in vacuum. In these embodiments, it may be advantageous to undersize the lower bellows in the 3D printer relative to the upper bellows, such that there is a net upward force on the elevator plate.

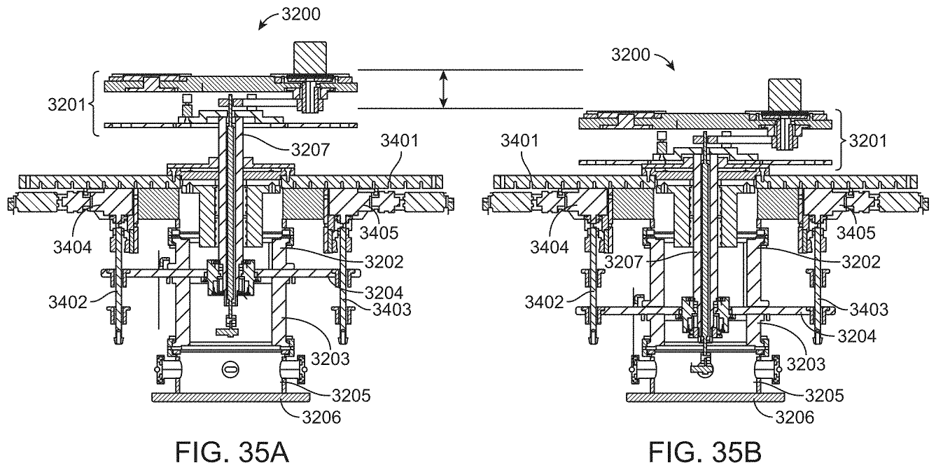

FIG. 33 illustrates an example of a processing machine having two bellows with different diameters above and below an elevator plate, according to an embodiment. In the example shown, the processing machine is 3D printer 3300 comprising a rotating and translating stage 3301, an upper bellows 3302, a lower bellows 3303, an elevator plate 3304, a vacuum cylinder 3305, a base 3306, and a rotating shaft 3307. In the embodiment of FIG. 33, the rotating and translating stage 3301 is disposed in a vacuum chamber 3308 and includes a rotating support table, in this case, a main rotary turntable (MRT) and may also include one or more secondary support tables (e.g., rotary build platforms). One or more build parts may sit on the surface of the MRT or a surface of one or more RBPs, as disclosed in further detail herein. The MRT may rotate clockwise or counter-clockwise continuously or intermittently. In some embodiments, every full rotation, the MRT drops by a small distance to accommodate a new build layer for the 3D build part. Rotating shaft 3307 provides both rotation and translation to the MRT in the rotating and translating stage 3301.

In the embodiment of FIG. 33, an upper bellows 3302 is provided above the elevator plate 3304, and a lower bellows 3303 is provided below the elevator plate 3304, such that the elevator plate 3304 is between bellows 3302-3303. Elevator plate 3304 is connected to each of the bellows 3302 and 3303. In this case, bellows 3302 and 3303 are flexible hollow cylindrically shaped tubes. In the embodiment of FIG. 33, the upper bellows 3302 has a larger diameter and a larger area than the lower bellows 3303. As shown in FIG. 33, the diameter Dᵤₚₚₑᵣ of upper bellows 3302 is greater than the diameter M_{lower} of the lower bellows 3303, such that M_{lower}<Dᵤₚₚₑᵣ. The degree of vacuum inside the upper bellows 3202 may be different from the degree of vacuum inside the lower bellows 3203.

The vacuum chamber 3308 enclosing rotating and translating stage 3301 and the inner chambers of each of the two bellows 3302-3303 are in vacuum, while a build part is being built in the 3D printer 3300.

When the inner chambers of the bellows 3302-3303 are in vacuum, a net upward force F_{UP} is applied to the elevator plate 3304, because the lower bellows 3303 is smaller than the upper bellows 3302. The net upward force F_{UP} is indicated by the arrows in FIG. 33. The net upward force F_{UP} may reduce or fully cancel the weight of the rotating and translating stage 3301 using air pressure, if the differential areas between the upper and lower bellows 3302-3303 are carefully controlled. The net upward force F_{UP} may reduce the load on the vertical actuators that move the elevator plate 3304 vertically.

As in the case of the embodiment shown in FIGS. 32A-32B, bellows 3302-3303 reciprocate in order to accommodate a vertical motion of the elevator plate 3304. Bellows 3302 and 3303 are extended and compressed in length as the elevator plate 3304 moves vertically. As the elevator plate 3304 translates downward to accommodate additional layers added to the build part, the upper bellows 3302 extends in length, while the lower bellows 3303 contracts in length. This reciprocation of the bellows 3302-3303 allows for the elevator plate 3304 to translate down, while still maintaining a vacuum pressure above and below the elevator plate 3304 within the bellows 3302-3303.

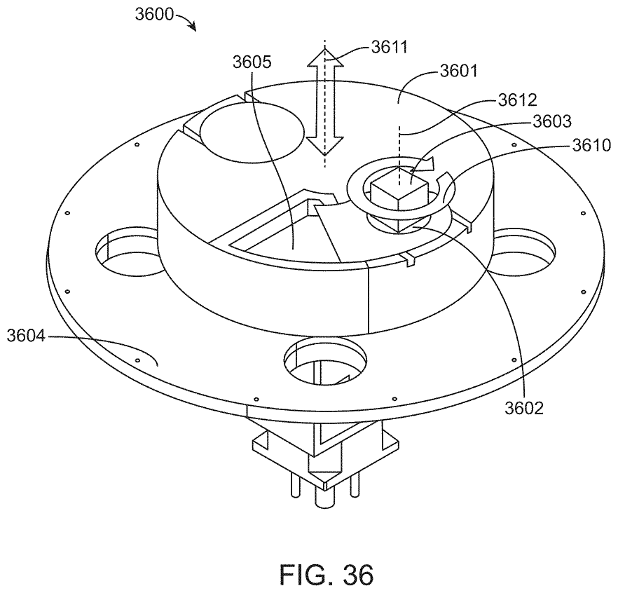

FIG. 34 illustrates a cross-sectional view showing further details of the processing machine (e.g., 3D printer 3200) depicted in FIGS. 32A-32B, according to an embodiment. In the embodiment of FIG. 34, 3D printer 3200 further includes a rigid plate 3401, two vertical actuators 3402 and 3403, two motors 3404 and 3405, and additional components 3201-3207 shown in FIGS. 32A-32B. The vertical actuators 3402-3403 are mounted in elevator plate 3204, as shown in FIG. 34. In this case, the vertical actuators 3402-3403 are configured to move the elevator plate 3204 vertically during the process of building one or more 3D parts in stage 3201. The vertical movement of the elevator plate 3204 is disclosed herein with respect FIGS. 32A-32B. In the example shown, the vertical actuators 3402-3403 do not rotate during the build process.

In this example, the vertical actuators 3402 and 3403 are attached to motors 3404 and 3405, respectively. The motors 3404-3405 are attached to plate 3401. Motors 3404 and 3405 drive the vertical movement of the vertical actuators 3402 and 3403, respectively, which in turn drive the vertical movement of the elevator plate 3204.

Because the rotating and translating stage 3201 operates at very high temperatures (e.g., in excess of 500° C.) and in vacuum, in a preferable embodiment, the vertical actuators 3402 and 3403 driving the motion of the stage 3201 are placed in a position away from the stage 3201 and the build part. As an example, in the embodiment of FIG. 34, the vertical actuators 3402-3403 are placed far below the stage 3201. In this case, the motion from the vertical actuators 3402-3403 is coupled to the stage 3201 via the elevator plate 3204 and rotating shaft 3207.

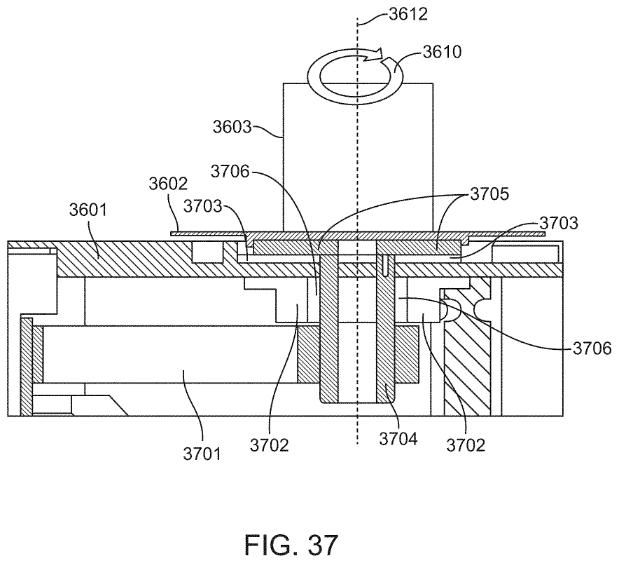

FIGS. 35A-35B illustrate cross-sectional views showing further details of the processing machine (e.g., 3D printer 3200) depicted in FIGS. 32A-32B and FIG. 34 with the bellows 3202 and 3203 extended and compressed in two different configurations, according to an embodiment. In particular, as described in more detail below, FIG. 35A depicts a cross-sectional view of the processing machine wherein the elevator plate at its highest position during a build process, while FIG. 35B depicts a cross-sectional view of the processing machine of FIG. 35A wherein the elevator plate at its lowest position during a build process.

Bellows 3202 and 3203 reciprocate in response to the vertical motion of the elevator plate 3204 caused by the vertical actuators 3402-3403 and the motors 3404-3405. In FIG. 35A, the vertical actuators 3402-3403 and the motors 3404-3405 have moved the elevator plate 3204 and the rotating shaft 3207 to their highest position when the 3D printing build process begins (e.g., at the top of a stroke), causing the upper bellows 3202 to be fully compressed and the lower bellows 3203 to be fully extended. In FIG. 35B, the vertical actuators 3402-3403 and the motors 3404-3405 have moved the elevator plate 3204 and the rotating shaft 3207 to their lowest position at the end of the 3D printing build process (e.g., at the bottom of the stroke), causing the lower bellows 3203 to be fully compressed and the upper bellows 3202 to be fully extended.

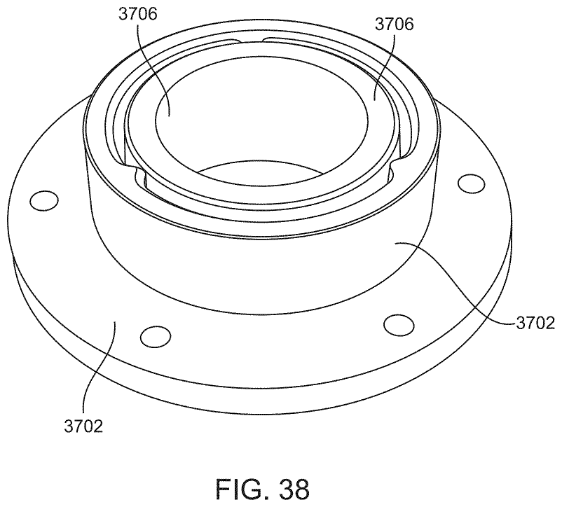

FIG. 36 illustrates an example of a rotating and translating stage 3600 for a processing machine (e.g., 3D printer) from a top perspective, according to an embodiment. The rotating and translating stage 3600 includes a rotating support table, in this case, main rotary turntable (MRT) 3601, a removable secondary support table, in this case, rotary build platform (RBP) 3602, a lower turntable 3604, and powder collection bin 3605. The 3D printer of FIG. 36 builds a 3D part 3603 on RBP 3602 during the 3D printing process. During the 3D printing process, the MRT 3601 and lower turntable 3604 are rotated around and translated vertically along their center axis 3611. The RBP 3602 is also translated vertically with MRT 3601 along the center axis 3611 and rotated around its center axis 3612 continuously, intermittently, or in one or more discrete steps. MRT 3601, turntable 3604, and RBP 3602 may rotate clockwise or counterclockwise. In an exemplary embodiment, RBP 3602 rotates opposite direction of MRT 3601 such as clockwise, which causes the build part 3603 to rotate clockwise as shown by the arrow 3610 when the MRT 3601 rotates counterclockwise. The collection bin 3605 is a cavity below MRT 3601 that is used to collect excess powder from RBP 3602, as discussed herein with respect to FIGS. 28 and 29A-29B. Unlike RBPs 2811, 2812 in FIG. 28 and RBPs 2911-2913 in FIG. 29A-29B, the translating stage 3600 does not include cylinders such as cylinders 2805, 2931-2933, and therefore RBP 3602 is not connected cylinder. The parts shown in FIG. 36 may, for example, be part of the rotating and translating stages 3201/3301 disclosed in previous embodiments herein.

The RBP 3602 rotates clockwise or counterclockwise relative to the rotation of the MRT 3601. For this reason, the RBP 3602 is supported via rotational bearings. As discussed above, the rotary build platforms, such as RBP 3602, may be exposed to temperatures in excess of 500 ° C. during the 3D printing process of building a 3D part, such as part 3603. Therefore, according to further embodiments, graphite bearings or bushings that can support the rotation of the rotary build platform are provided for use in the 3D printer. The graphite bearings or bushings disclosed herein can maintain structural integrity at a temperature of up to 870° C.

Accordingly, in some embodiments, a processing machine for building a part includes a mechanical assembly comprising a rotating support table configured to rotate about a first axis. The rotating support table is configured to operate in a vacuum chamber. The processing machine further comprises a powder supply assembly that distributes powder onto the rotating support table to form a powder layer and an energy system that directs an energy beam at a portion of the powder on the rotating support table to form a portion of the part being built. The processing machine also includes a mechanism for moving the rotating support table as the part is being built.

In some embodiments, the mechanism for moving the rotating support table comprises a shaft configured to couple both rotational and translational motion from one or more actuators to the rotating support table. In some cases, the translational motion comprises lowering a position of the rotating support table to accommodate a new build layer of powder as the part is being built. In some instances, the one or more actuators are mounted or coupled to an elevator plate, the elevator plate supporting the mechanical assembly and configured to translate vertically to accommodate build layers of the part being built.

In some cases, the processing machine further comprises a cylindrical bearing around a portion of the shaft, wherein the cylindrical bearing is configured to support rotary motion at high temperatures, and the shaft is configured to rotate a flange and the rotating support table. As an example, in some embodiments, the cylindrical bearing comprises graphite and is configured to support rotary motion at temperatures in a range between about 300 degrees Celsius to about 1000 degrees Celsius, preferably in a range between about 300 degrees Celsius and about 600 degrees Celsius, more preferably in a range between about 400 degrees Celsius and about 550 degrees Celsius, and in some cases, in a range exceeding about 600 degrees Celsius, exceeding about 700 degrees Celsius, exceeding about 800 degrees Celsius, or exceeding about 900 degrees Celsius.

In some embodiments, a thrust bearing disposed between a flange and the rotating support table, wherein the thrust bearing is configured to support rotary motion at high temperatures. In addition to rotary motion, the thrust bearing also supports the weight of the payload (e.g. rotational and axial loads).

As an example, in some embodiments, the thrust bearing comprises graphite and is configured to support rotary motion at temperatures in a range between about 300 degrees Celsius to about 1000 degrees Celsius, preferably in a range between about 300 degrees Celsius and about 600 degrees Celsius, more preferably in a range between about 400 degrees Celsius and about 550 degrees Celsius, and in some cases, in a range exceeding about 600 degrees Celsius, exceeding about 700 degrees Celsius, exceeding about 800 degrees Celsius, or exceeding about 900 degrees Celsius.

In some embodiments, a bearing housing is disposed around the cylindrical bearing, the bearing housing being configured to support the cylindrical bearing at high temperatures. As an example, in some embodiments, the bearing housing comprises aluminum oxide and is configured to withstand temperatures in a range between about 300 degrees Celsius to about 1000 degrees Celsius, preferably in a range between about 300 degrees Celsius and about 600 degrees Celsius, more preferably in a range between about 400 degrees Celsius and about 550 degrees Celsius, and in some cases, in a range exceeding about 600 degrees Celsius, exceeding about 700 degrees Celsius, exceeding about 800 degrees Celsius, or exceeding about 900 degrees Celsius.

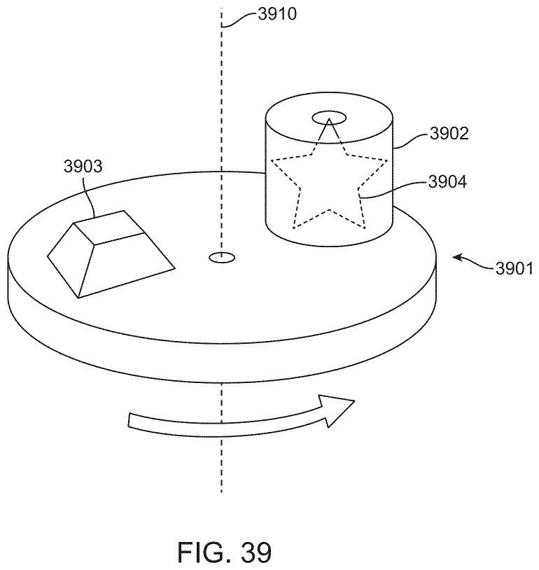

FIG. 37 illustrates a cross-sectional view of the exemplary rotating build platform of FIG. 36 and related components. FIG. 37 shows portions of the rotating and translating stage 3600 in cross section including MRT 3601, RBP 3602, high temperature steel belt and pulley 3701, high temperature bearing housing 3702, high temperature thrust bearing 3703, rotation shaft 3704, flange 3705 (e.g. support table), and high temperature cylindrical bearing 3706. FIG. 37 also shows build part 3603, RBP axis of rotation 3612, and an exemplary rotation direction 3610 for build part 3603. RBP 3602 is detachably placed on flange (support table) 3705 and removable from the assembly shown in FIGS. 36-37. Flange 3705 is attached to the top of rotation shaft 3704. High temperature steel belt and pulley 3701 rotate the rotation shaft 3704 and flange 3705. RBP 3602 sits on top of flange 3705. Therefore, the rotation of shaft 3704 and flange 3705 rotates RBP 3602 and the build part 3603. The flange 3705 sits on top of high temperature thrust bearing 3703. The thrust bearing 3703 sits in a recessed portion of MRT 3601. Thrust bearing 3703 and flange 3705 may, for example, be disk-shaped.

The operating temperature of the rotating and translating stage 3600 during the 3D printing process may be high enough (e.g., in excess of 500° C.) to damage standard rotary bearings. Therefore, a different bearing material is needed for use in the high temperature environment of stage 3600. According to an embodiment, graphite is used as the material to form the bearings that are used in the high temperature environment of stage 3600. Graphite is a naturally lubricious material that is also highly resistant to high temperatures and is vacuum compatible. Therefore, graphite is ideal for use in the high temperature environment of stage 3600.

According to some embodiments, the high temperature thrust bearing 3703 and the high temperature cylindrical bearing 3706 in stage 3600 are made of graphite. In these embodiments, the high temperature thrust bearing 3703 and the high temperature cylindrical bearing 3706 may be graphite plain bushings. In a more specific embodiment, bearings 3703 and 3706 may be made of copper impregnated graphite. Bearing 3703 may be a graphite disk, and bearing 3706 may be a graphite cylinder. The graphite bearings or bushings 3703 and 3706 can be used to support rotary motion in a vacuum and at high temperatures without deforming. Graphite has a higher operating temperature in a vacuum than it does in atmospheric pressure.

In addition, the graphite bearings or bushings 3703 and 3706 are electrically conductive and can sink charge that builds up on the rotary build platform 3602 from an electron beam used to irradiate part 3603 during the 3D printing process. Also, the graphite bearings or bushings 3703 and 3706 have a high thermal contact area and are compliant. Cylindrical bearing 3706 may conform to the stiffer rotation shaft 3704 that is rotating relative to bearing 3706, and thrust bearing 3703 may conform to flange 3705. As a result, the graphite bearings or bushings 3703 and 3706 have large contact areas that can sink heat building up in stage 3600. In addition, graphite also has the advantage of being an inexpensive material.

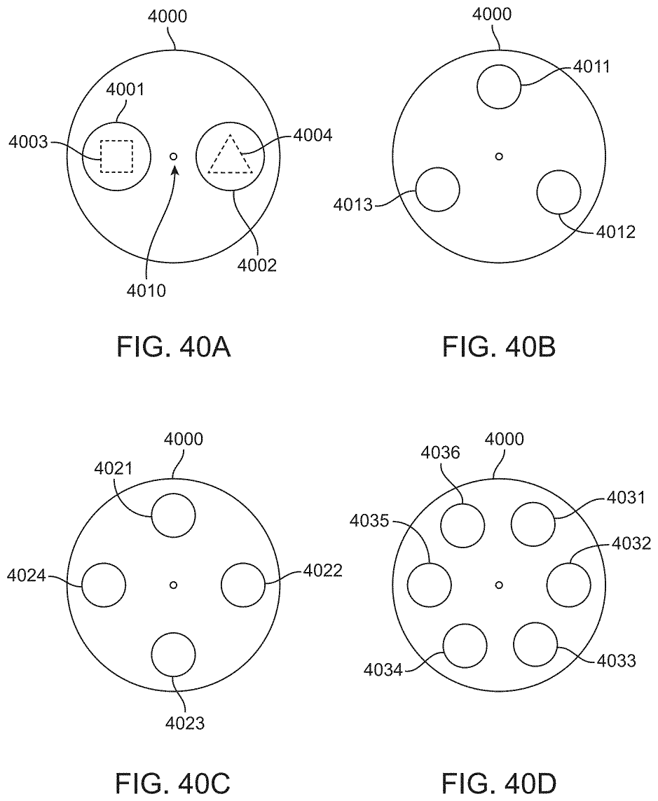

FIG. 38 illustrates further details of bearing or bushing structures shown in FIG. 37. In particular, FIG. 38 shows the high temperature bearing housing 3702 and the high temperature cylindrical bearing or bushing 3706 of FIG. 37 before these bearings or bushings have been placed in the rotating and translating stage 3600 of the 3D printer, so that the details of bearings or bushings 3702 and 3706 can be viewed more clearly. In the embodiment of FIG. 38, the high temperature bearing housing 3702 is a housing that is made of alumina ceramic (i.e., aluminum oxide). Bearing housing 3702 functions as a support flange for assembling the rotating assembly of FIG. 37. High temperature cylindrical bearing 3706 of FIG. 38 is made of graphite, as discussed above with respect to FIG. 37.

### Ninth Embodiment

As a 3D part (e.g., 3D part 3603) is built by a processing machine as disclosed herein, for example, a 3D printer, the mass of the turntable changes, creating an imbalance that will affect the performance and accuracy of the 3D printing process. Such an imbalance is particularly problematic when printing large metal 3D parts. To address this issue, according to further embodiments, a counterbalance part or mechanism is placed on the turntable to reduce the imbalance effect. The following embodiments address this problem of maintaining the balance of a rotary and translating stage system for a 3D printer by providing a counterbalance mechanism to the mass of the 3D part being built by the 3D printer. Several of these embodiments are disclosed as follows.

In some embodiments, a system for 3D printing includes a rotating support table configured to rotate about a first axis and one or more secondary support tables. The one or more secondary support tables rotate with the rotating support table and the one or more secondary support tables rotate around non-coaxial secondary axes. A powder supply assembly distributes powder onto the one or more secondary support tables to form a powder layer. Each of the one or more secondary support tables is configured to support an object being built. An energy system directs an energy beam at a portion of the powder on the one or more secondary support tables to form a portion of the object being built on each of the secondary support tables. To address the problem of maintaining the balance of the system, a counterbalance mechanism is configured to counterbalance a weight of the object being built on each of the secondary support tables.

In some embodiments, a processing machine for building a part as disclosed herein includes a rotating support table configured to rotate about a first axis. The rotating support table comprises a secondary support table. The secondary support table is configured to rotate with the rotating support table and the secondary support table is configured to rotate around a non-coaxial secondary axis. Additionally, in some cases, the processing machine comprises a powder supply assembly that distributes powder onto the secondary support table to form a powder layer. In some examples, as discussed in more detail herein, the powder supply assembly comprises a material supply device or powder supply device. The processing machine also comprises an energy system that directs an energy beam at a portion of the powder on the secondary support table to form a portion of the part being built. In some embodiments, the energy system comprises an irradiation device. Finally, the processing machine includes a counterbalance mechanism configured to counterbalance at least a portion of a weight of the part being built on the secondary support table.

In some instances, the part being built comprises a three-dimensional (3D) object built from powder, the rotating support table comprises a rotary turntable (e.g., a main rotary turntable), and the secondary support table comprises a build platform configured to support the part being built. In these cases, the build platform is configured to rotate around the non-coaxial secondary axis.

In some embodiments, the rotating support table and the secondary support table are configured to rotate in a same rotational direction. In other embodiments, the rotating support table is configured to rotate about the first axis in a first rotational direction and wherein the secondary support table is configured to rotate around the non-coaxial secondary axis in a rotational direction counter to the first rotational direction.

In some embodiments, the counterbalance mechanism comprises a counterweight disposed on the rotating support table in a position that counterbalances at least a portion of the weight of the part being built.

In the case of building a plurality of parts simultaneously, the secondary support table comprises a plurality of build platforms, each build platform being configured to rotate around its own non-coaxial secondary axis. Additionally, each build platform is configured to support one of the plurality of parts being built in parallel as layers of powder are distributed on each build platform. In some embodiments, the rotary turntable and each of the build platforms are configured to rotate in a same rotational direction, while in other embodiments, the rotary turntable is configured to rotate about the first axis in a first rotational direction and the build platforms are each configured to rotate around their own non-coaxial secondary axes in a second rotational direction opposite or counter to the first rotational direction. Additionally, each build platform in the plurality of build platforms is configured to rotate independently around its own non-coaxial secondary axis, and can therefore rotate in any direction (e.g., in the same or different directions as the rotary turntable, or in the same or different directions as any of the other build platforms).

In the case of building a plurality of parts simultaneously, each part on one of a plurality of build platforms, in some embodiments the counterbalance mechanism comprises a counterweight disposed on the rotary turntable in a position that counterbalances at least a portion of the weight of the parts being built on each build platform.

In some embodiments, the counterweight has a fixed mass. In some cases, such as the cases discussed below, the counterweight has a fixed mass of about half the mass of a finished part.

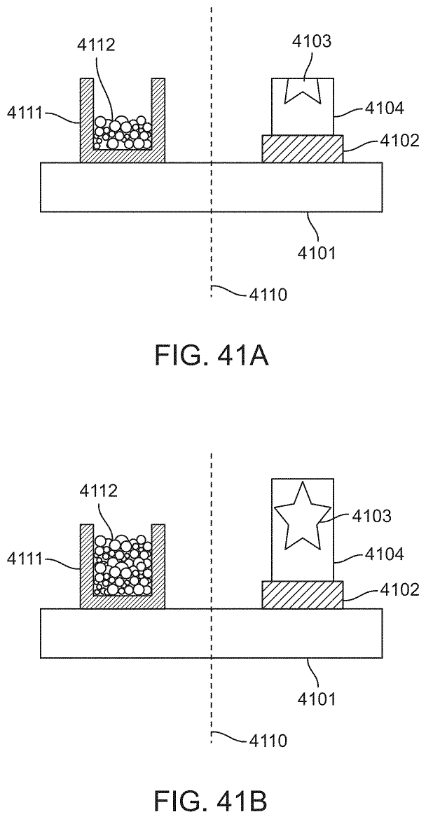

FIG. 39 illustrates an example of a processing machine having a rotating support table and a counterweight for reducing an imbalance on the rotating support table. In some embodiments, the processing machine includes a main rotary turntable and a secondary support table or build platform disposed on the main rotary turntable. A counterweight can be positioned or disposed on an opposing side of the main rotary turntable, opposite the build platform and the part that is being built. In some cases, the counterweight has a fixed mass, which can be about half the mass of a finished build part to reduce an imbalance on the main rotary turntable, according to an embodiment.

FIG. 39 shows a rotating support table (e.g., turntable 3901), a powder cake 3902 (e.g., wherein a powder cake comprises powder buildup, potentially sintered, around the part being built), a counterweight 3903, and a build part 3904 that is formed inside the powder cake 3902. Turntable 3901 is rotated around axis 3910 in the counterclockwise direction during the 3D printing process, as shown in FIG. 39. In this case, the turntable is a main rotary turntable (MRT), and powder cake 3902 is formed on a rotary build platform that rotates separately from the MRT. As another example, powder cake 3902 may be formed directly on turntable 3901. During the 3D printing process, layers of powder are deposited to form powder cake 3902 and then irradiated to form the build part 3904 within the powder cake 3902, while the rotary turntable 3901 is rotated around central axis 3910.

In the example shown, the counterweight 3903 is disposed on turntable 3901 in a position that is about 180° opposite the position of the powder cake 3902 on turntable 3901, as shown in FIG. 39. The counterweight 3903 is placed on turntable 3901 to reduce imbalance on turntable 3901 caused by the increasing mass of the build part during the 3D printing process. The weight Wc of the counterweight 3903 is about one-half the weight W_{FBP} of the finished build part 3904 (i.e., W_{C}=W_{FBP}/2). The counterweight 3903 has exactly or approximately 50% of the combined mass of the finished build part 3904 and powder cake 3902.

In this embodiment, the 3D printing process of building the build part 3904 starts with about a 50% imbalance (relative to the amount of imbalance that would exist at completion of the 3D printing process if the counterweight 3903 were not present) on the turntable 3901 that is weighted towards the counterweight 3903. As powder layers are added to the build part 3904, the mass of the build part 3904 increases, and the imbalance on turntable 3901 between the counterweight 3903 and the build part 3904 decreases. When the mass of the build part 3904 reaches about 50% of its final finished mass, the turntable 3901 is balanced, because the build part 3904 and the counterweight 3903 weigh about the same.

When the mass of the build part 3904 becomes greater than the mass of the counterweight 3903, the turntable 3901 becomes weighted toward the build part 3904. Then, as the mass of the build part 3904 continues to increase with additional powder layers, the imbalance on turntable 3901 between the counterweight 3903 and the build part 3904 continues to increase, and the turntable 3901 becomes increasingly weighted toward the build part 3904. The 3D printing process finishes with about a 50% imbalance on turntable 3901 weighted toward the build part 3904 and away from the counterweight 3903. Counterweight 3903 reduces the magnitude of the imbalance on turntable 3901 by at least about 50% during the 3D printing process without requiring any additional moving parts in the 3D printer.

In some embodiments, the 3D printer comprises or is in communication with a computing device configured to pre-calculate a weight of the counterweight 3903. In some cases, the pre-calculated weight of the counterweight 3903 is based on a desired final weight of the finished build part 3904 plus the final powder cake 3902 that will surround it at the completion of the build process. The weight of the counterweight 3903 can be adjusted automatically by the computing device and installed by a robot on the turntable 3901 before each build of a build part by the 3D printer. Alternatively, the counterweight 3903 can be installed on the turntable 3901 manually.

According to an alternative embodiment, the desired final weight of the build part 3904 is estimated based on a determination of a maximum size build part that the 3D printer is capable of building on turntable 3901. A counterweight 3903 is then built that is about 50% of the desired final weight of the build part estimated using the maximum size build part plus the final powder cake 3902 that will surround it at the completion of the build process. The fixed counterweight 3903 is then installed on the turntable 3901. This technique can be used to build a counterweight 3903 that is equal to about 50% or close to 50% of the weight of most build parts that are built by the 3D printer.

In some embodiments, the build platforms are disposed on the rotary turntable to reduce an imbalance on the rotary turntable as parts are being built on the build platforms. In some cases, the build platforms are disposed on the rotary turntable to enable building two or more parts in parallel, equally distributed around the turntable circumference, to reduce an imbalance on the rotary turntable as parts are being built on each build platform.

In some embodiments, the counterbalance mechanism comprises a counterweight disposed on the rotary turntable in a position that counterbalances at least a portion of the weight of the parts being built on each build platform. In some cases, the build platforms are disposed on the rotary turntable to reduce an imbalance on the rotary turntable as parts are being built on each build platform, the imbalance being reduced by a counterweight comprising layers of powder deposited on the build platforms.

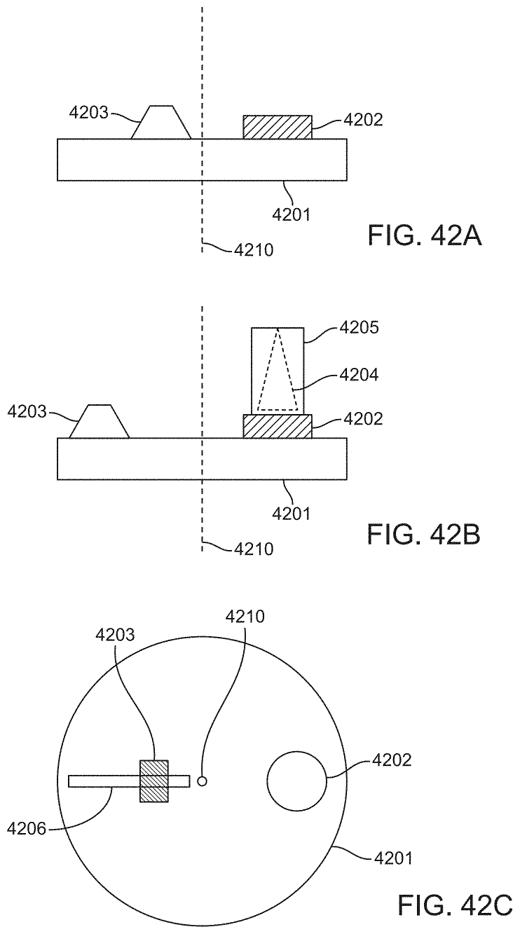

FIGS. 40A-40D illustrate four examples of techniques for preventing or reducing the imbalance on a turntable in a 3D printer by building two or more 3D parts on the turntable in parallel that are evenly or equally distributed around the turntable circumference, according to additional embodiments. Each of FIGS. 40A-40D shows a rotary turntable 4000 in a 3D printer apparatus from a top down view. During the 3D printing processes of FIGS. 40A-40D, layers of powder are deposited on two or more build platforms and then irradiated to form layers of two or more build parts, while the rotary turntable 4000 is rotated around a center axis 4010.

FIG. 40A shows two build parts 4003 and 4004 that are built on two build platforms 4001 and 4002, respectively, concurrently and in parallel by the 3D printer during the 3D printing process. The build platforms 4001 and 4002 are placed about 180° opposite to each other on turntable 4000. Because the build parts 4003 and 4004 are positioned on the build platforms 4001 and 4002, respectively, the build parts 4003 and 4004 are also about 180° opposite to each other on turntable 4000. As the build parts 4003 and 4004 are built on the build platforms 4001-4002, respectively, each pair of additional layers added to the build parts 4003 and 4004 counterbalance each other to prevent or to reduce imbalances on turntable 4000. The build platforms 4001-4002 may be, for example, rotary build platforms on a main rotary turntable 4000, as disclosed herein, for example, with respect to FIGS. 26A-26C and 27A-27B.

FIG. 40B shows three build platforms 4011-4013 that are evenly or equally spaced apart on turntable 4000. A different build part is built on each of the three build platforms 4011-4013 during the 3D printing process. The 3D printer builds the three build parts concurrently and in parallel on the build platforms 4011-4013 during the 3D printing process. The build platforms 4011-4013 and the build parts thereon are evenly or equally spaced apart at 120° intervals on turntable 4000, as shown in FIG. 40B. As the build parts are built on the build platforms 4011-4013, each set of additional layers added to the build parts counterbalance each other to prevent or to reduce imbalances on turntable 4000. The build platforms 4011-4013 may be, for example, rotary build platforms on a main rotary turntable 4000, as disclosed herein, for example, with respect to FIGS. 26A-26C and 27A-27B.

FIG. 40C shows four build platforms 4021-4024 that are evenly or equally spaced apart on turntable 4000. A different build part is built on each of the 4 build platforms 4021-4024 during the 3D printing process. The 3D printer builds the 4 build parts concurrently and in parallel on the build platforms 4021-4024 during the 3D printing process. The build platforms 4021-4024 and the build parts thereon are evenly or equally spaced apart at about 90° intervals on turntable 4000, as shown in FIG. 40C. As the build parts are built on the build platforms 4021-4024, each set of additional layers added to the build parts counterbalance each other to prevent or to reduce imbalances on turntable 4000. The build platforms 4021-4024 may be, for example, rotary build platforms on a main rotary turntable 4000, as disclosed herein, for example, with respect to FIGS. 26A-26C and 27A-27B.

FIG. 40D shows six build platforms 4031-4036 that are evenly or equally spaced apart on turntable 4000. A different build part is built on each of the 6 build platforms 4031-4036 during the 3D printing process. The 3D printer builds the 6 build parts concurrently and in parallel on the build platforms 4031-4036 during the 3D printing process. The build platforms 4031-4036 and the build parts thereon are evenly or equally spaced apart at about 60° intervals on turntable 4000, as shown in FIG. 40D. As the build parts are built on the build platforms 4031-4036, each set of additional layers added to the build parts counterbalance each other to prevent or to reduce imbalances on turntable 4000. The build platforms 4031-4036 may be, for example, rotary build platforms on a main rotary turntable 4000, as disclosed herein, for example, with respect to FIGS. 26A-26C and 27A-27B.

In high volume manufacturing 3D printing operations, the embodiments of FIGS. 40A-40D can improve the fabrication throughput. For an even number of build platforms, counterweights are not needed, because the even number of build parts balance each other. For an odd number of build platforms, the build parts may balance each other. Alternatively, counterweights can be placed about 180° from each build part on turntable 4000, such that the counterweights are placed between the other build parts.

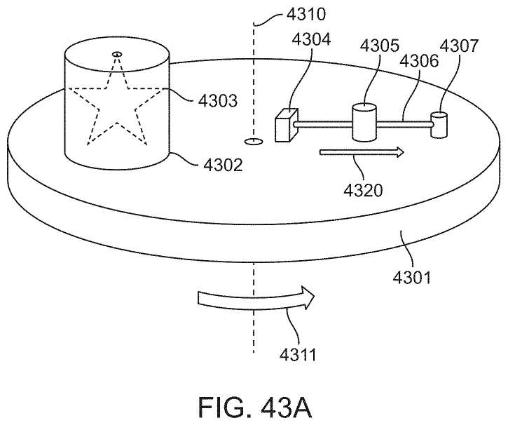

In some embodiments, as discussed in more detail with respect to FIGS. 41A-41B below, the counterweight comprises one or more variable weight structures (e.g., structures that are configured to have a weight that can be adjusted) on the rotating support table. In some cases, the variable weight structures comprise vessels mounted on the rotating support table configured to receive material that counterbalances at least a portion of the weight of a part as the part is being built.

FIGS. 41A-41B illustrate two examples of techniques for preventing or reducing the imbalance on a turntable in a 3D printer by providing an empty vessel on the turntable that is configured to hold or be filled with counterweight material, according to additional embodiments.

FIGS. 41A-41B illustrate a rotary turntable 4101, a build platform 4102, a build part 4103, a powder cake 4104, a vessel 4111, and counterweights 4112 from side views. Build platform 4102 is mounted on rotary turntable 4101. During the 3D printing process, layers of powder are deposited to form a powder cake 4104 and then irradiated to form the build part 4103 within the powder cake 4104, while the rotary turntable 4101 is rotated around central axis 4110.

Vessel 4111 is mounted on the rotary turntable 4101 in a position that is 180° opposite to the position of the build platform 4102 on turntable 4101. As the powder cake 4104 is formed, and the build part 4103 is built inside powder cake 4104 during the 3D printing process, the 3D printer gradually fills vessel 4111 with counterweights 4112 having a mass about equal to the increasing mass of the powder cake 4104 and build part 4103. As a specific example, a layer of powder may be deposited into vessel 4111 as counterweight 4112 (e.g., using material supply device 2611) each time that an additional layer of powder is deposited to form the powder cake 4104 and the build part 4103. Each layer of powder that is deposited into vessel 4111 as counterweight 4112 has a mass that is about equal to the mass of a corresponding layer of powder that has been (or will be) deposited to form an additional layer of the powder cake 4104 and build part 4103.

In FIG. 41A, a small amount of the counterweights 4112 have been deposited into vessel 4111 early in the build process when small portions of the build part 4103 and the powder cake 4104 have been deposited on build platform 4102. In FIG. 41B, vessel 4111 is nearly full of counterweights 4112 late in the build process when the build part 4103 is nearly complete.

The counterweights 4112 may, for example, be powder that is made of the same material (e.g., a metal) used to form powder cake 4104 and build part 4103. Alternatively, the counterweights 4112 may be powder that is made of one or more different materials than the powder material used to form powder cake 4104 and build part 4103. As examples, in some embodiments, it may be desirable to conserve expensive metal powder and to fill vessel 4111 with a counterweight material 4112 such as lead shot, scrap pieces of steel, or washers that stack on the counterweight 4112.

In various embodiments, the vessel 4111 may be located on turntable 4101 at the same radius from axis 4110 as the build platform 4102, and the vessel 4111 may be filled with an approximately equal amount of the same powder that is deposited on the build platform 4102 in powder cake 4104 to build part 4103. In alternative embodiments, the vessel 4111 and counterweights 4112 may be placed on turntable 4101 at a larger radius from axis 4110 than build platform 4102 so that less additional mass is required to maintain a balanced moment of inertia for turntable 4101.

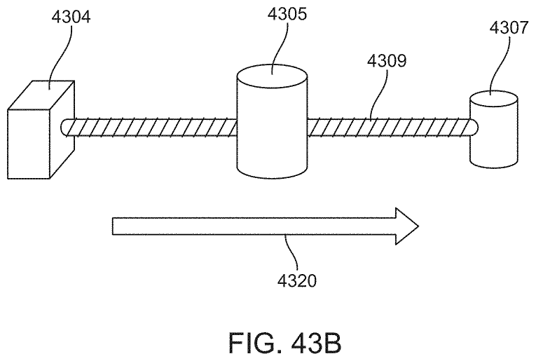

In some embodiments, as discussed for example with respect to FIGS. 42A-42C below, the counterbalance mechanism is configured to balance a moment of inertia on the rotating support table including by moving the counterweight radially outward on the rotating support table as the part is being built. In some cases, the processing machine as described herein further includes a motor to move the counterweight. In some cases, the processing machine as described herein further includes a radial guide attached to the rotating support table that guides the counterweight radially outward toward an outer edge of the rotating support table along a length of the radial guide as the part is being built. In various embodiments, this radial guide can be one or more rods, rails, ridges, hollow tubes or ducts. In some cases, the processing machine as described herein further includes a component to couple the motor to the counterweight and convert the motion of the motor into a motion of the counterweight along the radial guide in the direction away from the axis of rotation of the main rotary turntable. In some embodiments, this coupling mechanism can be one or more bands, chains, cables, wire ropes, or lead screws. In the cases where one or more lead screws are used, a lead screw may perform the functions of both a radial guide and a component to transfer the motion of the motor into motion of the counterweight.

FIGS. 42A-42C illustrate an example of a turntable in a 3D printer having a counterweight on an opposing side of the turntable that moves outward along a radial guide during the 3D printing process to reduce imbalance on the turntable, according to an embodiment. FIGS. 42A-42B illustrate a rotary turntable 4201, a build platform 4202, a build part 4204, a powder cake 4205, and a counterweight 4203 from side views. FIG. 42C illustrates rotary turntable 4201, build platform 4202, counterweight 4203, and radial guide 4206 from a top down view. During the 3D printing process, layers of powder are deposited to form powder cake 4205 and then irradiated to form the build part 4204 within the powder cake 4205, while the rotary turntable 4201 is rotated around central axis 4210.

Radial guide 4206 and counterweight 4203 are positioned on turntable 4201 about 180° opposite to the build platform 4202 and the powder cake 4205 on turntable 4201, as shown in FIGS. 42A-42C. The counterweight 4203 is moved along radial guide 4206 on turntable 4201 by a control mechanism (e.g., using a lead screw) during the 3D printing process. At the start of the process of building part 4204, counterweight 4203 is located at the closest point to axis 4210 along the length of radial guide 4206, as shown for example in FIG. 42A. As layers are added to the powder cake 4205 and the build part 4204 during the 3D printing process, counterweight 4203 is moved radially outward toward the edge of turntable 4201 and away from axis 4210 along the radial length of radial guide 4206 to reduce imbalance on turntable 4201, as shown for example in FIG. 42B. The motion of counterweight 4203 outward along radial guide 4206 as build part 4204 is built causes the moment of inertia on turntable 4201 to remain balanced (or more closely balanced) as the mass on the build platform 4202 is increasing. The mass of the counterweight 4203 may be about equal to the mass of the finished build part 4204 or may be a fraction of the mass of the finished build part 4204.

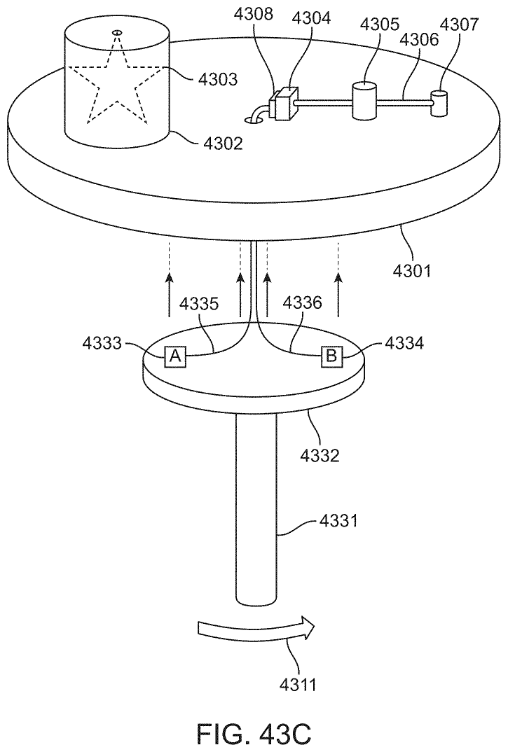

In some embodiments, as discussed with respect to FIGS. 43A-43C below, the processing machine as described herein includes a motor and a post. In these cases, the radial guide is a lead screw that extends from the motor through the counterweight to the post. The motor moves the counterweight along a length of the lead screw by rotating the lead screw as a part is being built.

FIGS. 43A-43C illustrate another example of a turntable in a 3D printer having a counterweight on an opposing side of the turntable that moves outward along a radial guide during the 3D printing process to reduce imbalance on the turntable, according to an embodiment. FIGS. 43A and 43C illustrate a rotary turntable 4301, a powder cake 4302, a build part 4303, a drive motor 4304, counterweight 4305, a radial guide 4306, and a post—in this case, a pivot post 4307. During the 3D printing process, layers of powder are deposited to form powder cake 4302 and then irradiated to form the build part 4303 within the powder cake 4302, while the rotary turntable 4301 is rotated around central axis 4310. The direction of rotation 4311 of turntable 4301 around axis 4310 is also shown in FIG. 43A. Counterweight 4305 and radial guide 4306 are positioned on turntable 4301 180° opposite to powder cake 4302 and build part 4303, as shown in FIGS. 43A and 43C.

FIG. 43B illustrates further details of drive motor 4304, counterweight 4305, and pivot post 4307. In the embodiment of FIG. 43B, the radial guide 4306 is a threaded lead screw 4309 that extends from motor 4304 through a threaded hole in counterweight 4305 to pivot post 4307. Lead screw 4309 may be secured to motor 4304 and post 4307. FIG. 43C further illustrates a control unit 4308 that controls the drive motor 4304. Drive motor 4304 moves counterweight 4305 along the length of lead screw 4309 on turntable 4301 in direction 4320 by rotating lead screw 4309 during the 3D printing process. The rotation of lead screw 4309 by motor 4304 pushes the counterweight 4305 radially outward along the length of lead screw 4309 toward post 4307 in direction 4320. The turning motion of lead screw 4309 translates into linear motion of counterweight 4305.

At the start of the 3D printing process of building part 4303, counterweight 4305 is located next to motor 4304. As layers are added to the powder cake 4302 and the build part 4303 during the 3D printing process, drive motor 4304 moves counterweight 4305 radially outward toward pivot post 4307 and away from axis 4310 along the length of lead screw 4309 by rotating lead screw 4309. The movement of counterweight 4305 along lead screw 4309 during the 3D printing process reduces imbalance on turntable 4301. The movement of counterweight 4305 outward along lead screw 4309 as build part 4303 is built causes the moment of inertia on turntable 4301 to remain balanced (or more closely balanced) as the mass of powder cake 4302 increases.

In some embodiments as discussed in more detail below with respect to FIG. 43C, the processing machine as disclosed herein comprises: a motor that moves the counterweight; a shaft configured to couple both rotational and translational motion from one or more actuators to the rotating support table; a flange attached to a top of the shaft and to a bottom of the rotating support table; one or more pressure sensors disposed on or coupled to the flange that generate sensor data indicating moments of inertia of the counterweight; and a control unit configured to control movement of the counterweight along the radial guide in response to the sensor data.

FIG. 43C illustrates a control system for controlling the movement of counterweight 4305 using pressure sensors that are located between rotary turntable 4301 and a flange on an axle, according to another embodiment. FIG. 43C further illustrates axle 4331, disk-shape flange 4332, pressure sensors 4333-4334, and wires 4335-4336 in an exploded view. Axle 4331 is permanently attached to the bottom of flange 4332. Flange 4332 is permanently mounted to the bottom of turntable 4301. Axle 4331 and flange 4332 rotate turntable 4301 in direction 4311 during the 3D printing process. Pressure sensors 4333-4334 are mounted on flange 4332. Conductive wires 4335-4336 electrically connect pressure sensors 4333-4334, respectively, to the control unit 4308 that controls motor 4304. Pressure sensors 4333-4334 are pressed between flange 4332 and turntable 4301 in the final assembly of the components shown in FIG. 43C.

Pressure sensor 4333 senses the moment of inertia of powder cake 4302. Pressure sensor 4334 senses the moment of inertia of counterweight 4305. Pressure sensors 4333-4334 continuously provide information about the moments of inertia of powder cake 4302 and counterweight 4305 to control unit 4308 through wires 4335-4336, respectively, during the 3D printing process. Control unit 4308 uses the information about the moments of inertia of powder cake 4302 and counterweight 4305 to control the movement that motor 4304 provides to counterweight 4305 along radial guide 4306. For example, as additional layers of powder are added to powder cake 4302, the moment of inertia of powder cake 4302 increases. Pressure sensor 4333 senses the increase in the moment of inertia of powder cake 4302, and in response to receiving information indicating the increased moment of inertia from sensor 4333, control unit 4308 causes motor 4304 to move counterweight 4305 farther outward along radial guide 4306.

The foregoing description of the exemplary embodiments of the present invention has been presented for the purpose of illustration. The foregoing description is not intended to be exhaustive or to limit the present invention to the examples disclosed herein. In some instances, features of the present invention can be employed without a corresponding use of other features as set forth. Many modifications, substitutions, and variations are possible in light of the above teachings, without departing from the scope of the present invention.

1-16. (canceled)

17. A processing machine for building a part, the processing machine comprising:
a rotating support table configured to rotate about a first axis, the rotating support table comprising a secondary support table, wherein the secondary support table is configured to rotate with the rotating support table, and wherein the secondary support table is configured to rotate around a non-coaxial secondary axis;
a powder supply assembly that distributes powder onto the secondary support table to form a powder layer;
an energy system that directs an energy beam at a portion of the powder on the secondary support table to form a portion of the part being built; and
a counterbalance mechanism configured to counterbalance at least a portion of a weight of the part being built on the secondary support table.

18. The processing machine of claim 17, wherein the part comprises a three-dimensional object built from powder, the rotating support table comprises a rotary turntable, and the secondary support table comprises a build platform configured to support the part being built, wherein the build platform is configured to rotate around the non-coaxial secondary axis.

19. The processing machine of claim 17, wherein the rotating support table and the secondary support table are configured to rotate in a same rotational direction.

20. The processing machine of claim 17, wherein the rotating support table is configured to rotate about the first axis in a first rotational direction and wherein the secondary support table is configured to rotate around the non-coaxial secondary axis in a rotational direction counter to the first rotational direction.

21. The processing machine of claim 17, wherein the counterbalance mechanism comprises a counterweight disposed on the rotating support table in a position that counterbalances the weight of the part being built.

22. The processing machine of claim 21, wherein the counterweight has a fixed mass.

23. The processing machine of claim 22, wherein the counterweight has a fixed mass of about half the mass of a finished part.

24. The processing machine of claim 21, wherein the counterweight comprises one or more variable weight structures.

25. The processing machine of claim 24, wherein the variable weight structures comprise vessels mounted on the rotating support table configured to receive material that counterbalances the weight of a part as the part is being built.

26. The processing machine of claim 21, wherein the counterbalance mechanism is configured to balance a moment of inertia on the rotating support table including by moving the counterweight radially outward on the rotating support table as the part is being built.

27. The processing machine of claim 26, further comprising:
a radial guide attached to the rotating support table that guides the counterweight radially outward toward an outer edge of the rotating support table along a length of the radial guide as the part is being built.

28. The processing machine of claim 27, further comprising:
a motor; and
a component to couple the motor to the counterweight and convert a motion of the motor into a motion of the counterweight along the radial guide in a direction away from the first axis of rotation of the rotating support table.

29. The processing machine of claim 27, further comprising:
a motor; and
a post, wherein the radial guide comprises a lead screw that extends from the motor through the counterweight to the post, and wherein the motor moves the counterweight along a length of the lead screw by rotating the lead screw as a part is being built.

30. The processing machine of claim 27, wherein the motor moves the counterweight and wherein a coupling mechanism transfers the motion of the motor into motion of the counterweight, the processing machine further comprising:
multiple pressure sensors mounted at an interface between a rotating axle assembly and an assembly comprising the main rotary turntable, wherein the sensors generate sensor data indicating moments of inertia on a counterweight side of the rotating support table and a side of the rotating table opposite the counterweight;
a processor and a memory coupled to the processor, wherein the processor is configured to:
compare pressure readings of the multiple pressure sensors;
calculate a new position for the counterweight along the radial guide to correct for a detected imbalance; and
send an instruction to the motor to move the counterweight to the new position.

31. The processing machine of claim 28 further comprising:
a motor that moves the counterweight;
a shaft configured to couple both rotational and translational motion from one or more actuators to the rotating support table;
a flange attached to a top of the shaft and to a bottom of the rotating support table;
one or more pressure sensors disposed on or coupled to the flange that generate sensor data indicating moments of inertia of the counterweight; and
a control unit configured to control movement of the counterweight along the radial guide in response to the sensor data.

32. The processing machine of claim 17, wherein the part comprises a plurality of parts, wherein the rotating support table comprises a rotary turntable, and wherein the secondary support table comprises a plurality of build platforms, each build platform being configured to rotate around its own non-coaxial secondary axis, and wherein each build platform is configured to support one of the plurality of parts being built in parallel as layers of powder are distributed on each build platform.

33. The processing machine of claim 32, wherein the rotary turntable and each of the build platforms are configured to rotate in a same rotational direction.

34. The processing machine of claim 32, wherein the rotary turntable is configured to rotate about the first axis in a first rotational direction and wherein the build platforms are each configured to rotate around their own non-coaxial secondary axes in a second rotational direction opposite or counter to the first rotational direction.

35. The processing machine of claim 32, wherein the build platforms are disposed on the rotary turntable to reduce an imbalance on the rotary turntable as parts are being built on each build platform.

36. The processing machine of claim 32, wherein the build platforms are disposed on the rotary turntable to enable building two or more parts in parallel, equally distributed around the turntable circumference, to reduce an imbalance on the rotary turntable as parts are being built on each build platform.

37-87. (canceled)
